(19) United States
(12) Patent Application Publication
(10) Pub. No.: US 2018/0197154 A1
(43) Pub. Date: Jul. 12, 2018

(54) SYSTEM FOR PRODUCT ARCHITECTURE LIFECYCLE MANAGEMENT

(71) Applicant: MODULAR MANAGEMENT GROUP STOCKHOLM AB, Stockholm (SE)

(72) Inventor: Jakob Erik Asell, Saltsjobaden (SE)

(21) Appl. No.: 15/861,190

(22) Filed: Jan. 3, 2018

Related U.S. Application Data
(60) Provisional application No. 62/441,865, filed on Jan. 3, 2017.

(51) Int. Cl. G06Q 10/00

(52) U.S. Cl. CPC G06Q 10/20; H04L 63/0428; G06Q 10/30

(57) ABSTRACT

A system that includes aspects that can determine and output features and configurations of a product or a service, and that can share its output downstream with product or service configuration systems. The system can include a processor and instructions stored in memory executable by the processor. The instructions can include goal values of goals, product properties, product modules, and module variants. Each of the product properties can include the goal values, each of the product modules can be associated with the product properties, and each of the module variants can be specified by the goal values. The instructions can also include a logical structure that is configured to instruct formation of a product or service based on the goal values, product properties, product modules, and module variants.

### CROSS-REFERENCE TO RELATED APPLICATION

This application claims the benefit of U.S. Provisional Application No. 62/441,865, filed Jan. 3, 2017.

### FIELD

This application relates to systems and methods for defining and managing modular product architectures (also referred to herein as module systems). Module systems include product modules that, for example, define different parts of a product (such a hardware or software product) or a service. Product modules disclosed herein can include modules for a product or a service. Although systems for product architecture lifecycle management are described herein, the systems are also applicable to lifecycle management for services. Thus, in applicable parts herein, the term “product” could be replaced with the term “service”. In other words, for this disclosure, where context permits, the term “product” encompasses the term “service” or “product”.

### BACKGROUND

Product lifecycle management (PLM) is the process of managing the entire lifecycle of a product from inception, through architecture, engineering design, purchasing of parts, manufacture, to service and disposal of manufactured products. PLM integrates client applications of parties involved, corresponding data, processes and business systems and provides a product information pillar for companies and their extended enterprise. Similar management can be provided for the lifecycle of services and software, or the combination of products and services.

Related to PLM, configuration management is an engineering process for establishing and managing consistency of a product or service's performance, functional, and physical attributes with its requirements, design, and operational information throughout its lifecycle. It can also be extended to business processes and systems related to the product or service, such as sales and marketing attributes of the product or service. Configuration management applied over a product or service's lifecycle provides information and control regarding its performance and functional and physical attributes. It validates that a product or service performs as intended, and is identified and documented in detail.

Configurator systems, software used for implementing configuration management, can facilitate management of system information and system changes. Configurator systems can change and expand capability, enhance performance, reliability, or maintainability, extend life, limit cost, risk or liability, and fix flaws in products and services.

Configurator systems can include complex systems usually including suites of user interfaces and complex syntaxes more intended for engineers and information systems specialists. Other parties involved in the configuration management or PLM, such as sales and marking, executive and strategy, product management, and supply, often rely on engineers and information systems specialist because of the complexity involved. Executives, product managers, creative, sales and marking, and business development personnel could provide valuable hands-on input into such management systems especially from a product architecture standpoint; however, the complexity of current systems can make it difficult for such parties to be involved with the configuration process.

Typically, configurator systems are bottom-up architected systems.

### SUMMARY

Disclosed herein are systems and processes that can limit complexity and that can assist all types of personnel with product architecture processes, PLM, and configuration management, including configuration management in the architecture, creation, supply, and sales of a product or service. Below, in this Summary Section, are descriptions of some exemplary features of the disclosed systems and processes. The systems and process disclosed herein include top-down architected systems and processes.

Exemplary embodiments include a system, such as a product configuration profile system. Such a system includes aspects that can determine and output foreseeable and unforeseeable features and configurations of a product or a service, and that can share its output downstream with other product or service configuration systems. The example system includes a processor and instructions stored in memory executable by the processor. The instructions can include goal values, and the goal values can include a controlling goal value that controls at least one controlled goal value. The instructions can also include product properties. Each of the product properties can include at least one of the goal values, and the product properties can include a unifying property that unifies at least one product property. The instructions can also include product modules, and each of the product modules can be associated with at least one of the product properties. The instructions can also include module variants, and each of the module variants can be specified by at least one of the goal values. The instructions can also include a logical structure that includes the product modules and is configured to instruct formation of a product based on the product properties. Such a logical structure can include a node structure referencing or realizing the product modules. Also, such a logical structure and parts of the logical structure can be stored in memory or libraries of the system in reusable units. The logical structure can further include: global logic that applies to the logical structure; local logic that applies to certain parts of the logical structure; conditions for selecting a module variant of a product module (the conditions may limit the number of valid variants, wherein if no variant is valid the logic fails, and wherein if one variant is a valid it may be the one to select, and wherein if many variants are valid even though the conditions are applied and goal values are selected, then the configurator may select one variant, which can be done by selecting the variant that provided an optimal solution, according a default sequence, the order they are stored or randomly for example); conditions for setting a quantity of a product module, the quantity including the amount of instances of the product module that are allowed, wherein each instance of the product module can be a variant of the product module or an exact replication of the other instances of the product module; and a translator. The translator, when executed by the processor, is configured to translate the logical structure into a product configurator model useable by a product configurator system.

In an example of the aforesaid exemplary embodiments, the configurator system can include a graphical user interface for configuring the product based on the configurator model.

In an example of the aforesaid exemplary embodiments, the logical structure further includes conditions that are reusable.

In an example of the aforesaid exemplary embodiments, the logical structure further includes conditions that are for single use.

In an example of the aforesaid exemplary embodiments, the logical structure further includes a control of product layout for the product, where the product is a recursive product.

In an example of the aforesaid exemplary embodiments, the instructions further include graphical user interface (GUI) tools for capturing the logical structure. In such an example, the GUI tools include tools for capturing market information related to the product. The GUI tools can also include tools for capturing engineering information related to the product. The GUI tools can also include tools for enhancing modularity and/or configurability of the product. The GUI tools can also include tools for enhancing profitability of the product. The GUI tools can also include tools for capturing supply chain information related to the product.

Also, exemplary embodiments include a method for generating a product. The exemplary method can include: providing graphical user interface (GUI) tools for capturing a logical structure that is configured to instruct formation of a product based on product properties instead of product parts; and translating the logical structure into a product configurator model useable by a product configurator system. The translating can include modules and module variants of the logical structure generating component classes of the product configurator system (such as modules and module variants realized in the logical structure that can generate component classes of the product configurator system). The translating can also include the product properties generating component classes of the product configurator system (as well as features and attributes describing module classes in some embodiments). The translating can also include node conditions generating component classes of the product configurator system; interface variance at module variant level generating component classes of the product configurator system; a generic product structure generating subpart structure; and a configuration interface generating an execution, which includes instructions for a user interface of the configurator model. The exemplary method can also include using the configurator model via the product configurator system to generate the product.

In an example of the aforesaid exemplary embodiments, the method can further include modifying the configurator model using the user interface of the configurator model.

In an example of the aforesaid exemplary embodiments, the method can further include using some of the GUI tools to capture market information related to the product. The method can also include using some of the GUI tools to capture engineering information related to the product. The method can also include using some of the GUI tools to enhance modularity of the product. The method can also include using some of the GUI tools to enhance profitability of the product. The method can also include using some of the GUI tools to capture supply chain information related to the product.

Also, exemplary embodiments can include a non-transitory computer readable medium, including instructions executable by a processor to provide a module variant specification (MVS) tool including a graphical user interface (GUI) for defining product modules with module variants and for defining product properties with goal values as well as for specifying the product modules with the product properties and for specifying the module variants with the goal values. The medium can also include instructions executable by a processor to provide a generic product structure (GPS) tool including a GUI for defining generic product structure for how to utilize and/or realize the product modules and for defining conditions to select valid module variants of a product module. The medium can also include instructions executable by a processor to provide a system property matrix (SPM) tool including a GUI for defining system properties that unify the product properties (such as wherein a specific goal value controls compatible goal values of controlled properties or wherein a specific goal value controls compatible goal values of controlled properties and vice versa such that control is in both directions; or such as wherein a system property lists a number of feasible scenarios and each scenario lists the goal values for each property that are compatible). The exemplary computer readable medium can also include instructions executable by a processor to provide a configuration interface (CI) tool including a GUI for defining a user interface with parameters for feedback related to or interaction with the information captured by the MVS tool, the GPS tool, and the SPM tool and a GUI for collecting configuration profile based at least on the information captured by the MVS tool, the GPS tool, and the SPM tool. The medium can also include instructions executable by a processor to use the configuration profile with a translator to generate a product configurator model. In an example of the aforesaid exemplary embodiments, the medium can further include instructions executable by a processor to execute the configurator model and provide a GUI for interacting with the configurator model. The medium can also include instructions executable by a processor to provide a commercial offerings (COM) tool used to define a set of commercial properties and assign pricing to the commercial properties, wherein a search can be initiated from the COM tool for properties to define a set of commercial properties and assign pricing; and instructions executable by a processor to provide a module variant costing (MVC) tool used to define the direct cost and/or the indirect cost for a module variant.

Also, exemplary embodiments include a generic computer programming language for generating a configuration profile of a product in a product architecture system. The programming language can include items and item sets. An item set can be a set of items that share a same base definition and serve a same function. The programming language can also include tools including functions, and the items and item sets are shared between tools such that attributes that are changed for an item in one tool are updated in other tools. The tools can include a first tool and a second tool, and the first tool provides input for the second tool, and an output of the second tool depends on the input from the first tool. The data of an item is accessed via one of the tools. The programming language can also include editors, configured to provide access to aspects of the tools, the items, the item sets, or relations thereof. Content of an editor can be dependent on the type of tool, item, or item set.

In an example of the aforesaid exemplary embodiments, each item can be associated with a unique identification code that is at least machine-readable and is readable by the product architecture system and other systems. Also, the unique identification code can be dynamic in that it changes or static, and can be transformed into human readable code as well.

In an example of the aforesaid exemplary embodiments, the programming language further includes modules and product module sets.

In an example of the aforesaid exemplary embodiments, the programming language further includes statuses for the items, item sets, and tools.

In an example of the aforesaid exemplary embodiments, the programming language further includes actions for adding, duplicating, deleting, reordering, deactivating, and reactivating items.

In an example of the aforesaid exemplary embodiments, the programming language further includes relation scores representative of strength of relations between items and item sets.

In an example of the aforesaid exemplary embodiments, the tools include different user interfaces for inputting and outputting items, item sets, and relations thereof.

In an example of the aforesaid exemplary embodiments, the tools, editors, items, and item sets have respective error messaging and error handling.

In an example of the aforesaid exemplary embodiments, the programming language further includes a graphical navigator configured to provide navigation through the tools, editors, items, item sets, and relations thereof. In such an embodiment, the items, item sets, and tools can be arrangeable within the graphical navigator.

In an example of the aforesaid exemplary embodiments, the programming language further includes a node diagram configured to present items, item sets as nodes, and relations thereof as interfaces between the nodes. In such an embodiment, nodes and interfaces can be arrangeable within the node diagram. Also, the node diagram can be in one of a regular node diagram layout, a circular node layout, or a hierarchical tree structure. Also, the node diagram may include a layout derived from a force-directed graph drawing algorithm. Also, in such an embodiment, the programming language can further include modules and product module sets, and the node diagram is further configured to present modules and product module sets as graphically indicated areas including nodes that belong to the modules and product module sets. Also, interfaces can include interfaces with conditions.

In an example of the aforesaid exemplary embodiments, the items and item sets can include product configuration items that makeup a configuration profile for a product collectively.

In an example of the aforesaid exemplary embodiments, the items include goal values. The goal values can include a controlling goal value that controls at least one controlled goal value. Also, the items can include product properties. Each of the product properties can include at least one of the goal values. Further, the product properties can include a unifying property that unifies at least one product property. Unifying properties can be of different scope including a scope for globally controlling all instances of the property or a scope for local control of instances only within a certain branch of the node structure. Unifying properties can also control node properties and system properties. It can be a practical consequence that a system property can control valid combinations and then it is linked to only one product module to select a valid variant of that module. Also, in some example embodiments, module variants are not selected manually, but selected automatically according to a rule such as an optimization rule.

In some of the aforesaid embodiments, the programming language can also include product modules, and each of the product modules can be associated with at least one of the product properties. At least one of the product properties can include a unifying product property in that the unifying product property unifies at least one product property. The programming language can also include module variants, each of the module variants specified by at least one of the goal values (such as for at least one product property).

The programming language can also include a logical structure including the product modules and configured to instruct formation of a product based on the product properties. The logical structure can also include: global logic that applies to the logical structure; local logic that applies to certain parts of the logical structure; conditions for selecting a module variant of a product module (the conditions may limit the number of valid variants, wherein if no variant is valid the logic fails, and wherein if one variant is a valid it may be the one to select, and wherein if many variants are valid even though the conditions are applied and goal values are selected, then the configurator may select one variant, which can be done by selecting the variant that provided an optimal solution, according a default sequence, the order they are stored or randomly for example); and conditions for setting a quantity of a product module, the quantity including the amount of instances of the product module that are allowed, wherein each instance of the product module can be a variant of the product module or an exact replication of the other instances of the product module.

Also, exemplary embodiments include a system, including a generic computer programming language for generating a configuration profile of a product in a product architecture system. The programming language of the system can include items and item sets. In such embodiments, an item set can be a set of items that share a same base definition and serve a same function.

In an example of the aforesaid exemplary embodiments, each item can be associated with a unique identification code that is at least machine-readable and is readable by the product architecture system and other systems. Also, the unique identification code can be dynamic in that it changes or static, and can be transformed into human readable code as well.

The programming language can also include tools including functions, and the items and item sets are shared between tools such that attributes that are changed for an item in one tool are updated in other tools (such as wherein the tools set relations between items from different or the same item sets). The tools can include a first tool and a second tool, and the first tool provides input for the second tool, and an output of the second tool depends on the input from the first tool. Data of an item can be accessed via one of the tools. The system can also include editors, configured to provide access to aspects of the tools, the items, the item sets, or relations thereof. Content of an editor can be dependent on the type of tool, item, or item set.

The system can also include a specific translator for a specific configurator system, configured to translate instructions including the generic computer programming language to a configurator model executable by the configurator system. The configurator model can include an explicit configurator syntax executable by a specific configurator system such as wherein the configurator system may be a configurator engine and/or solver. A solver can be any type of solver, such as wherein the configuration profile can be translated to object-oriented, sequential, Boolean and constraint based solvers.

Also, exemplary embodiments include a graphical user interface (GUI) for a product architecture system (PAS), which includes a navigator area that includes expandable and collapsible lists of tools. Each list can include selectable indications of tools and each selectable indication of a tool can provide navigation to the tool upon selection thereof. The tools can be grouped into a first group of tools for capturing a logical structure of the loaded module system and a second group of tools that provide general access to items and item sets of the loaded module system. In such examples, an item set is a set of items that share a same base definition and serve a same function. The logical structure can product modules and can be configured to instruct formation of a product based on product properties. The product properties can each include goal values, and the product modules each can be associated with at least one of the product properties. The GUI can also include a tool area, configured to provide a GUI of a selected tool selected from the navigator area, and provide a graphical navigator GUI configured to: display a combination of selectable indicators of any one of item sets and the first group of tools, and display relations between the displayed indicators of any one of item sets and the first group of tools. The tool area can also provide a node diagram associated with the logical structure, configured to: display items and item sets as nodes and relations thereof as interfaces between the nodes, and display modules and product module sets as graphically indicated areas including the nodes that belong to the modules and product module sets. The GUI can also include an editor area, configured to provide information regarding a tool, associated items, and relations thereof through an editor GUI, the content of the editor GUI dependent on item type.

In an example of the aforesaid exemplary embodiments, the GUI can include an indication of a loaded module system and a version of the loaded module system.

In an example of the aforesaid exemplary embodiments, the GUI can include an indication of level of interaction with the loaded module system permitted.

In an example of the aforesaid exemplary embodiments, the tools can be grouped into separate tabs in the navigator area (or in other embodiments, the tools can be grouped into separate browser windows or frames) including the first group of tools for capturing the logical structure of the loaded module system and the second group of tools that provide general access to items and item sets of the loaded module system.

In an example of the aforesaid exemplary embodiments, the first group of tools can include: a first category of tools for capturing market information related to the product; a second category of tools for capturing engineering information related to the product; a third category of tools for enhancing modularity and/or configurability of the product; a fourth category of tools for enhancing profitability of the product; and a fifth category of tools for capturing supply chain information related to the product, wherein each of the categories of tools includes a graphical indicator selectable to expand and collapse its respective list of tools in the navigator area.

In an example of the aforesaid exemplary embodiments, the indicators of the first group of tools in the graphical navigator GUI can include a first one or more shapes, and the indicators of the item sets in the graphical navigator GUI can include a second one or more shapes different from the first one or more shapes.

In an example of the aforesaid exemplary embodiments, each indicator in the graphical navigator GUI can include a respective label indicating the corresponding tool or item set.

In an example of the aforesaid exemplary embodiments, each indicator in the graphical navigator GUI can include an indication of a respective status or state of the corresponding tool or item set.

In an example of the aforesaid exemplary embodiments, each indicator in the graphical navigator GUI can be selectable for providing a comment regarding the corresponding tool or item set.

In an example of the aforesaid exemplary embodiments, the tool area can be further configured to provide a tool dropdown menu that includes functions related to an active tool in the tool area. In such an embodiment, the functions in the tool dropdown menu include a function for sorting the items related to the tool.

In an example of the aforesaid exemplary embodiments, the selectable indicators of any one of the first group of tools and item sets in the graphical navigator GUI can be arrangeable within the graphical navigator GUI.

In an example of the aforesaid exemplary embodiments, the nodes and interfaces in the node diagram can be arrangeable within the node diagram.

In an example of the aforesaid exemplary embodiments, the node diagram is in one of a regular node diagram layout, a circular node layout, or a hierarchical tree structure.

In an example of the aforesaid exemplary embodiments, the interfaces in the node diagram can include interfaces with conditions.

In an example of the aforesaid exemplary embodiments, the GUI can further include a menu bar configured to provide access to lists of functions of the PAS. In such an embodiment, the GUI can further include a tool bar configured to present preselected tools to list in the tool bar, and the availability of the menu and tool bars are dependent on the level of interaction with the loaded module system permitted.

Also, in an example of the aforesaid exemplary embodiments, the GUI can include a task navigator that is expandable and collapsible in a tasks tab in the navigator area, which shows tasks that are assigned to or originated by a user logged into the PAS interacting with the GUI.

Also, the editors of the GUI provided by the editor area can include an item editor, a relation editor, and search results.

Further, in an example of the aforesaid exemplary embodiments, the GUI can include an information bar configured to graphically indicate concurrent users of the loaded module system, status of an active tool, and status of a selected tool, item, or item set.

### BRIEF DESCRIPTION OF THE DRAWINGS

FIGS. 1, 1A, and 1B illustrate block diagrams of architectures related to a product architecture system (PAS).

FIG. 1C illustrates an information hierarchy related to the PAS.

FIG. 1D illustrates an information model related to the PAS.

FIGS. 2 through 3 illustrate example computers that can be used with or by the PAS.

FIGS. 4 through 114 and 116 illustrate example graphical user interfaces and graphical user interface parts of the PAS.

FIGS. 115 and 115A illustrates example operations for capturing a configuration profile using tools of the PAS.

### DETAILED DESCRIPTION

Embodiments of the invention are described more fully hereinafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure can be thorough and complete, and can fully convey the scope of the invention to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It can be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It can be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It can be understood that, although the terms first, second, etc. may be used herein to describe various elements, these elements should not be limited by these terms. These terms are only used to distinguish one element from another. Thus, a first element could be termed a second element without departing from the teachings of the present invention.

It is to be understood that product modules disclosed herein can include modules for a product or a service. Although systems for product architecture lifecycle management are described herein, the systems are also applicable to lifecycle management for services. Thus, for this disclosure, where context permits, the term “product” encompasses the term “service” or “product”.

Those skilled in the art can provide computer readable instructions with data structures to implement the technologies described and/or illustrated herein. Although the present invention has been described with reference to exemplary embodiments, workers skilled in the art will recognize that changes may be made in form and detail without departing from the spirit and scope of the invention.

Unless otherwise defined, all terms (including technical and scientific terms) used herein have the same meaning as commonly understood by one of ordinary skill in the art to which this invention belongs. It can be further understood that terms, such as those defined in commonly used dictionaries, should be interpreted as having a meaning that is consistent with their meaning in the context of the relevant art and cannot be interpreted in an idealized or overly formal sense unless expressly so defined herein.

### Overview of the Product Architecture System (PAS)

The product architecture system (hereinafter referred to as the PAS) is a system that can generate and/or describe a product architecture. From such a product architecture, the PAS or an external system connected to the PAS can generate a configuration profile. In one example, the PAS can define configuration logic, which can be one of many outputs that the PAS can provide. Other outputs can include, for example, design specification, volume forecast for production, profitability forecasts, price models, cost targets and complexity cost. An example product architecture outputted by the PAS can provide several views of a product that are consistent and aligned such that views provide a foundation for an efficient downstream operation across several support systems and activities.

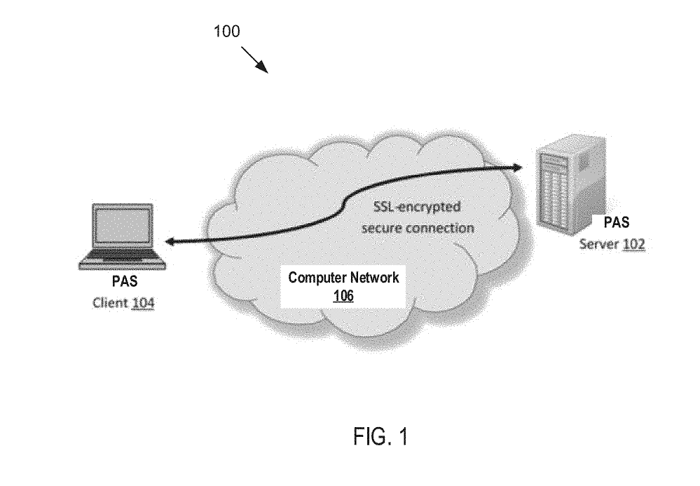

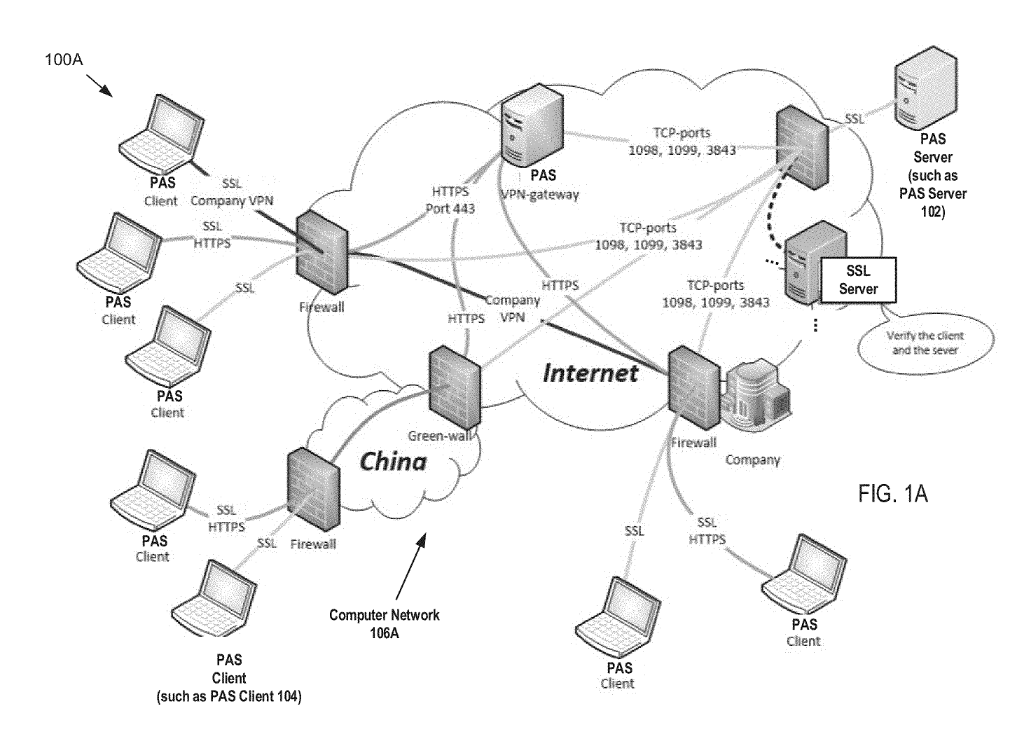

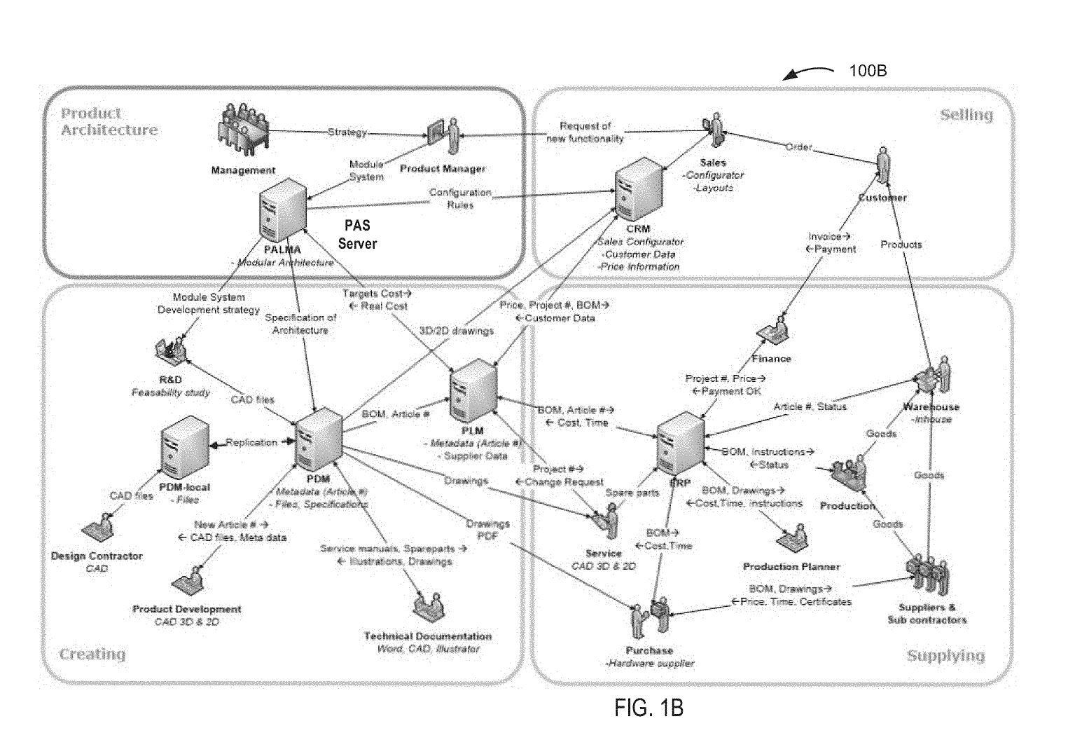

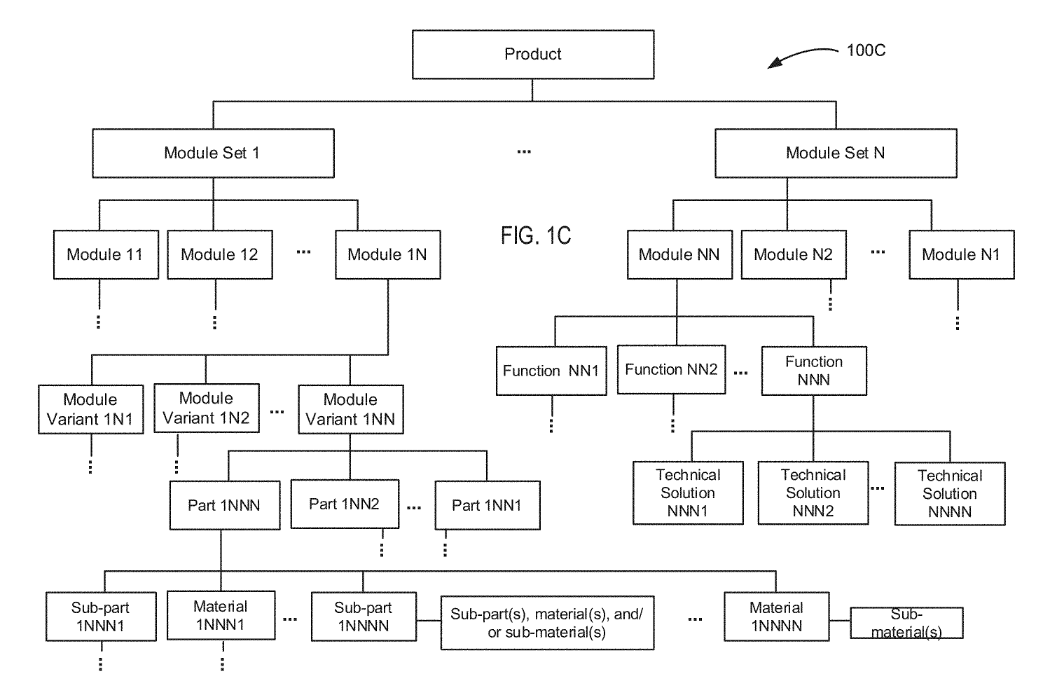

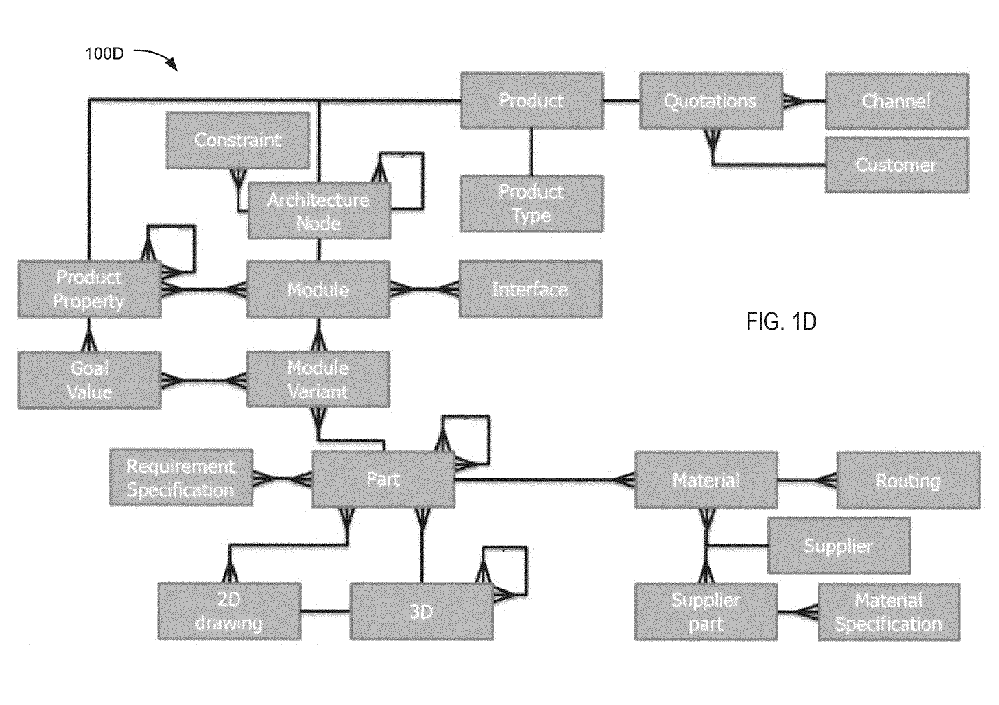

FIG. 1 illustrates a block diagram of a computer network architecture 100 (also herein referred to as system 100) that can provide the PAS.

PAS can be a client-server based system as illustrated in FIG. 1. This means that the end user device includes a PAS client application running on the device. The client application can communicate with the server thru the Internet (such as a cloud system) to retrieve information (e.g., data for module systems). The connection across the Internet can be made through a secure SSL-encrypted connection. The end user device can login to establish a connection with the server. The PAS client application can be hosted by a client server in some embodiments. In some other embodiments, a thin client can be used in that the PAS client is accessed through a web browser.

At login, a user, via use of the end user device, is identified and authorized with privileges according to user type. PAS can allow different actions and access depending on the authorization in separate module systems; these can however never exceed the privileges of the user type.

As depicted, the computer network architecture 100 in the example of FIG. 1 includes a PAS server 102 and a PAS client 104. The PAS server 102 can be coupled to a database and the PAS client 104 over computer network 106.

FIG. 1A illustrates a block diagram of a computer network architecture 100A (also herein referred to as system 100A) that can also provide the PAS. FIG. 1A includes a PAS server such as server 102, and multiple PAS clients (wherein each may be similar to PAS client 104). The PAS clients are coupled to the PAS server over computer network 106A. The computer network 106A depicts the PAS client devices coupled to the PAS server via SSL VPN connections, SSL and HTTPS connections (including SSL HTTPS connections), firewalls, a PAS VPN-gateway, TCP ports, and HTTPS ports. An SSL server is also shown in the computer network 106A, which can manage the SSL connections. The PAS VPN-gateway can manage the VPN connections.

The computer network architecture 100 may be implemented at least partially in a cloud computing environment, at least partially in a server, at least partially in a client device, or in a combination thereof.

Information associated with the PAS may include database records stored in databases. Suitable information may be stored, maintained, updated and read from the databases by the PAS server 102.

The PAS server 102 may be implemented using a single server computer, a plurality of server computers, or other types of computing devices known in the art. Access to the servers can be accomplished through a firewall that protects information used and stored in these servers and their respective databases from external tampering. Additional security may be provided via enhancements to the standard communications protocols, such as Secure HTTP (HTTPS) or the Secure Sockets Layer (SSL). Such security may be applied to PAS server 102 and associated databases, and the PAS client 104.

The PAS server 102 and client 104 may provide an operator graphical user interface to simplify their respective processes. The operator graphical user interfaces may include a circuit, program, application, or software routine that forms a user interface. In a particular example, the operator graphical user interface is accessible as a website. Through the graphical user interface, the operator may interact with the computer, apparatus or device to view, input, or store information, as well as generate reports based on the information. Such data may be viewed in real time using the operator graphical user interface. A script and/or applet may be a part of this graphical user interface and may render access points for retrieval of such information. The script and/or applet may be implemented via a circuit. In an example, a graphical user interface may include a graphical display of fields for selecting various aspects of the information describe herein. The graphical user interface, via the script and/or applet, can request the various aspects of information. The information can be displayed, such as displayed according to the script and/or applet.

In an example, information associated with PAS can be served from the server 102 and used via a client-side application, such as a web browser, on the client 104. Such a client-side application may be rendered by the client 104. The client-side application can be used by different types of operators, including engineers, product managers, and sales representatives. The client-side application can output of graphical elements that include components of a process with a visually pleasing layout.

FIG. 1B illustrates a block diagram of a computer network architecture 100B (also herein referred to as system 100B) that can also provide the PAS. FIG. 1B depicts servers and client application devices communicating respective product information to and from each other. The servers and client application devices include servers and devices associated with product architecture, product development, supply of product parts and materials, and sales areas. Each one of these areas is shown to have respective servers and client application devices, and these primary areas can communicate with each other as shown in FIG. 1B.

Shown in FIG. 1B, the product architecture area includes devices for product management and management of product strategy. Also shown is an example PAS server, such as the PAS server shown in FIG. 1. The sales area includes devices for sales personnel and customers. Also shown is an example customer relationship management (CRM) server connected to the devices. The supply area includes devices for finance, warehousing, production, suppliers and sub-contractors, production planners, purchasing, and product service entities. Also, shown is an example enterprise resource planning (ERP) server connected to the devices. The product development entity includes devices for research and development, design contractors, product development, and technical documentation. Also, shown is an example product data management (PDM) server (which is shown as replicated), and an example product lifecycle management (PLM) server, both shown as connected to the devices.

FIG. 1B illustrates an example PAS server (such as PAS server 102) communicating directly with a client application device of a product manager (e.g., see the device labeled “Product Manager” in FIG. 1B), a client application device of a research and development entity (e.g., see the device labeled “R&D”), a local PDM server (e.g., see the server labeled “PDM-local”), a primary PDM server (e.g., see the server labeled “PDM”), a PLM server (e.g., see the server labeled “PLM”), and a CRM server (e.g., see the server labeled “CRM”). The PAS server, as shown, can generate the modular architecture of a product (a modular product architecture), module system development strategy information, specification architecture information, target cost information, and configuration rules. The aforesaid information may be used by the PAS server to derive a configuration profile for a product. And, the aforesaid information may be gathered by the various PAS tools described herein.

The product manager application device is shown in FIG. 1B directly receiving strategy information from a management application device (e.g., see the device labeled “Management”), which can be generated by the management application device. The product manager application communicates module system information directly to the PAS server. The module system information can be based on the strategy information and produced by the product manager application device. The module system information can also be based on a request of new functionality information received from a sales application device, as shown. The new functionality information can be generated by the sales application device. The sales application device can receive orders information from a customer or a customer application device, as shown. The sales application can include a configurator system and layouts that are compatible with a configuration profile generated by the PAS server.

As shown in FIG. 1B, the PAS Server can communicate configuration rules to the CRM server. The CRM server can also receive sales information from the sales application device, 3D and 2D drawings of a product or parts of the product from the PDM server, and price, project, and BOM information from the PLM server. The CRM can produce customer data and price information using a sales configurator system that is compatible with a configuration profile generated by the PAS server.

FIG. 1B also depicts the PDM server generating metadata, data files, and specifications related to product information and the product architecture. The PDM can also replicate itself on another server, such as a local server (e.g., see the server labeled “PDM-local”). The PDM server can also receive CAD files from the research and development client application, which can be based on the module system development strategy information that is communicated from the PAS server. The generation of the information by the PDM server can be derived from the specification of the product architecture, the CAD files, and/or the configuration profile. Also, as shown in FIG. 1B, the PDM server can communicate or receive various types of product information to and from various product development and design applications, technical documentation applications, service and purchaser applications, the PLM server, and the CRM server.

FIG. 1B also depicts the PLM server generating metadata related to the product information and supplier data based on at least one of: drawings communicated from the PAS server; price, customer, and sales information communicated from the CRM server; similar types of information, but related to supply of parts and material, from one or more ERP servers; and change requests from service application devices. As shown, the PLM server can provide drawings and other forms of product information to such servers and client applications.

FIG. 1C illustrates an information hierarchy 100C and relationships of product architecture information generated and received by aspects of the PAS, such as the servers and client application devices of the PAS described herein. As shown in FIG. 1C, the information is organized into objects of an object hierarchy that can be a part of a configuration profile and/or a logical structure configured to instruct formation of a product based on product properties.

As depicted, all the information of the hierarchy relates to the top-level object that is the product object. The product object includes one or more module set objects, and is associated with a product designed and managed by the PAS. Each of the module set objects includes one or more product module objects. A module set object is associated with a module set related to the product. The product object may also include module objects not associated with module set objects (which is not depicted). A module object is associated with a product module related to the product.

Each product module object can include one or more product function objects and/or one or more module variant objects. Each function object can include one or more technical solution objects related to respective one or more technical solutions of the product. Each module variant object can include one or more product part objects. A module variant object is related to a module variant of the product, and a product part object is related to a part of the product. Each product part object can include one or more sub-part objects and/or one or more product material objects. A sup-part object is related to a sub-part of a part of the product. A product material object is related to a material of a product part or an actual product part from a supplier. Also, each sub-part object can include one or more sub-part objects and/or one or more product material objects. Each material object can include one or more sub-material objects. A sub-material object is related to a sub-material of a product material of the product.

FIG. 1D illustrates an information model 100D that can be a part of or associated with a configuration profile and/or a logical structure configured to instruct formation of a product based on product properties. Examples of the model 100D can be generated and received by aspects of the PAS, such as the servers and client application devices of the PAS described herein.

FIG. 1D depicts a product having or being related to at least one product property having or being related to one or more goal values and other product properties. The product can have or be related to an architecture node that can include or be related to one or more constraints and other architecture nodes. An architecture node can also include and be related to a product module. A product module can include and be related to one or more product properties, module variants, and module interfaces. The product properties can be related to one or more product modules. A module interface can be related to one or more product modules.

The product can also include a product type and product quotations. Each product quotation can be related to a product channel or customer. The channels and customers can each have one or more product quotations.

A product property can have one or more goal values and each goal value can have one or more module variants. Each module variant can be associated with one or more goal values, a product module, and a product part.

A product part can include one or more other product parts (such as sub-parts of the part), requirement specifications, and 2D and 3D drawings. Requirement specifications can have or be associated with one or more product parts. The drawings can also have or be associated with one or more product parts. As mentioned herein, each product part and sub-part may have or include one or more materials. A material may be and/or include an actual product part, wherein the product parts and sub-parts described herein are generic definitions of a part or sub-part that can be satisfied by an actual part or sub-part. A material may have or be associated with one or more routing or supply chain feature, and a supplier. The material also may have one or more supplier parts (actual product parts and sub-parts). A supplier part can have one or more supplier material specifications (specifications of actual product parts and sub-parts).

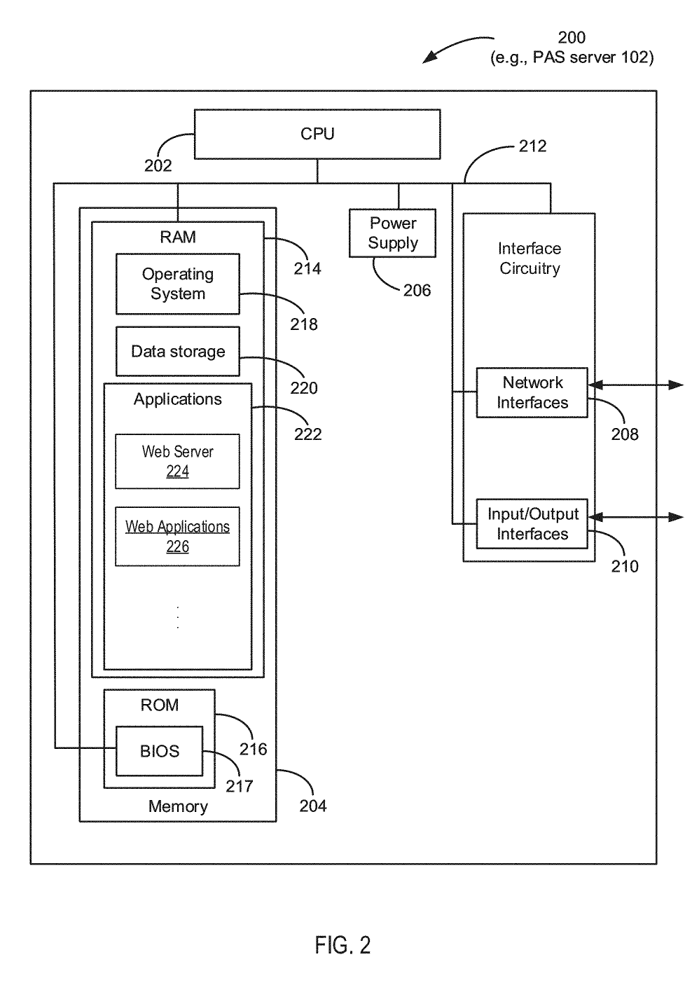

FIG. 2 illustrates an example computer 200 that can implement the PAS server 102 depicted in FIG. 1. The computer 200 can include a central processing unit (CPU) 202, a memory circuit 204, a power supply circuit 206, and input/output circuits, such as network interfaces 208 and input/output interfaces 210, and a communication bus 212 that connects the aforementioned elements of the computer. The network interfaces 208 can include a receiver and a transmitter (or a transceiver), and an antenna for wireless communications. The CPU 202 can be any type of data processing device, such as a central processing unit (CPU). Also, the CPU 202 can be central processing logic; central processing logic may include hardware (such as circuits and/or microprocessors), firmware, software and/or combinations of each to perform functions or actions, and/or to cause a function or action from another circuit of the computer 200. Also, central processing logic may include a software controlled microprocessor, discrete logic such as an application specific integrated circuit (ASIC), a programmable/programmed logic device, memory device containing instructions, a combinational logic embodied in hardware, or any combination thereof. Also, logic may also be fully embodied as software. Also, the CPU 202 can include one or more data processing devices or processors that may be in combination with local or remote memory.

The memory circuit 204, which can include random access memory (RAM) 214 or read-only memory (ROM) 216, can be enabled by memory hardware, such as a primary (directly accessible by the CPU) and/or a secondary (indirectly accessible by the CPU) storage device (such as flash memory, magnetic disk, optical disk). The memory devices or circuits described herein may also be local or remote with respect to one or more processors, such as CPU 502.

The RAM 214 can store data and instructions defining an operating system 218, data storage 220, and applications 222, including a web server 224 and web applications 226. The applications 222 and 226 can include sub-applications such as corresponding to any of the tools, GUIs, or the like described herein. Each of these applications and sub-applications may be implemented via circuits. The circuits may be combined with scripts and/or applets. The applications 222 and sub-applications may include hardware (such as circuits and/or microprocessors), firmware, software, or any combination thereof. Example information provided by an application, such as the web applications 226, may include text, images, audio, video, or any combination thereof, which may be processed in the form of physical signals, such as electrical signals, or may be stored in memory, as physical states.

The ROM 216 can include basic input/output system (BIOS) 217 of the computer 200. The power supply circuit 206 contains power components, and facilitates supply and management of power to the computer 200. The input/output circuits can include various types of interfaces for facilitating communication between components of the computer 200, components of external computers (such as components of other computers of the system 100), and end users. For example, such circuits can include a network card that is an integration of a receiver, a transmitter, and I/O interfaces. The network interfaces 208 may include a network card. A network card can facilitate wired or wireless communication with other computers and network devices of a network. In cases of wireless communication, an antenna can facilitate such communication. The I/O components, such as I/O interfaces 210, can include user interfaces such as monitors, keyboards, touchscreen displays, microphones, and speakers.

The computer 200 may be capable of sending or receiving signals, such as via a wired or wireless network, or may be capable of processing or storing signals, such as in memory as physical memory states, and may operate as a server. The computer 200 may include dedicated rack□mounted servers, desktop computers, laptop computers, integrated devices, and any combination thereof. The computer 200 also include a mass storage device, a power supply, wired and wireless network interfaces, input/output interfaces, and/or a computer operating system, such as Windows Server.

The computer network 106 may include a data communication network or a combination of networks. A network may couple devices, such as computers of a computer network, so that communications may be exchanged, such as between a server and a client device or other types of devices, including between wireless devices coupled via a wireless network. The network 106 may include mass storage, such as a network attached storage (NAS), a storage area network (SAN), or other forms of computer or machine-readable media. The network 106 may include the Internet, local area networks (LANs), wide area networks (WANs), wire□line type connections, wireless type connections, or any combination thereof.

The client 104 may include a central processing unit that may access the server 102 and associated databases in the computer network architecture 100 over the network 106. The client 104 may implement a client-side application for viewing electronic properties and submitting user requests, and may communicate data to the server and an associated database, including data defining electronic properties and other information. The client 104 may receive communications from any server or database of the computer network architecture 100, including data defining electronic properties and operations information. The interactions and information may be logged in data logs and such logs may be communicated to an analytics server for processing, such as an analytics server connected to the server 102. Once processed into corresponding analytics data, such data can be input for determining products and solutions to maintain and improve operations related to the tests, authentication, sales, marketing, etc.

The client 104 may include a computing device, such as a computer, capable of sending or receiving signals, such as via a wired or a wireless network. The client 104 may include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, and any combination thereof. The client 104 may include or may execute a variety of operating systems, including a personal computer operating system. The client 104 may also include or execute an application to communicate content, such as, textual content, multimedia content, or the like.

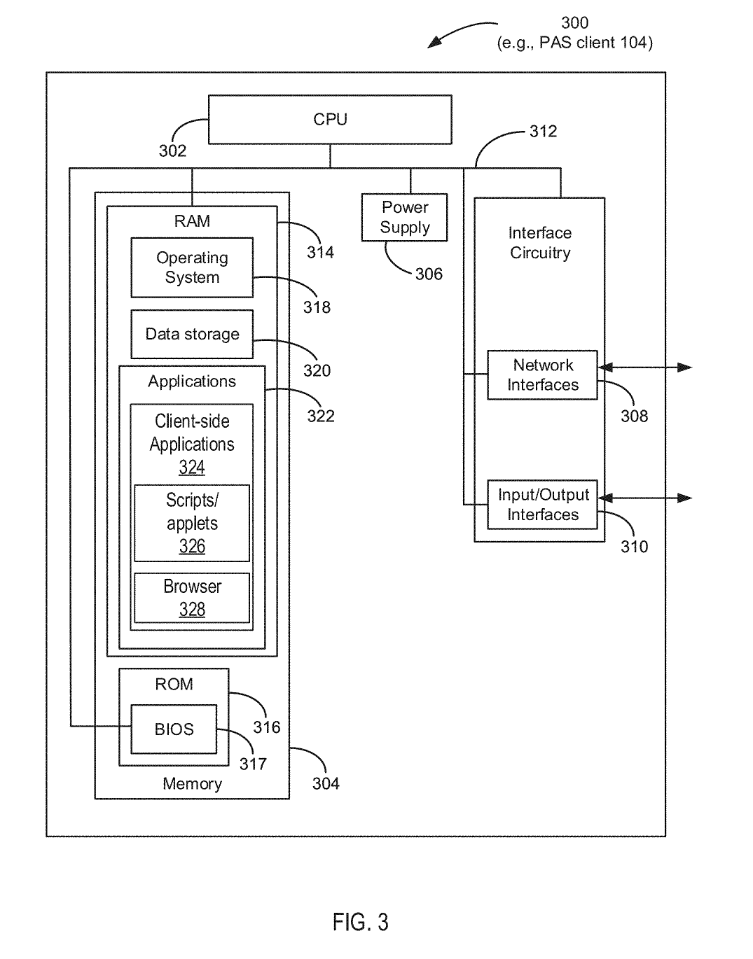

FIG. 3 illustrates an example computer 300 that can implement client-side parts of the applications distributed by the PAS, such as the client-sides to the server-sides of the web applications 226 of FIG. 2. The example computer 300 can implement the PAS client 104 depicted in FIG. 1 as well. The computer 300 can include a central processing unit (CPU) 302, a memory circuit 304, a power supply circuit 306, and input/output circuits, such as network interfaces 308 and input/output interfaces 310, and a communication bus 312 that connects the aforementioned elements of the computer. The network interfaces 308 can include a receiver and a transmitter (or a transceiver), and an antenna for wireless communications. The CPU 302 can be any type of data processing device, such as a central processing unit (CPU). Also, the CPU 302 can be central processing logic; central processing logic may include hardware (such as circuits and/or microprocessors), firmware, software and/or combinations of each to perform functions or actions, and/or to cause a function or action from another circuit of the computer 300. Also, central processing logic may include a software controlled microprocessor, discrete logic such as an ASIC, a programmable/programmed logic device, memory device containing instructions, a combinational logic embodied in hardware, or any combination thereof. Also, logic may also be fully embodied as software.

The memory circuit 304, which can include random access memory (RAM) 314 or read-only memory (ROM) 316, can be enabled by memory hardware, such as a primary (directly accessible by the CPU) and/or a secondary (indirectly accessible by the CPU) storage device (such as flash memory, magnetic disk, optical disk).

The RAM 314 can store data and instructions defining an operating system 318, data storage 320, and applications 322, including client-side applications 324 such as client-side parts of the PAS. The client-side parts can include sub-applications such as corresponding scripts/applets 326. Also, the client-side parts may be implemented through a web browser 328. Each of these applications may be implemented physically via circuits. The applications 322 and sub-applications may include hardware (such as circuits and/or microprocessors), firmware, software, or any combination thereof. Example information provided by an application, such as the client-side parts, may include text, images, audio, video, or any combination thereof, which may be processed in the form of physical signals, such as electrical signals, or may be stored in memory, as physical states.

The ROM 316 can include basic input/output system (BIOS) 317 of the computer 300. The power supply circuit 306 contains power components, and facilitates supply and management of power to the computer 300. The input/output circuits can include various types of interfaces for facilitating communication between components of the computer 300, components of external computers (such as components of other computers of the system 100), and end users. For example, such circuits can include a network card that is an integration of a receiver, a transmitter, and I/O interfaces. The network interfaces 308 may include a network card. A network card can facilitate wired or wireless communication with other computers and network devices of a network. In cases of wireless communication, an antenna can facilitate such communication. The I/O components, such as I/O interfaces 310, can include user interfaces such as monitors, keyboards, touchscreen displays, microphones, and speakers.

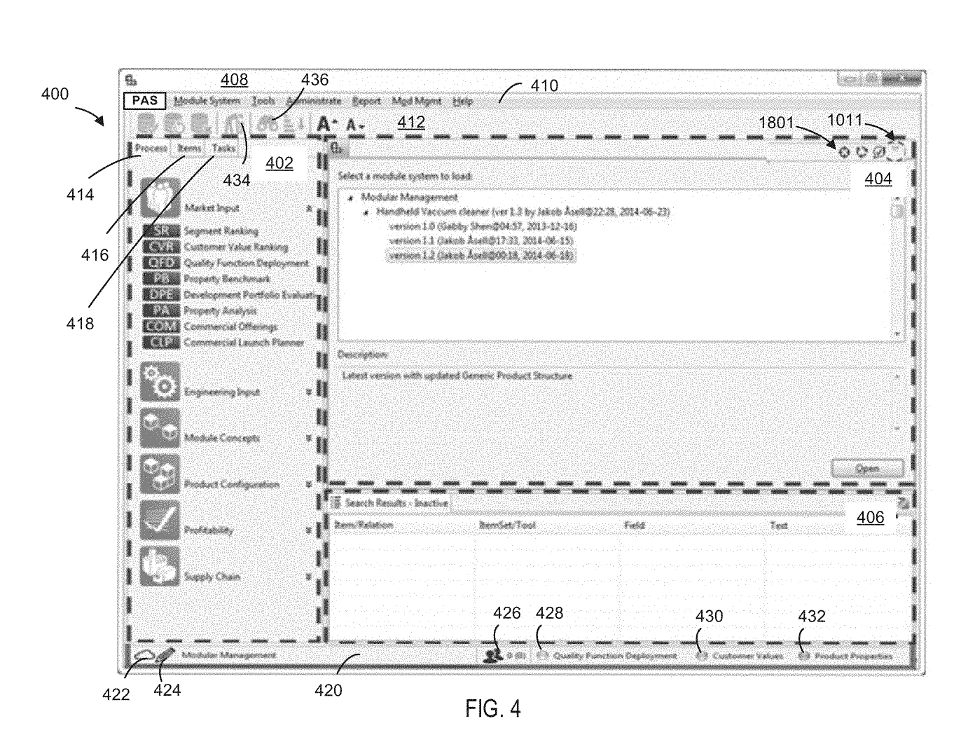

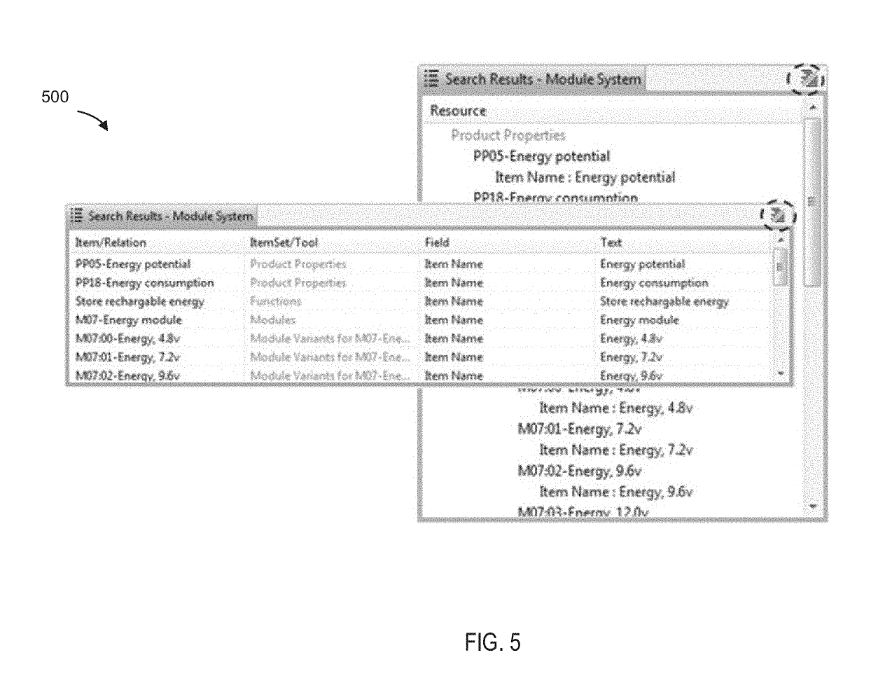

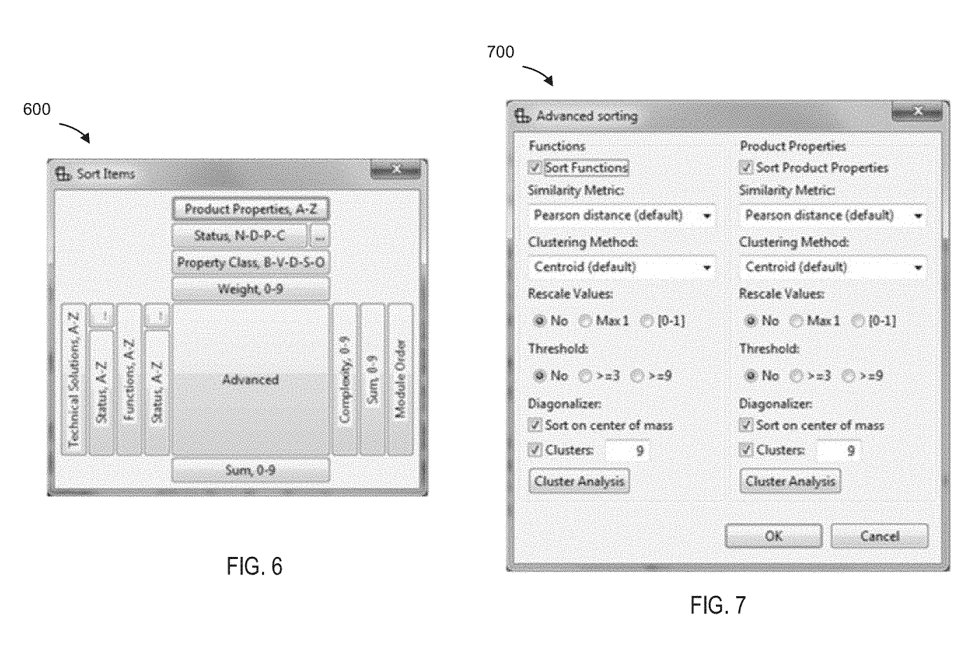

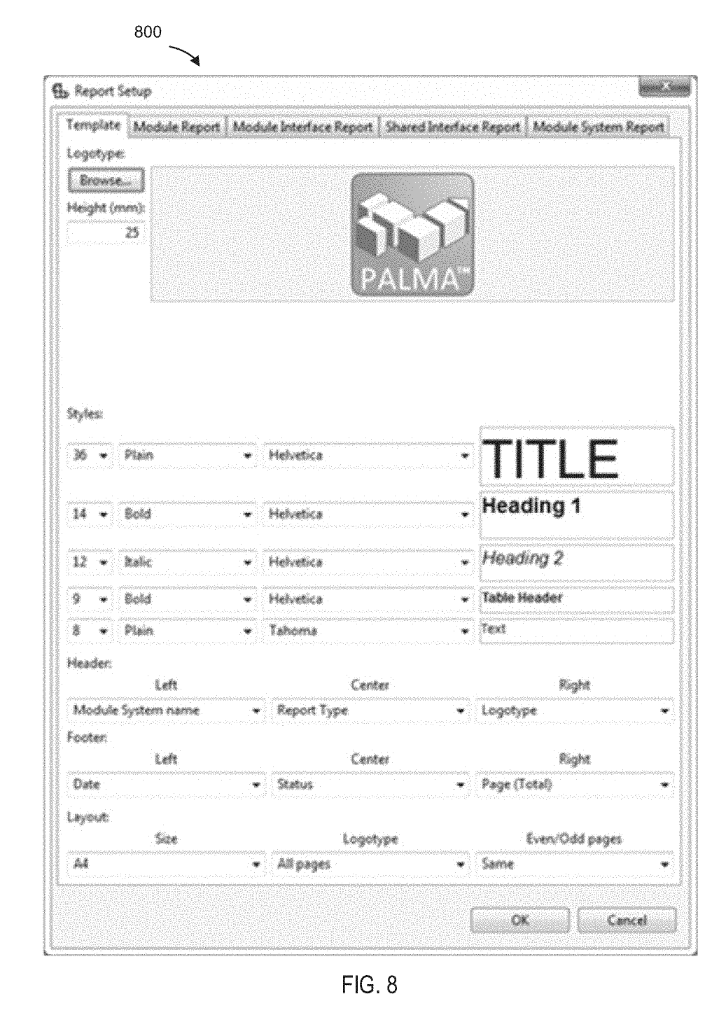

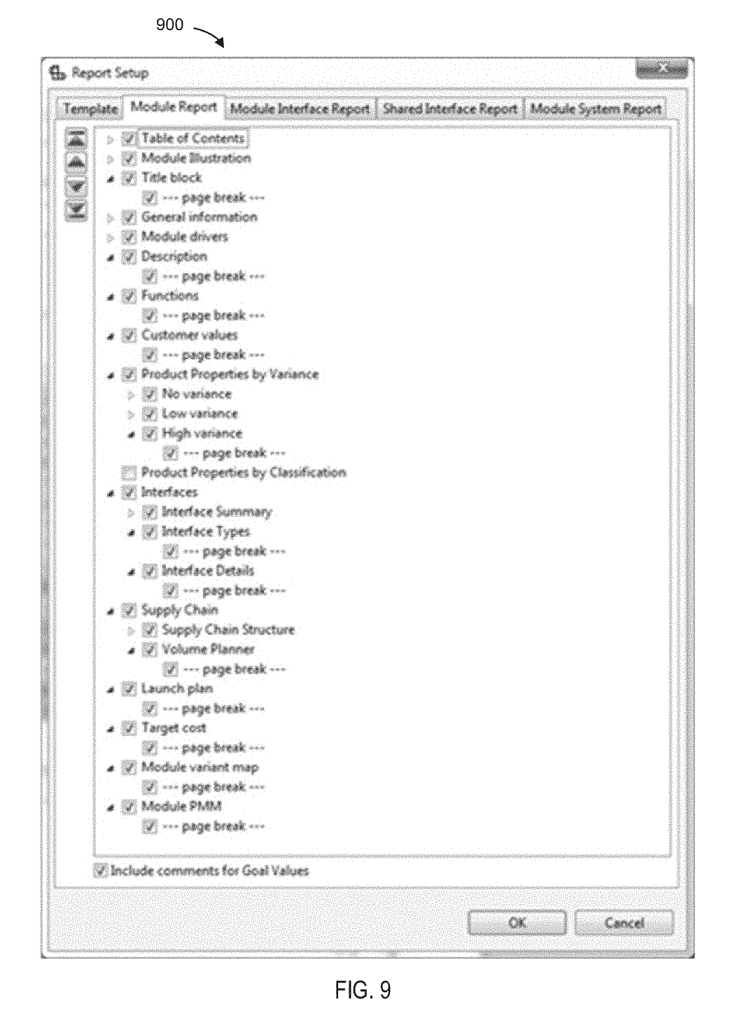

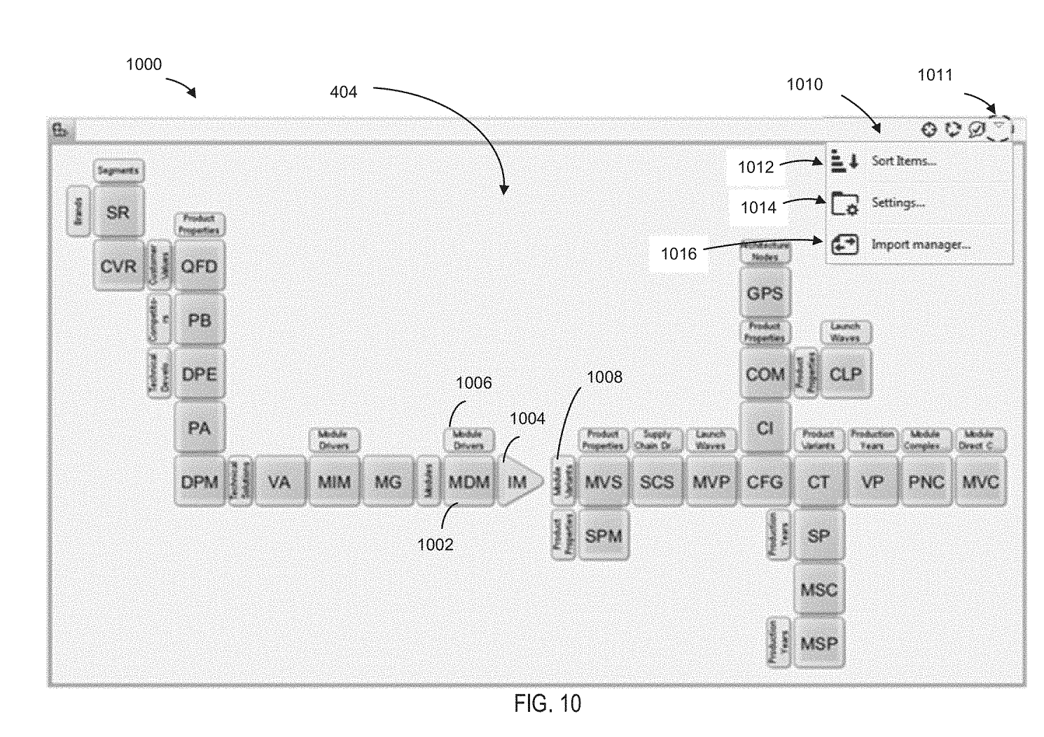

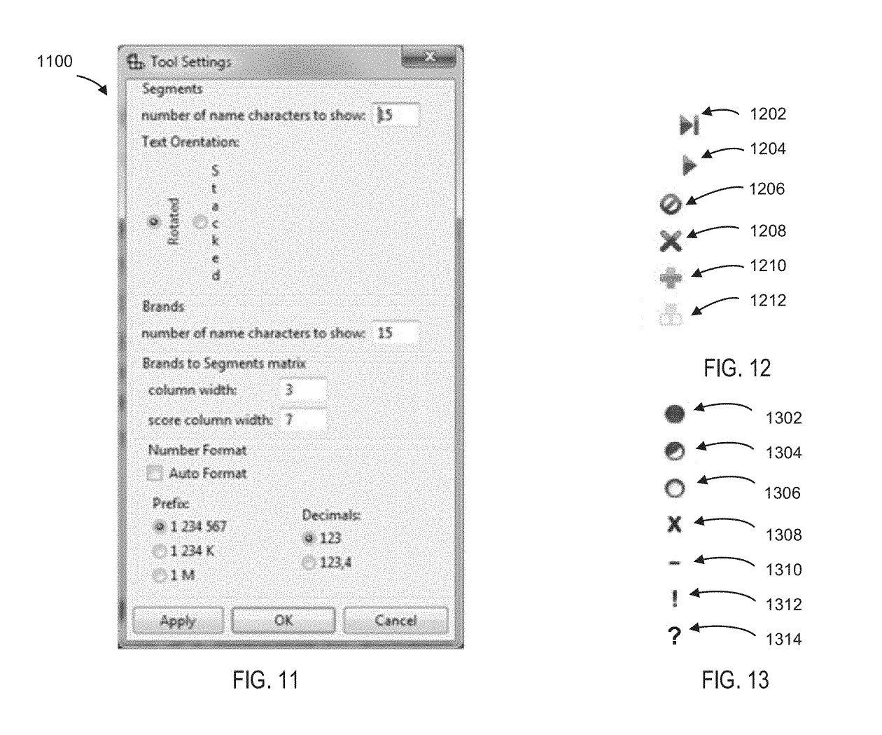

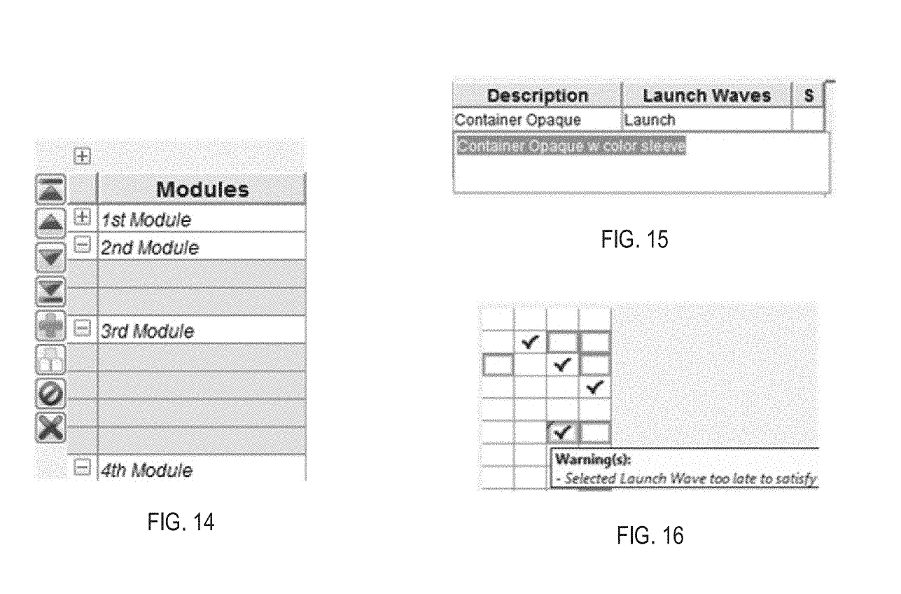

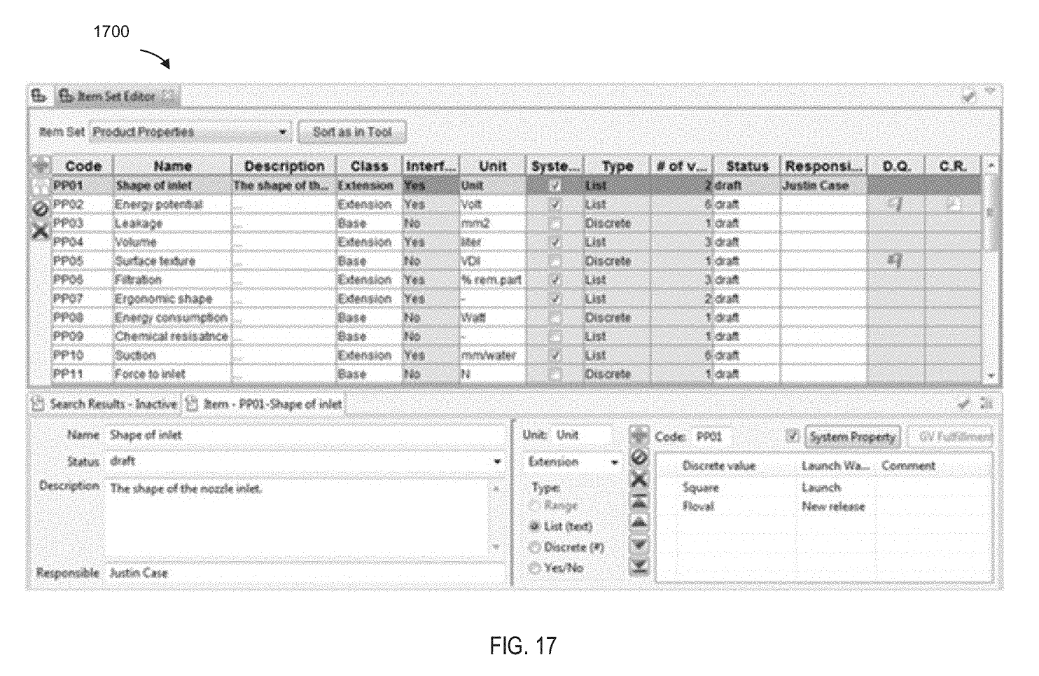

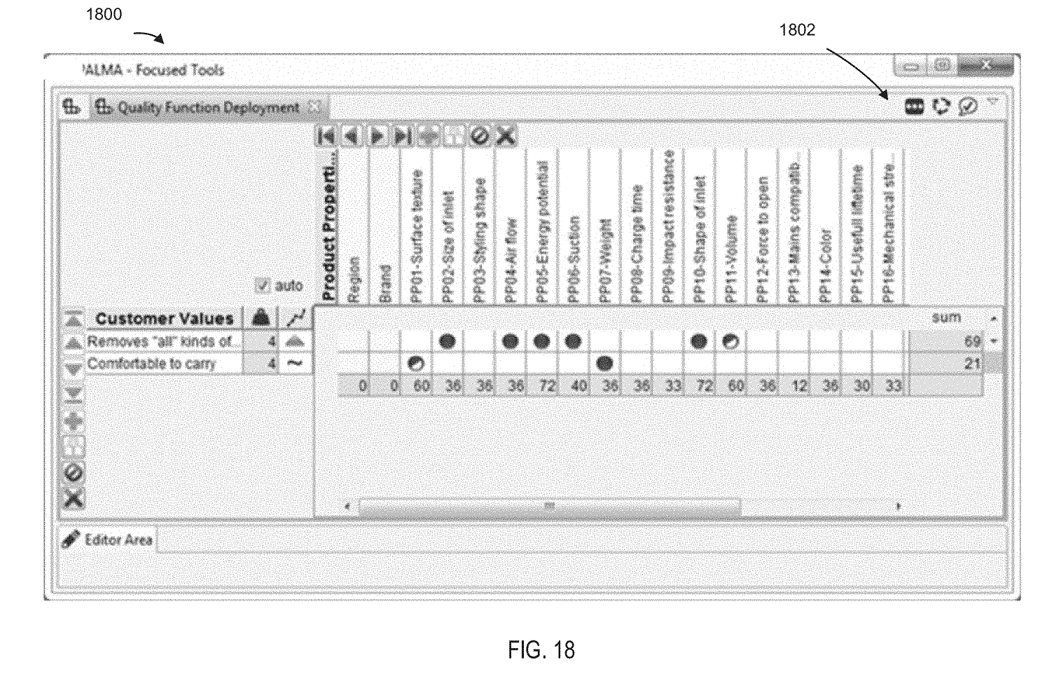

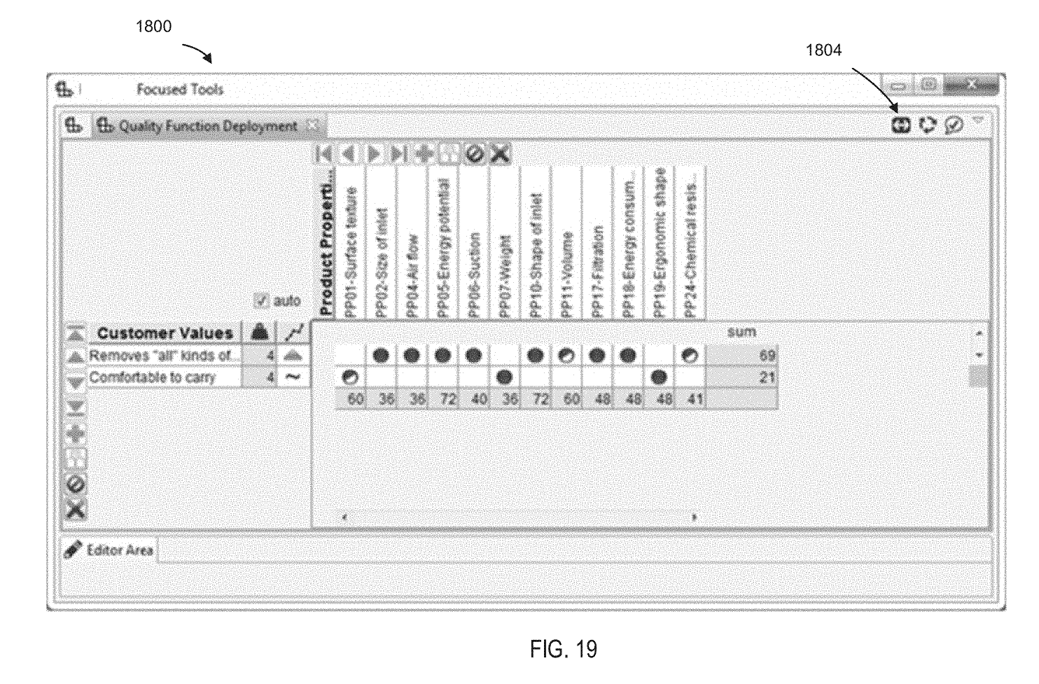

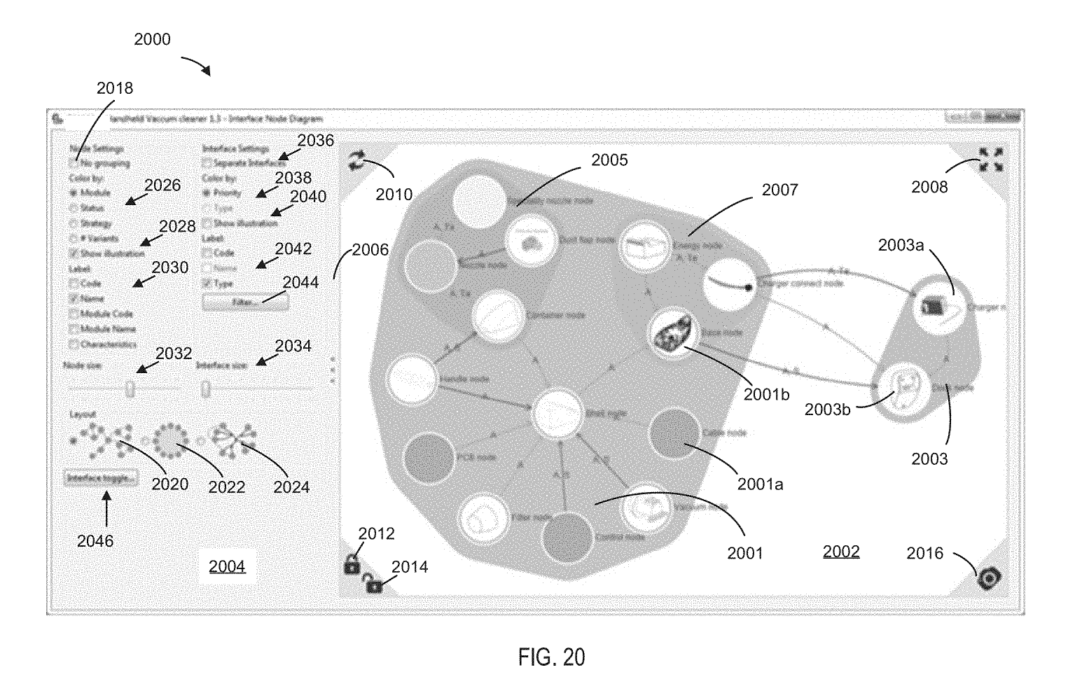

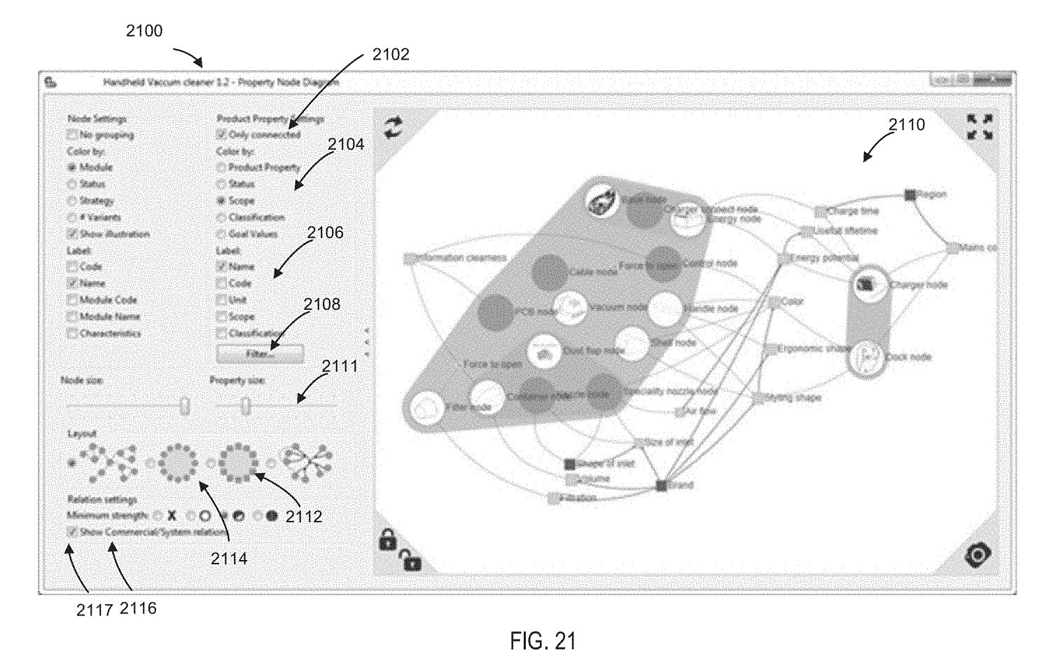

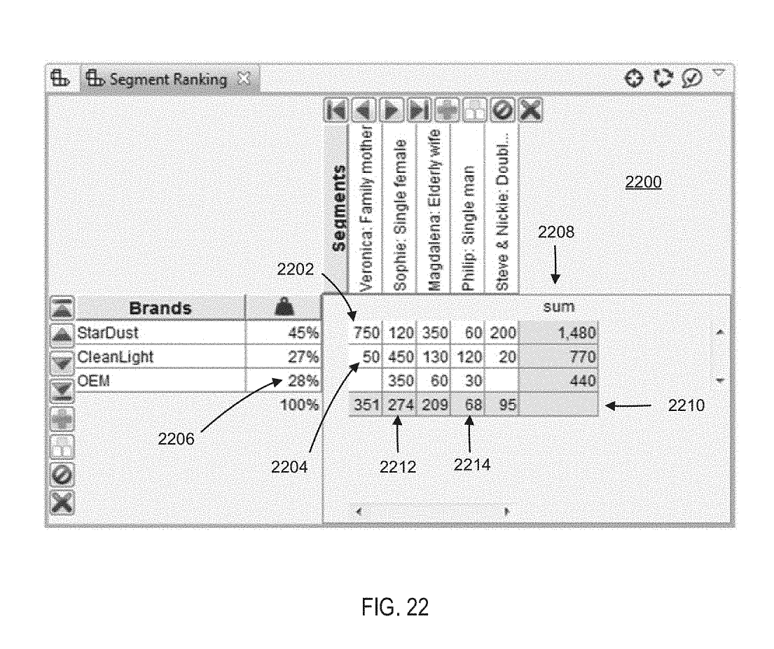

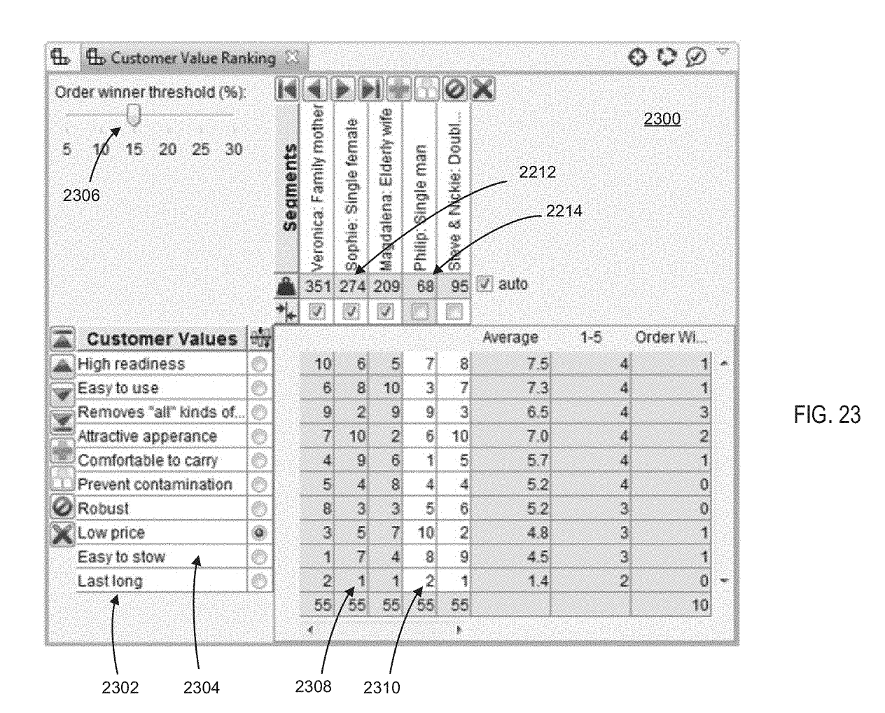

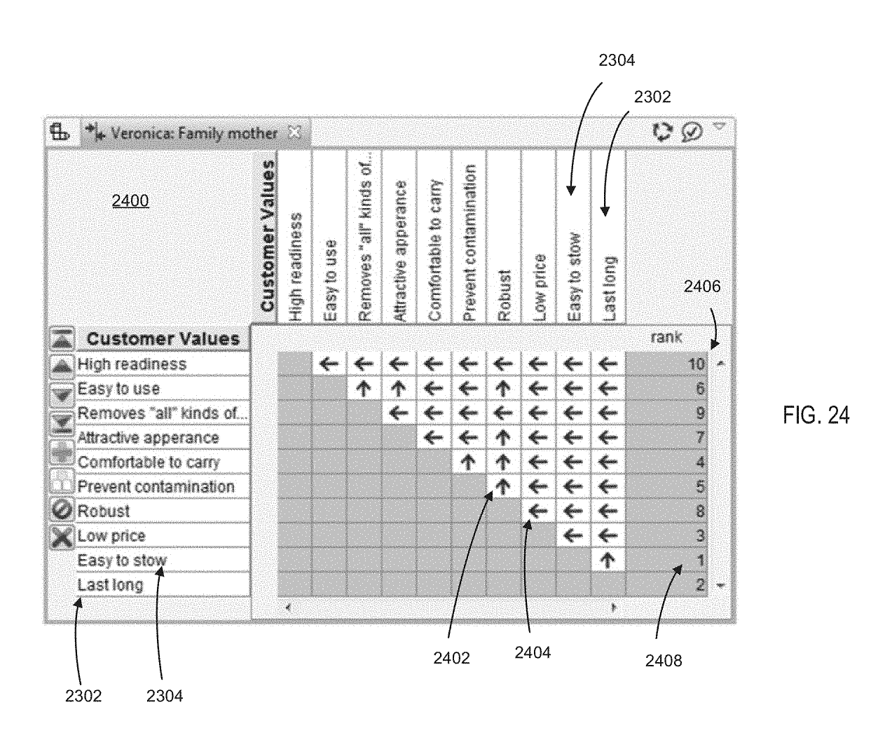

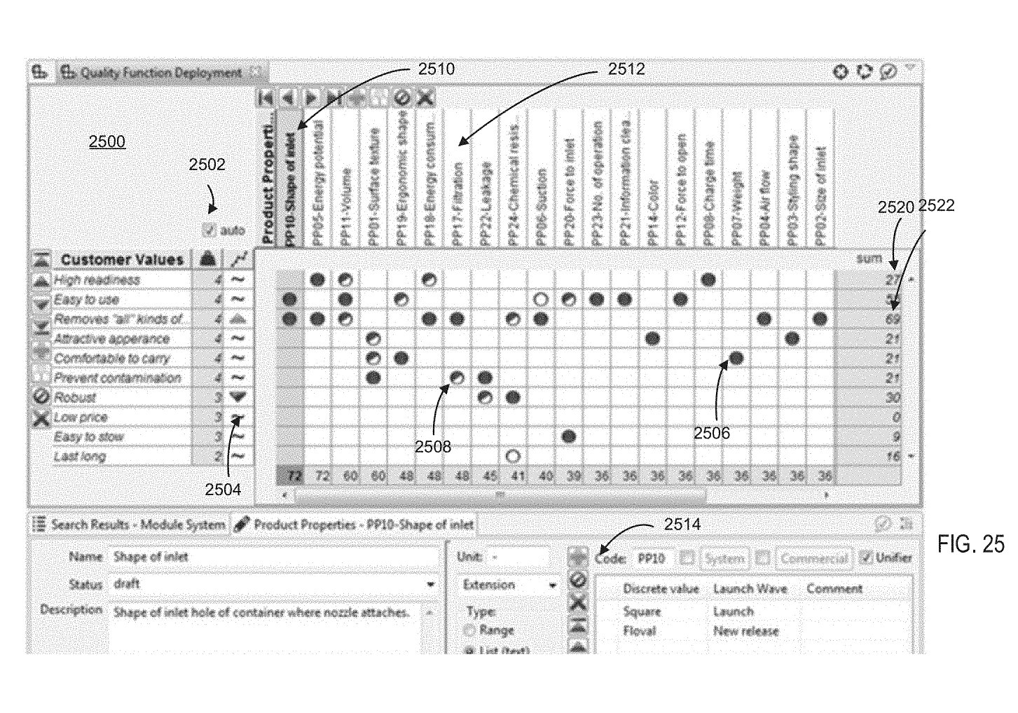

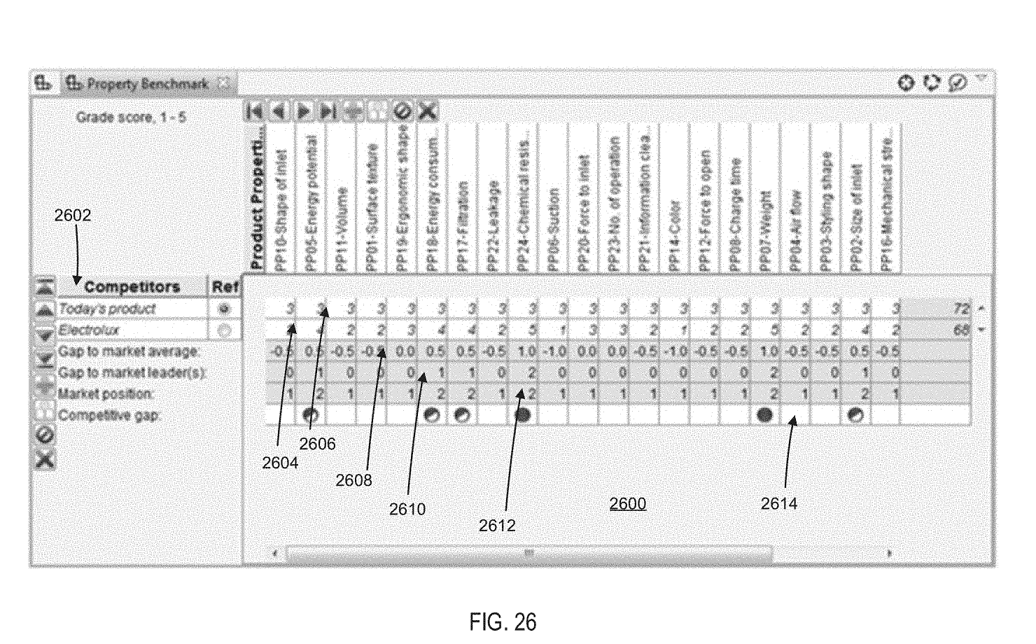

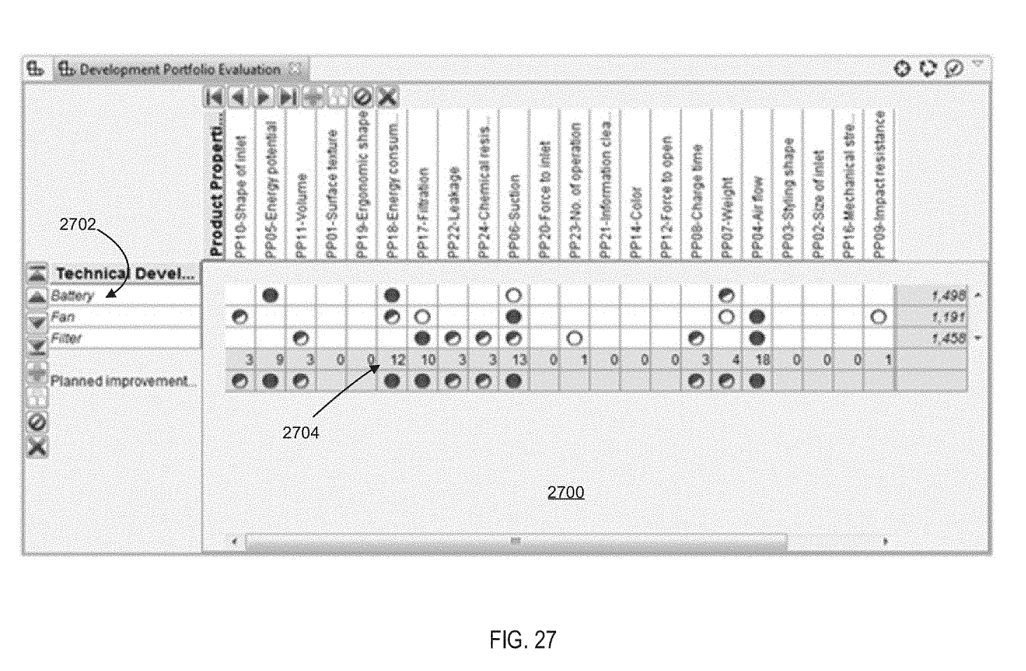

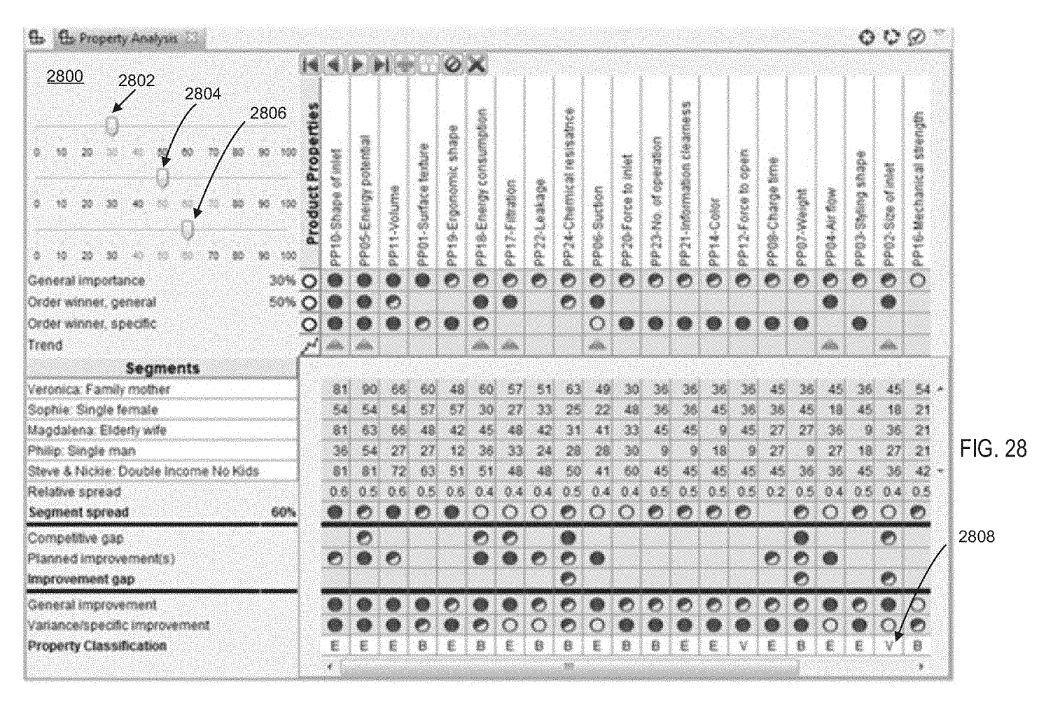

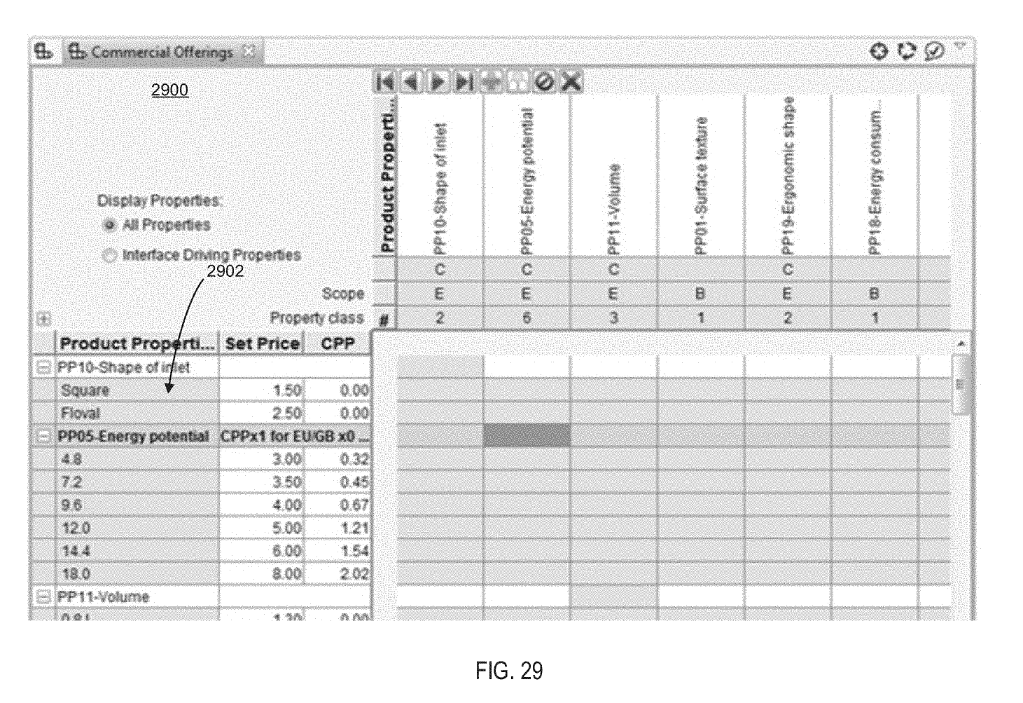

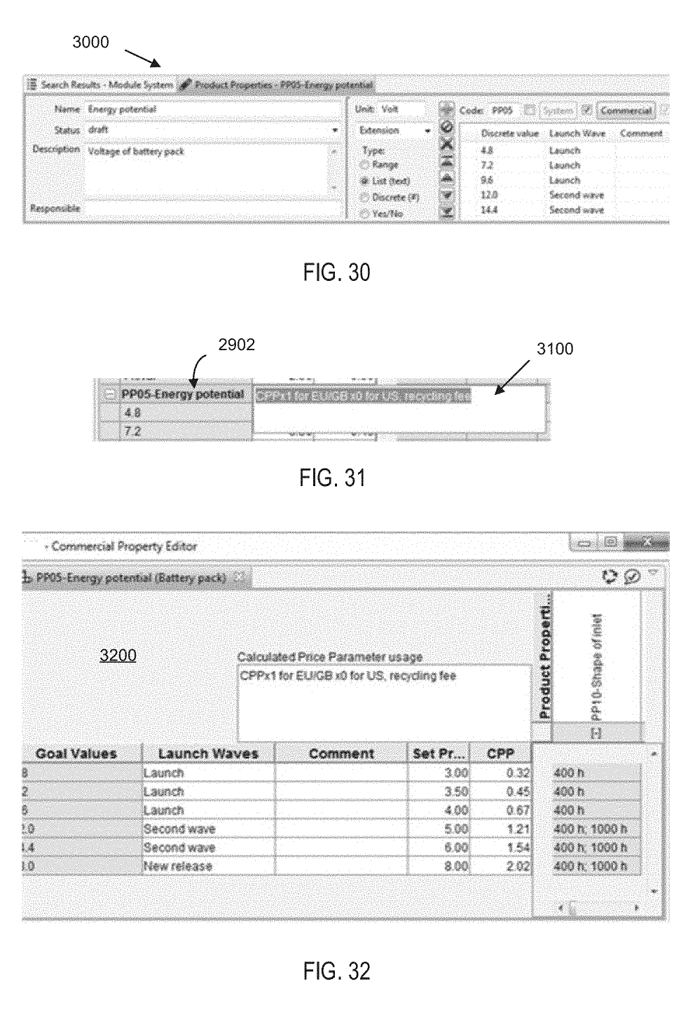

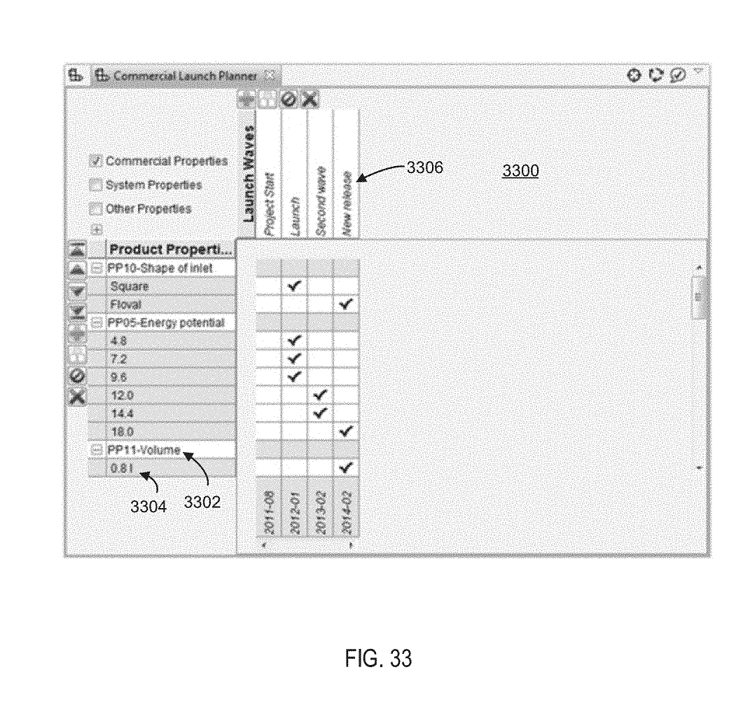

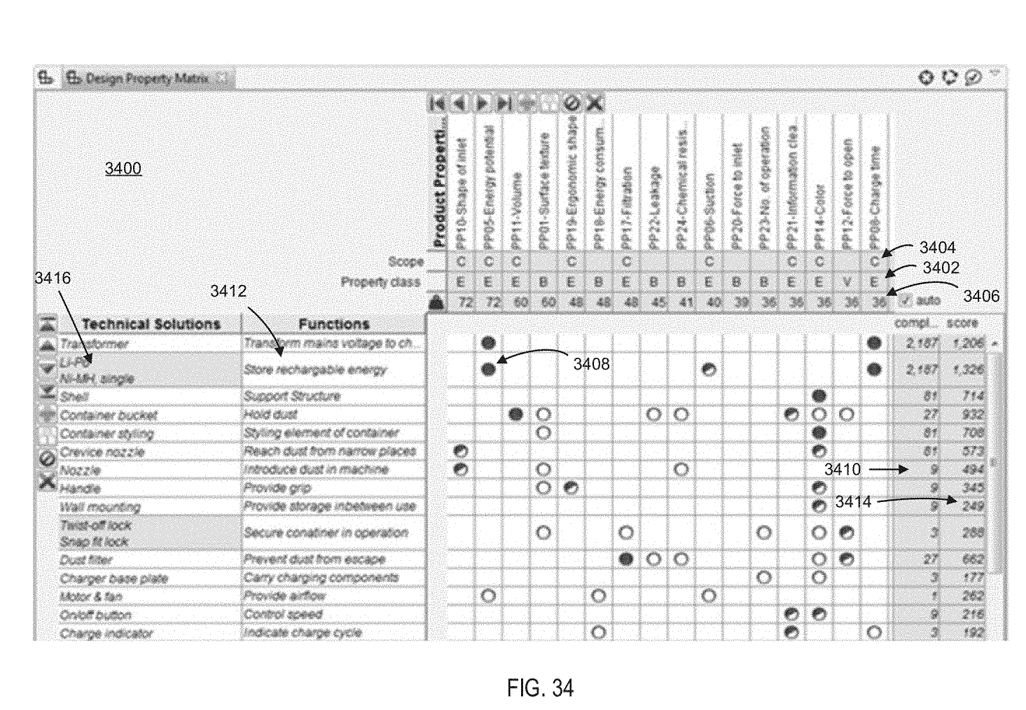

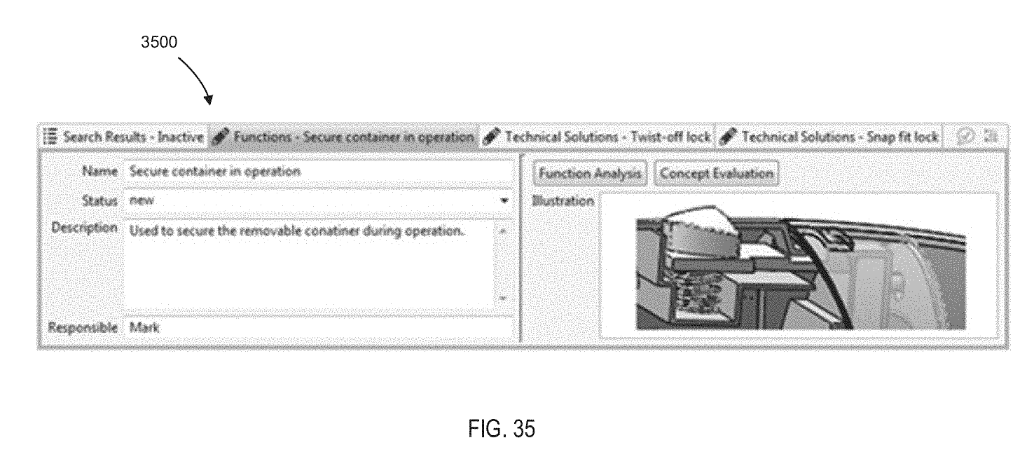

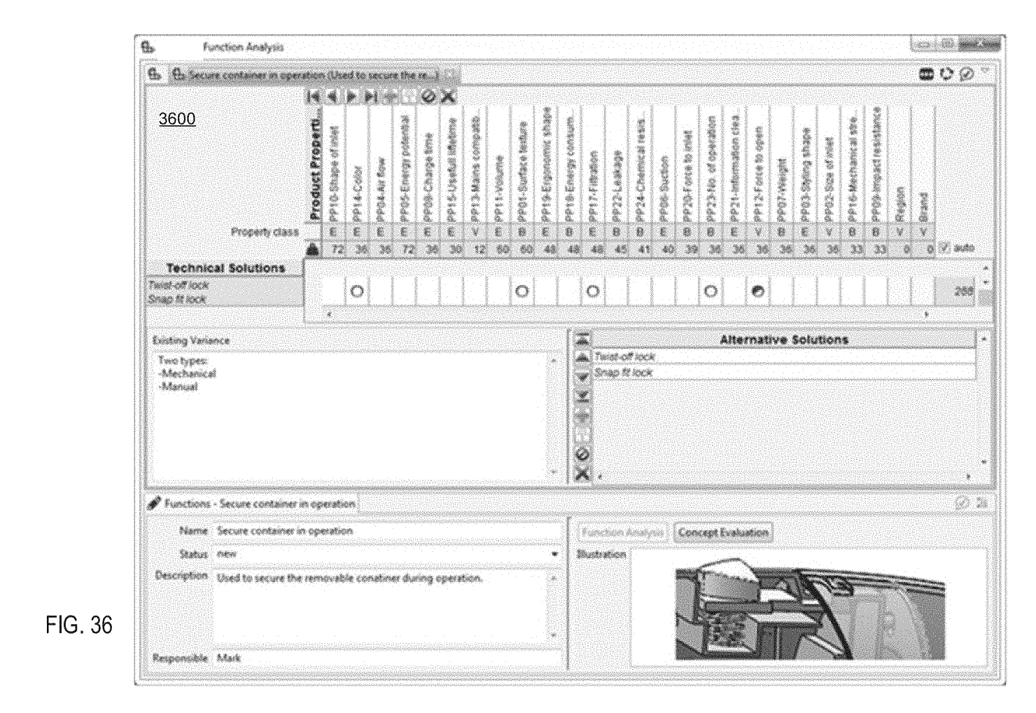

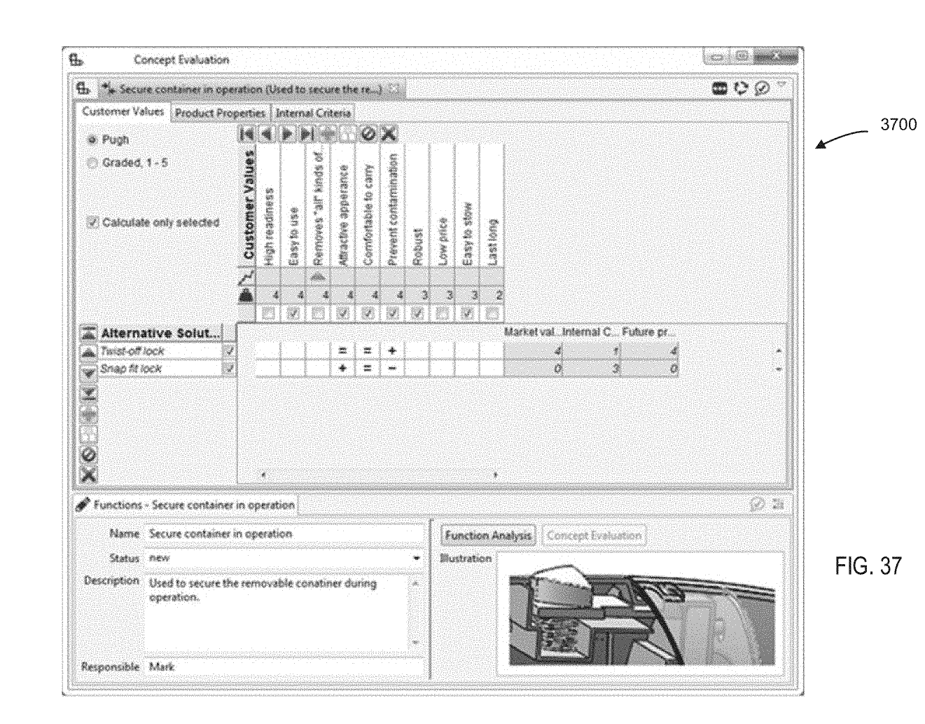

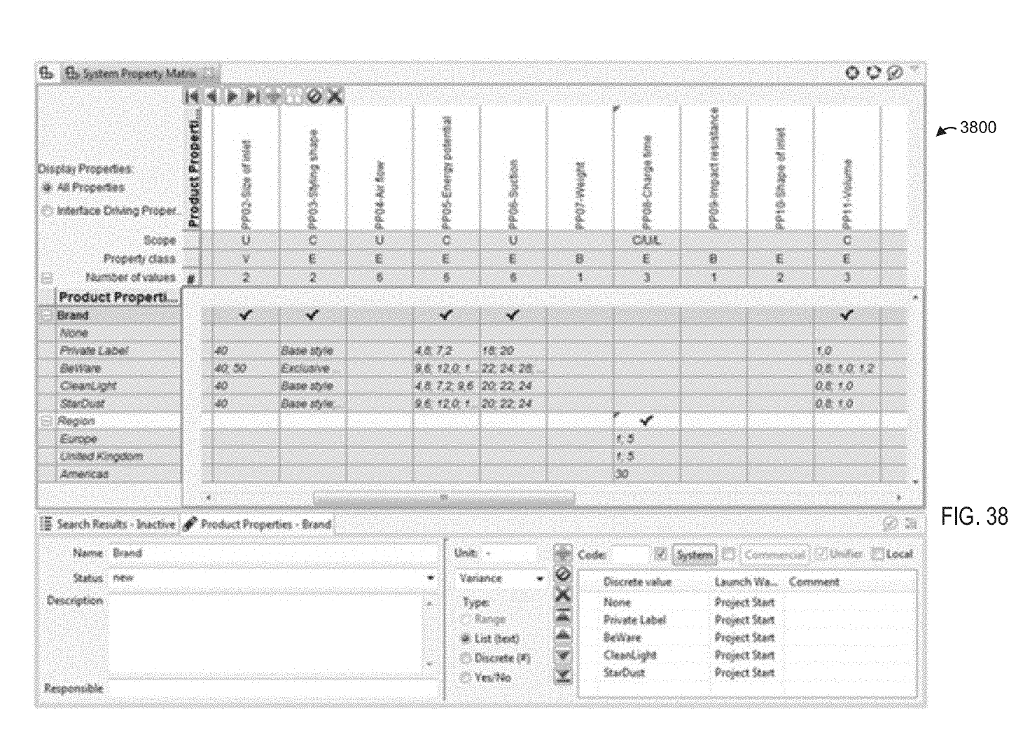

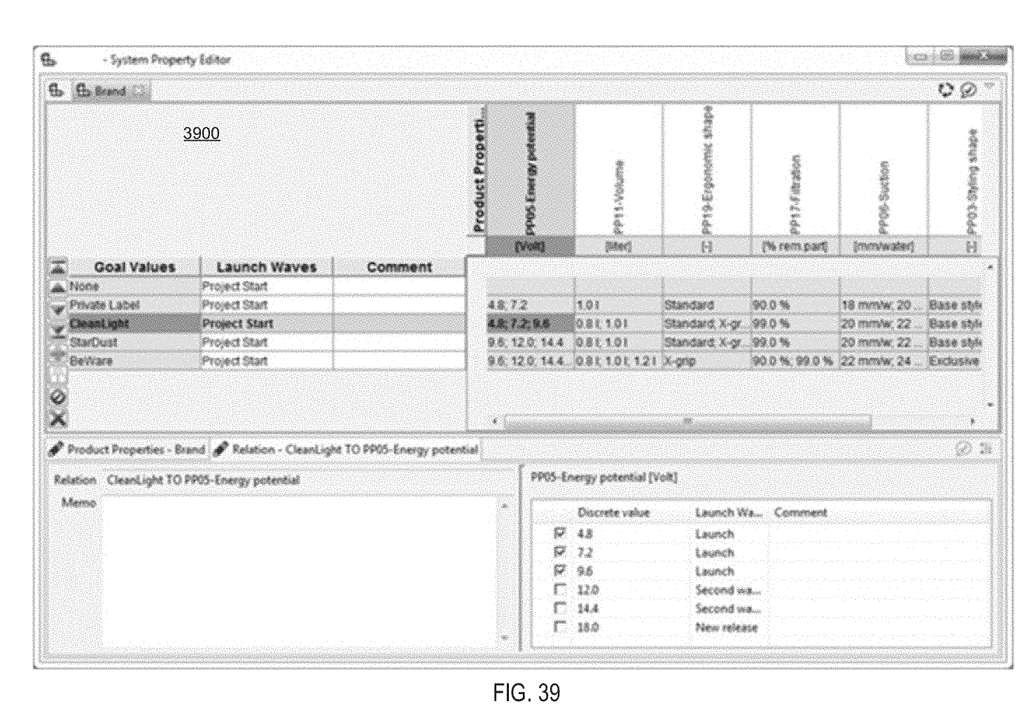

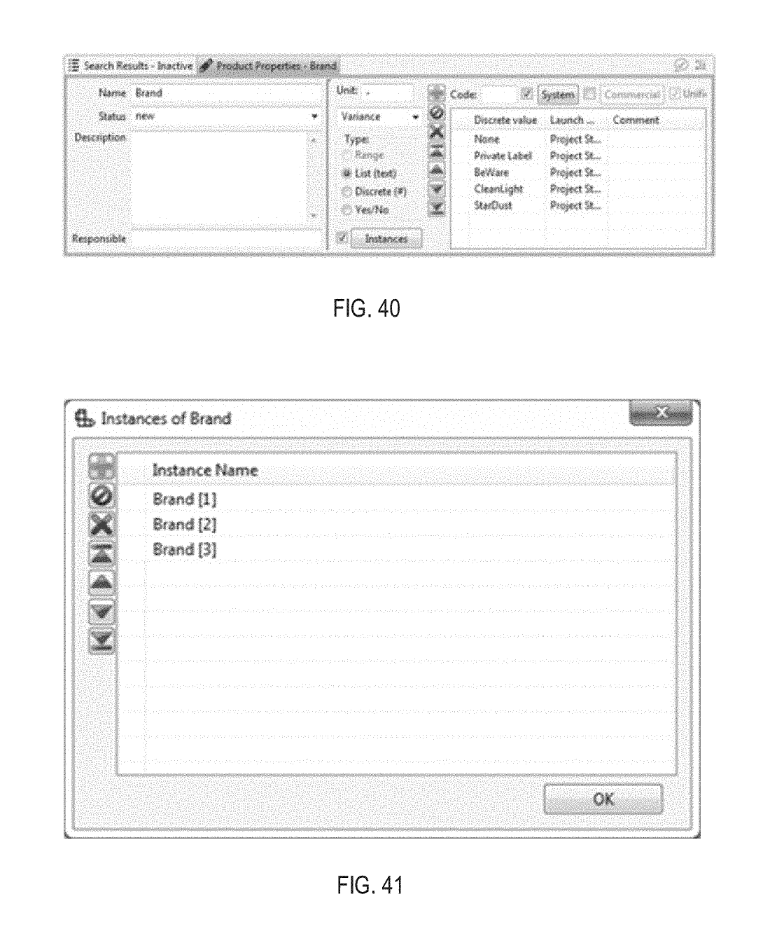

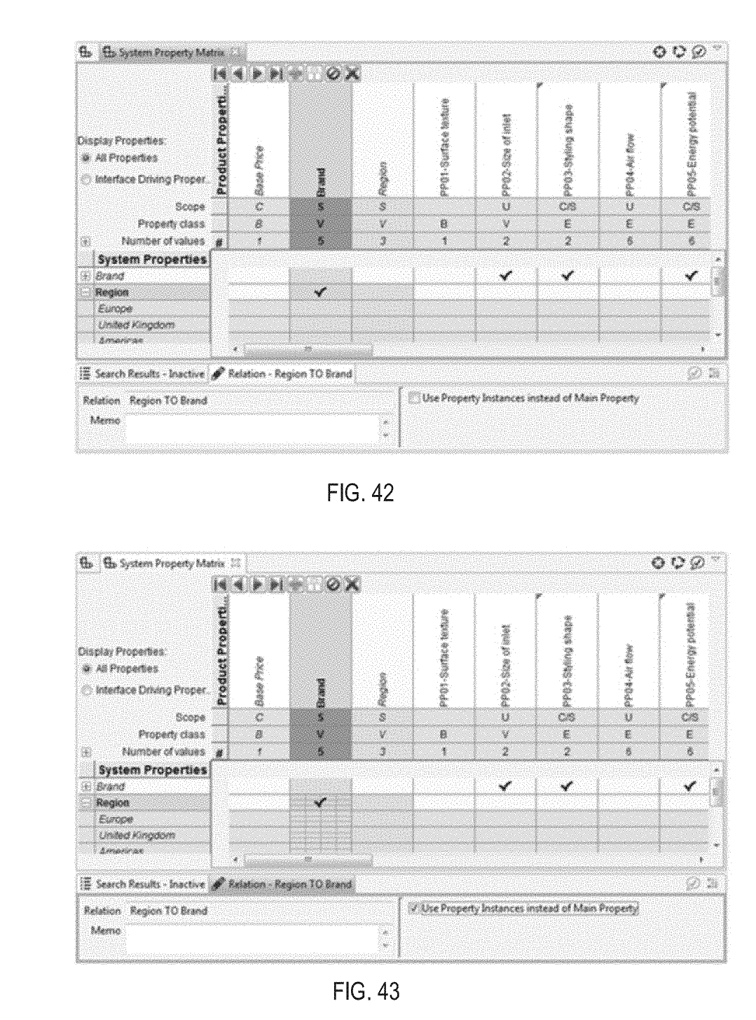

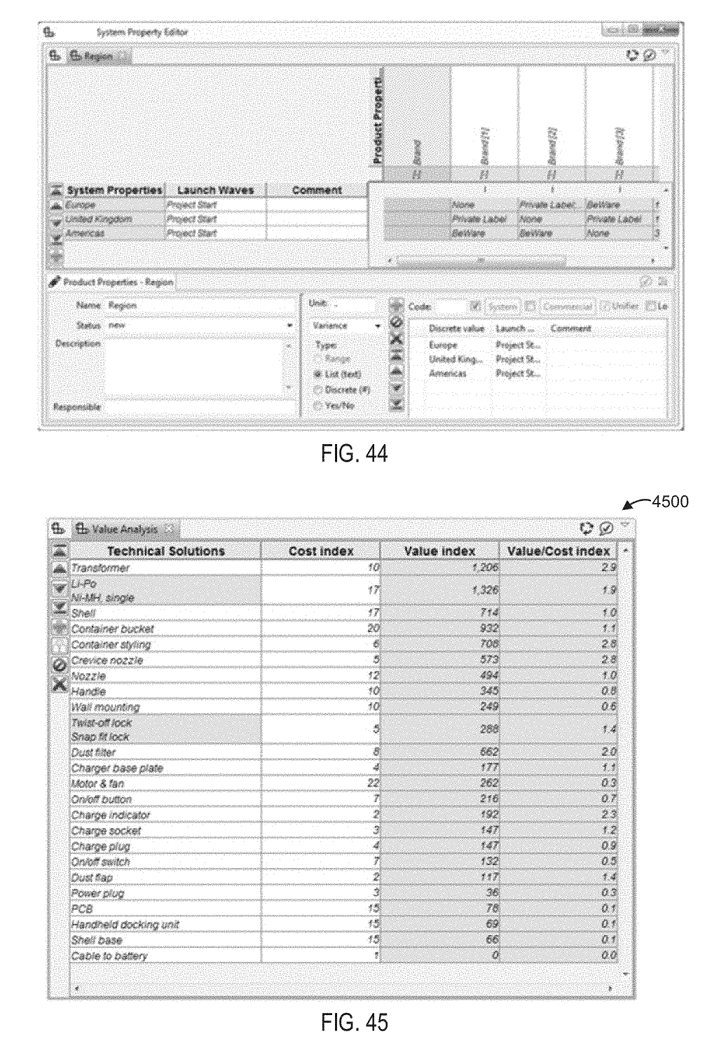

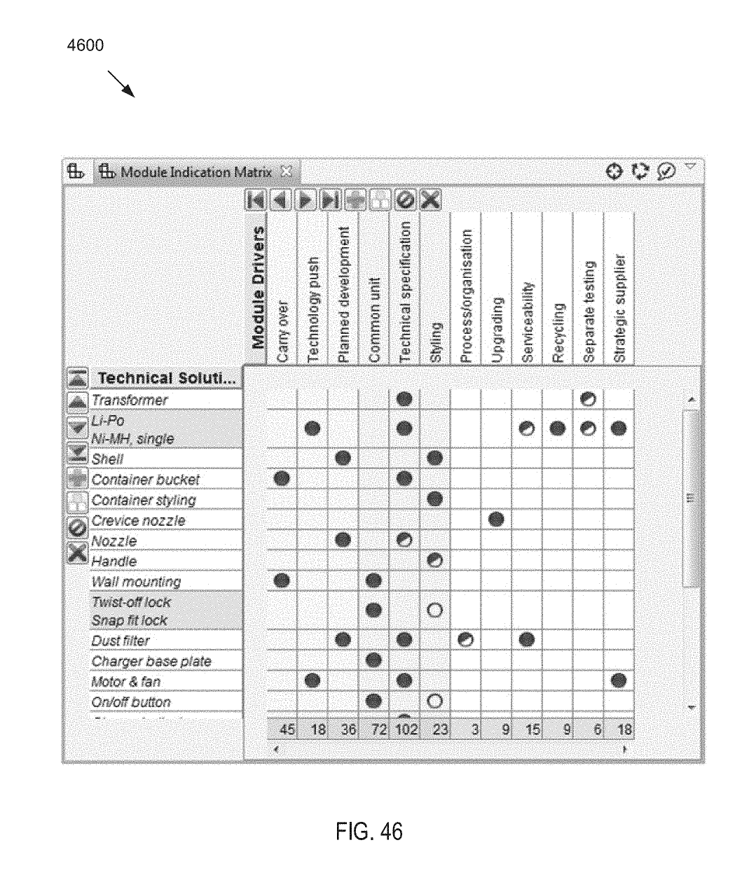

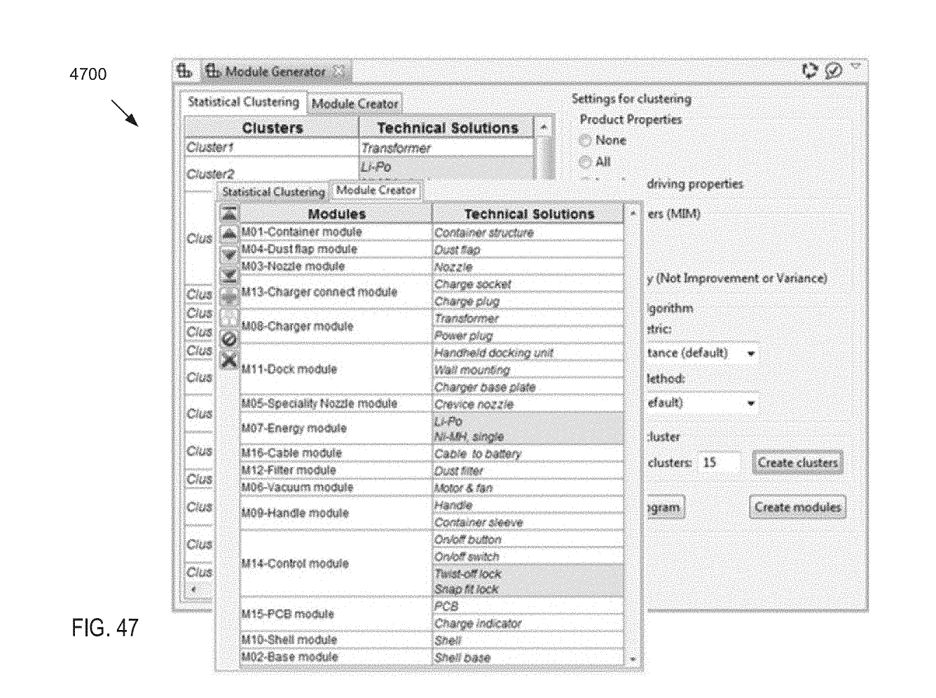

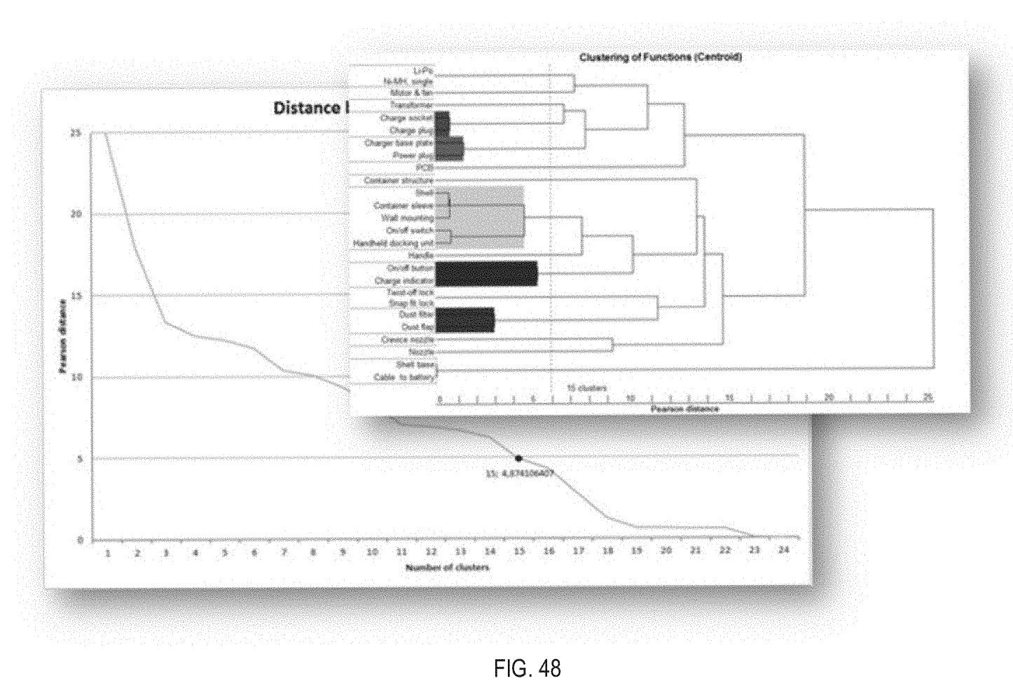

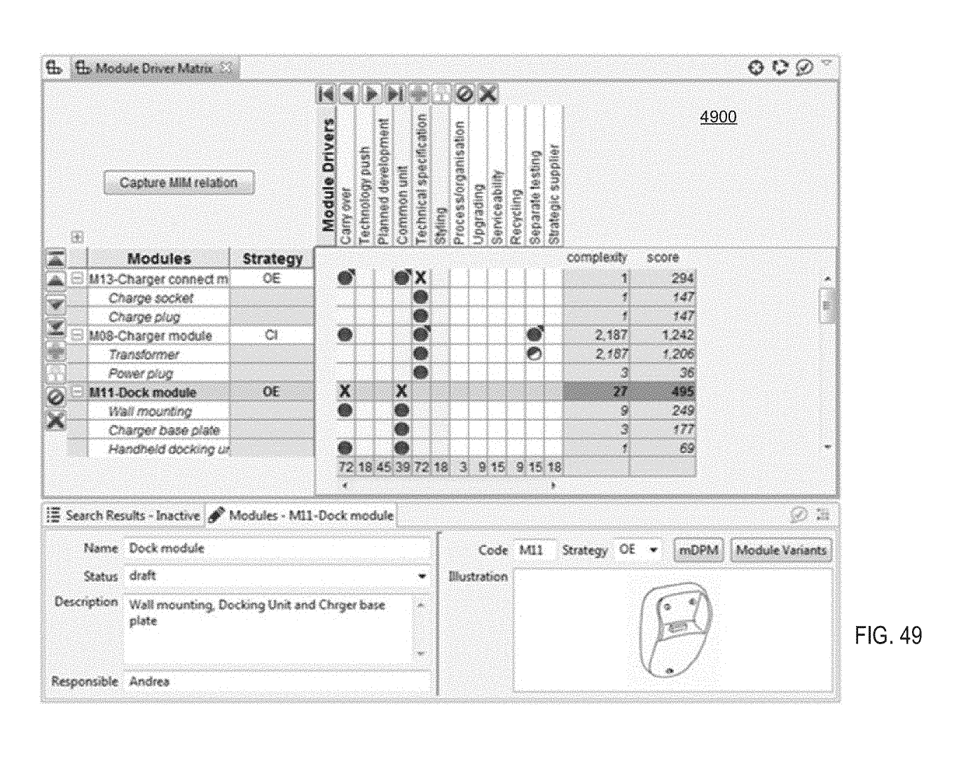

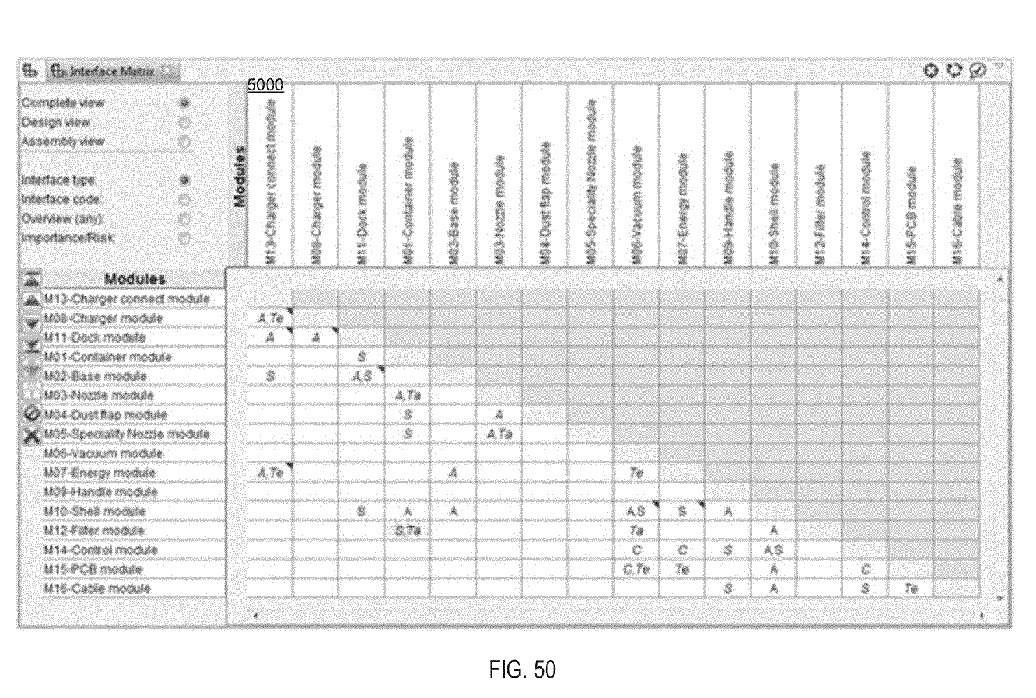

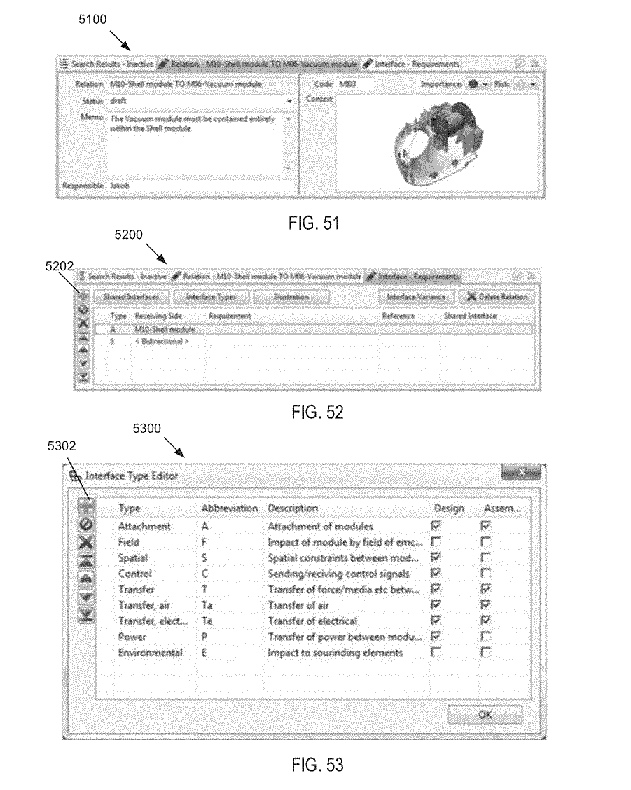

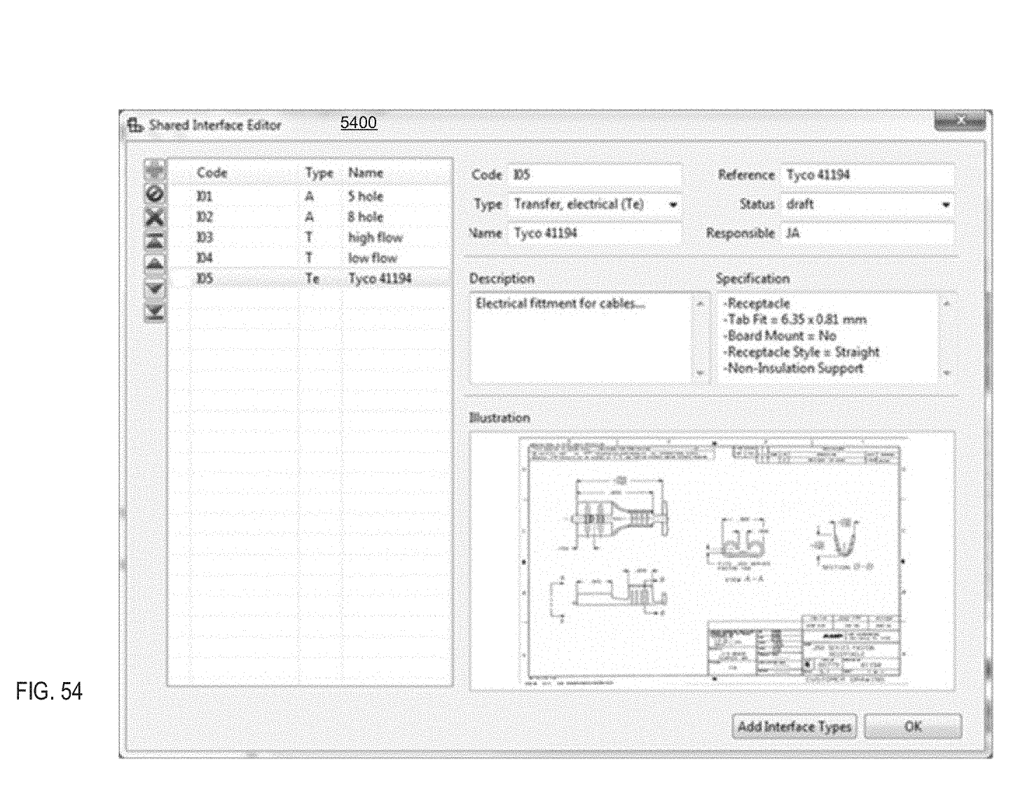

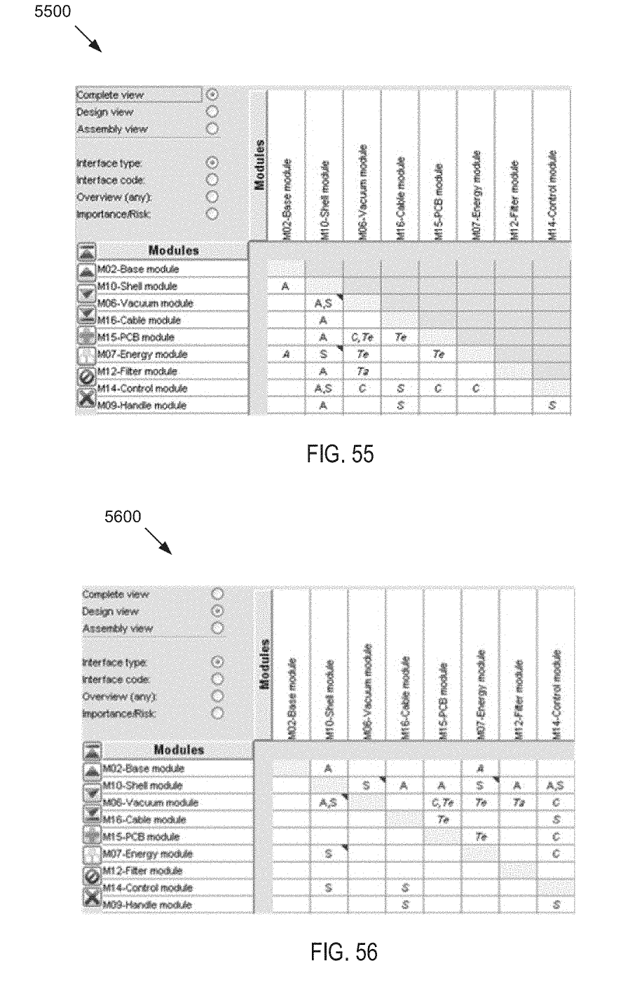

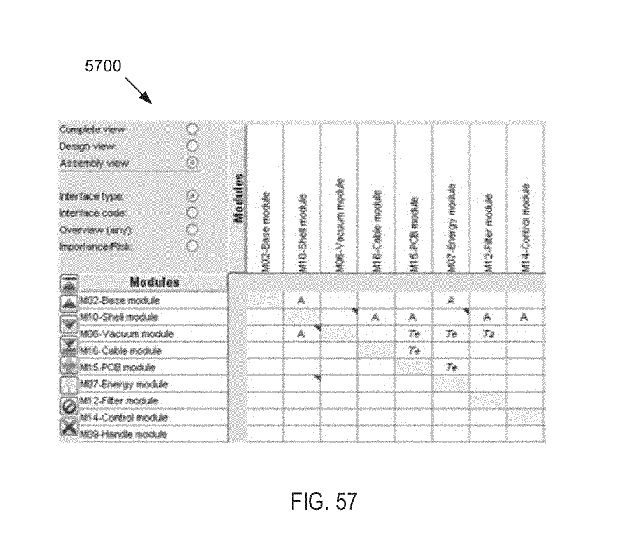

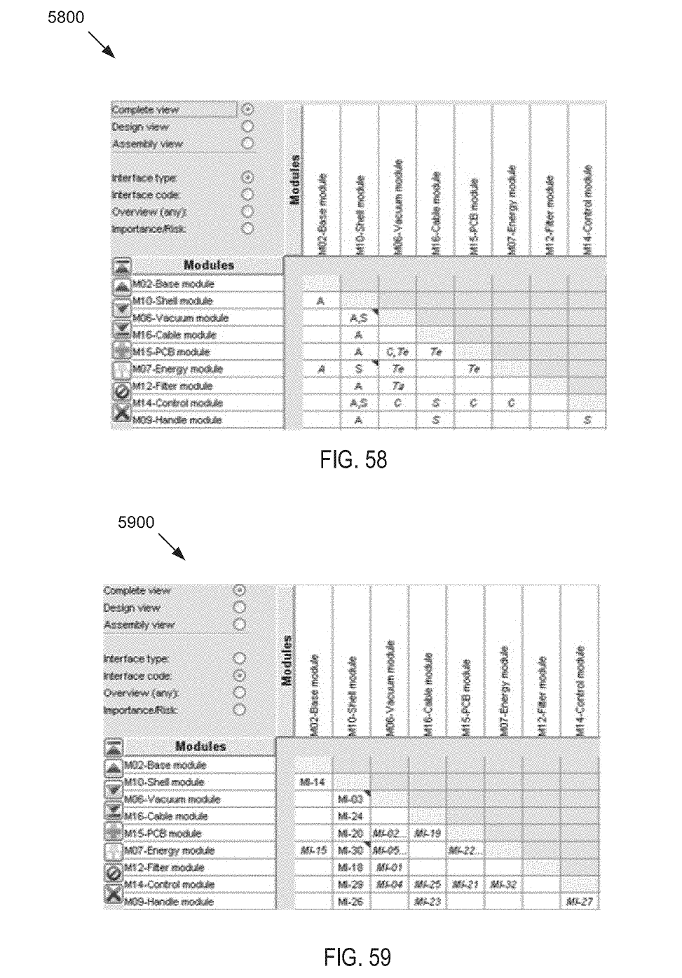

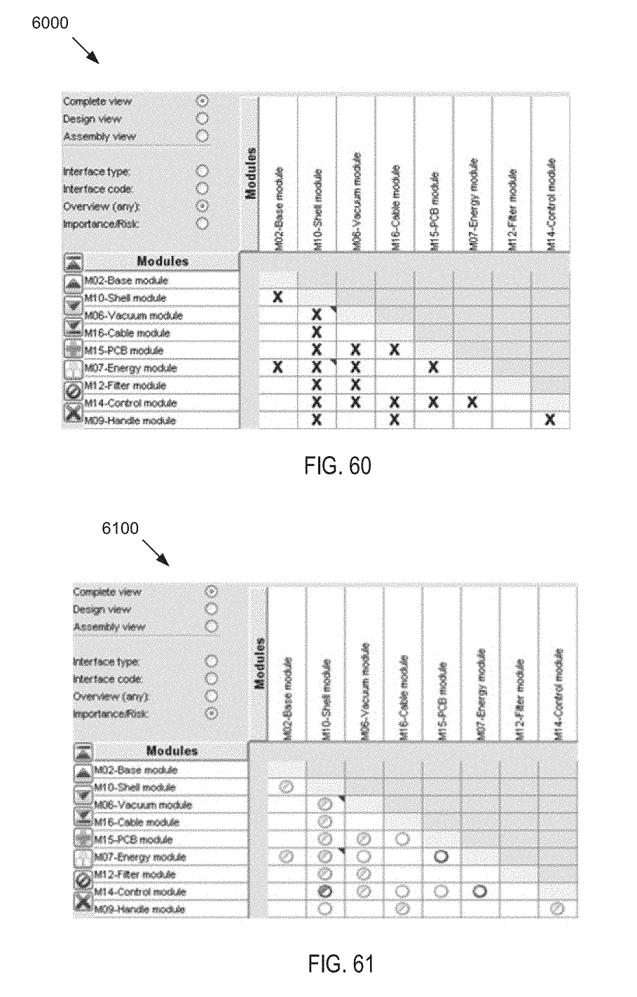

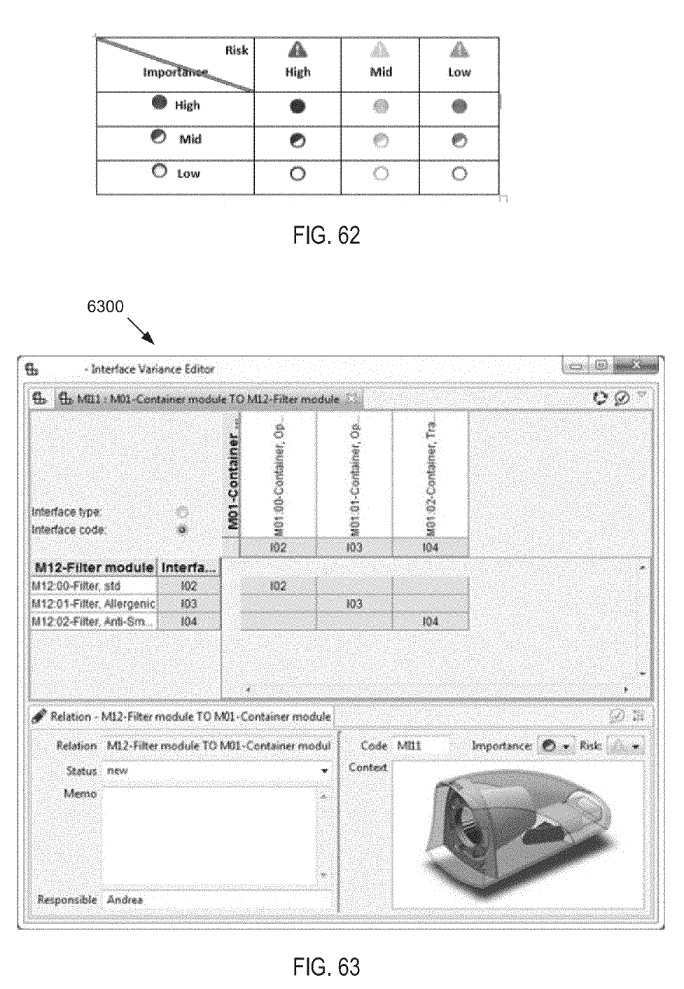

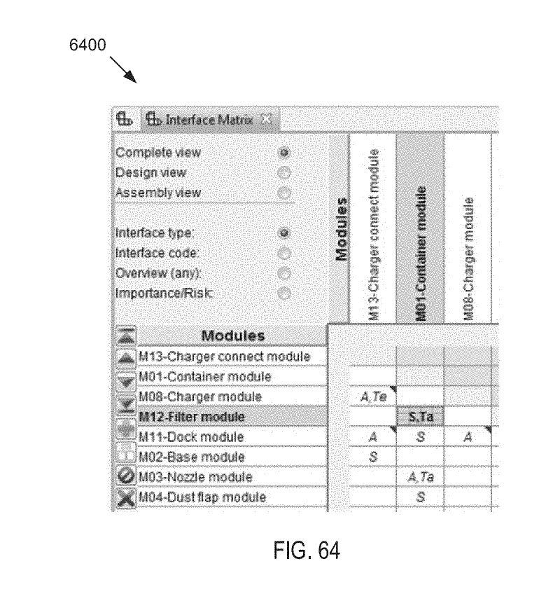

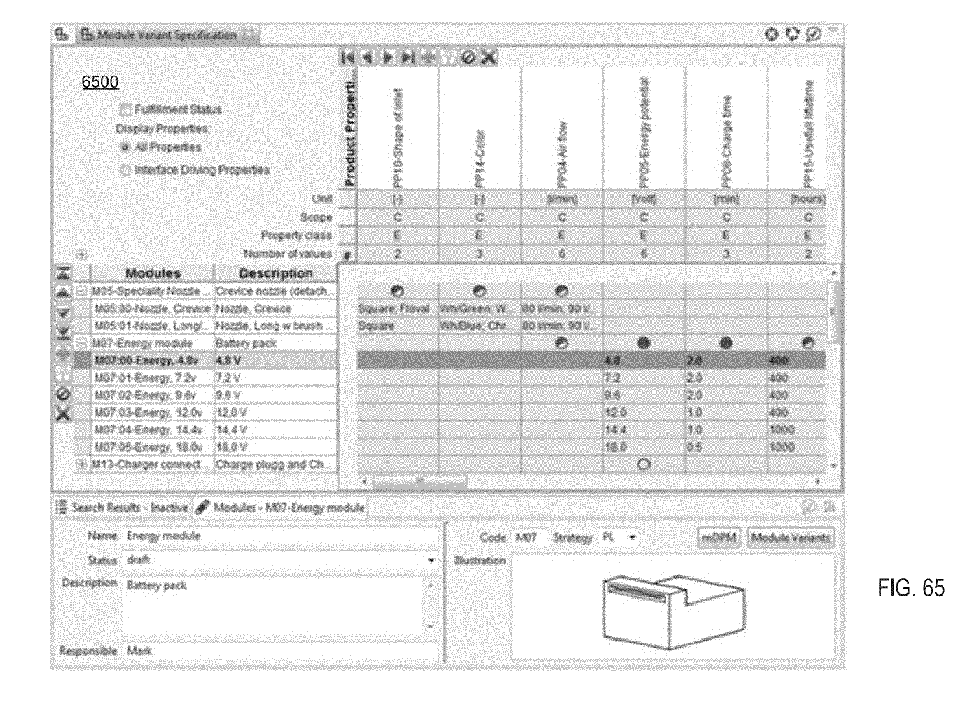

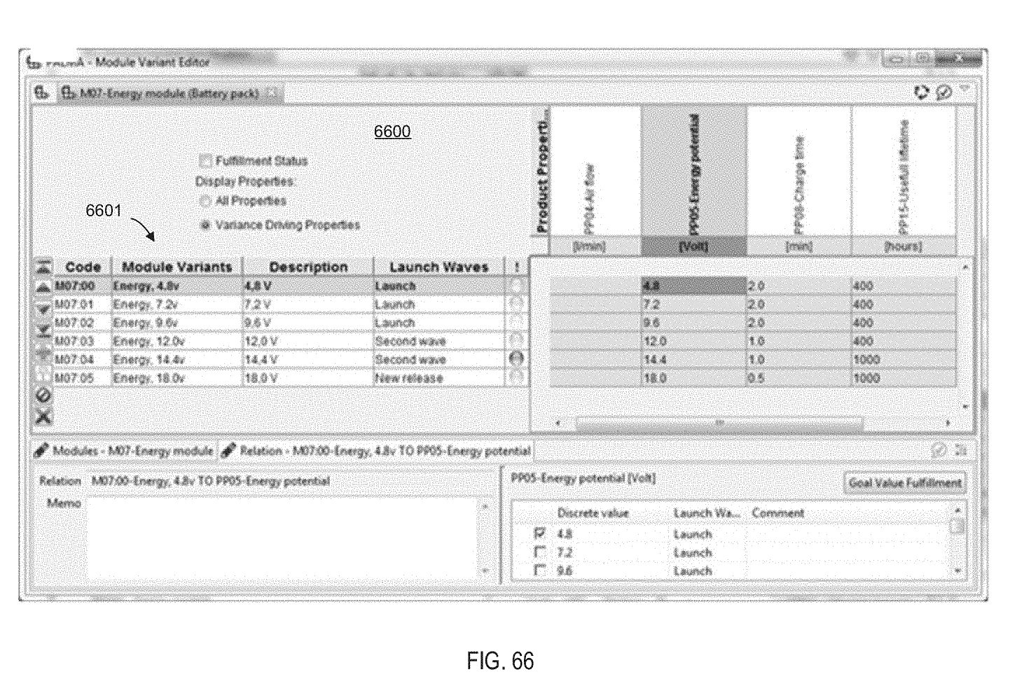

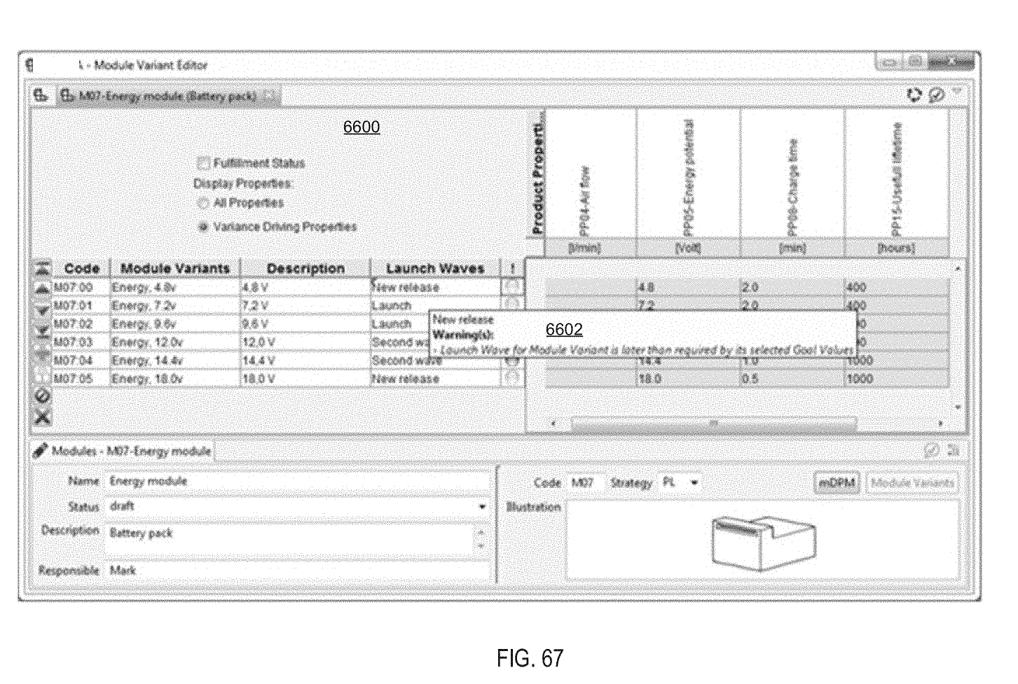

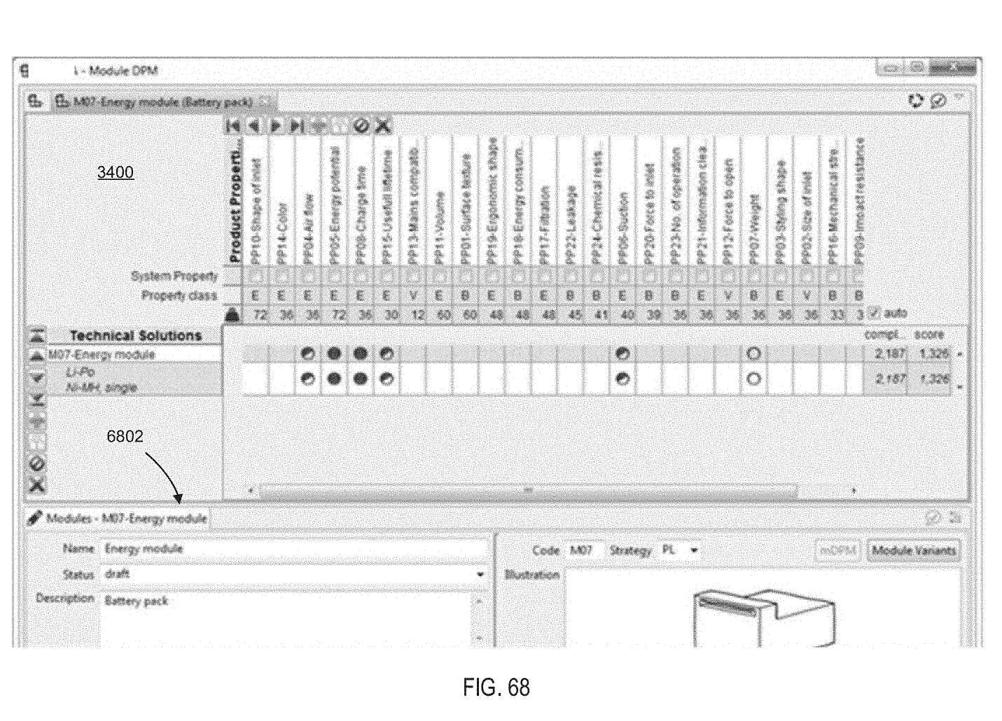

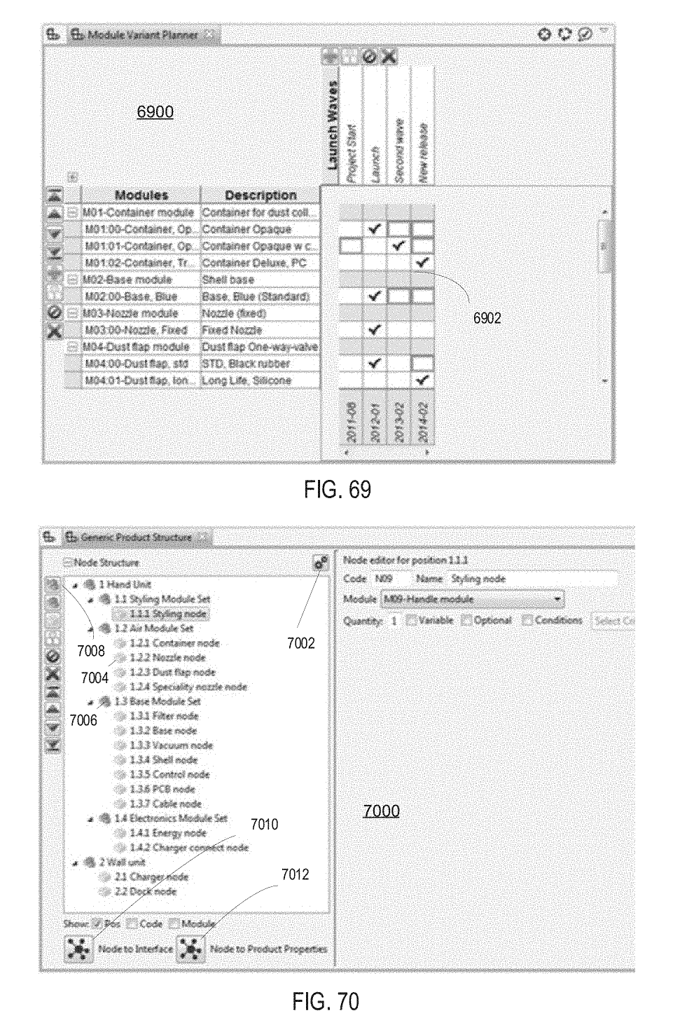

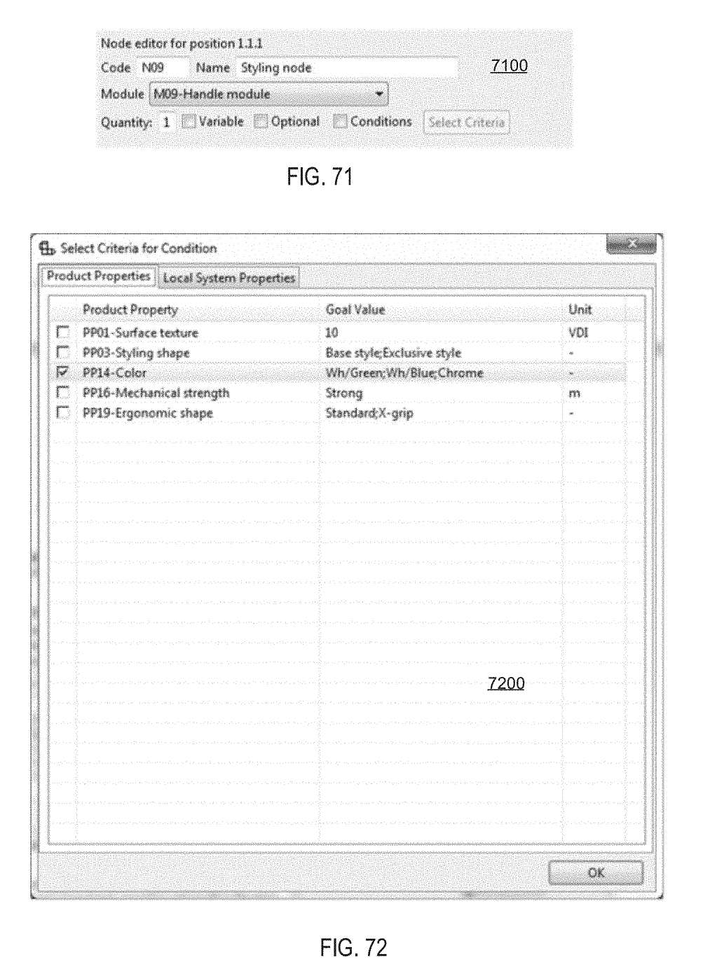

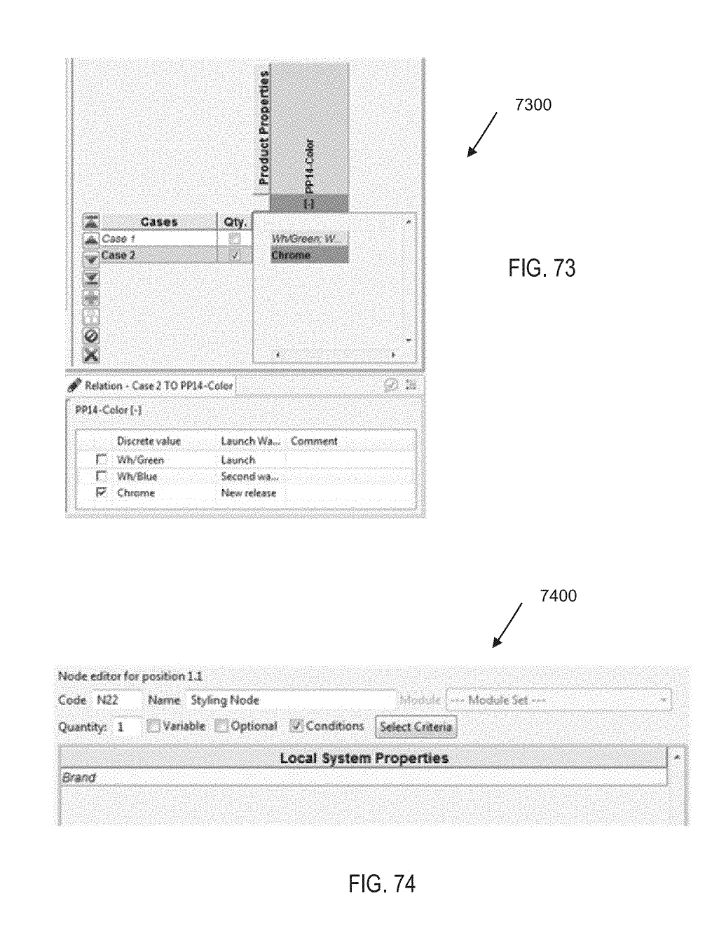

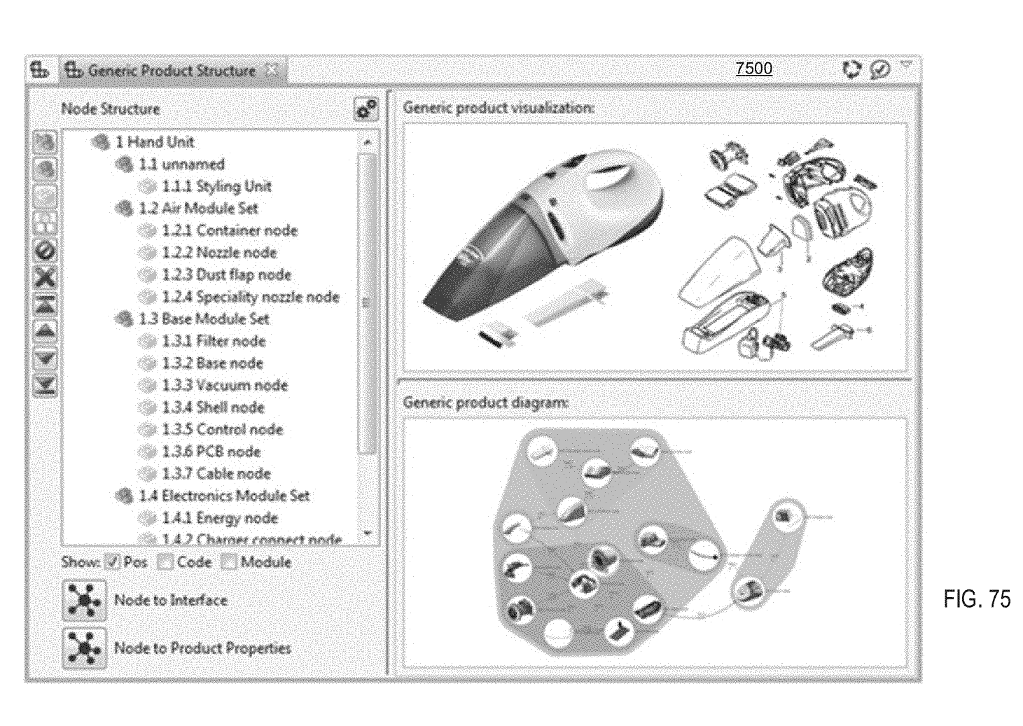

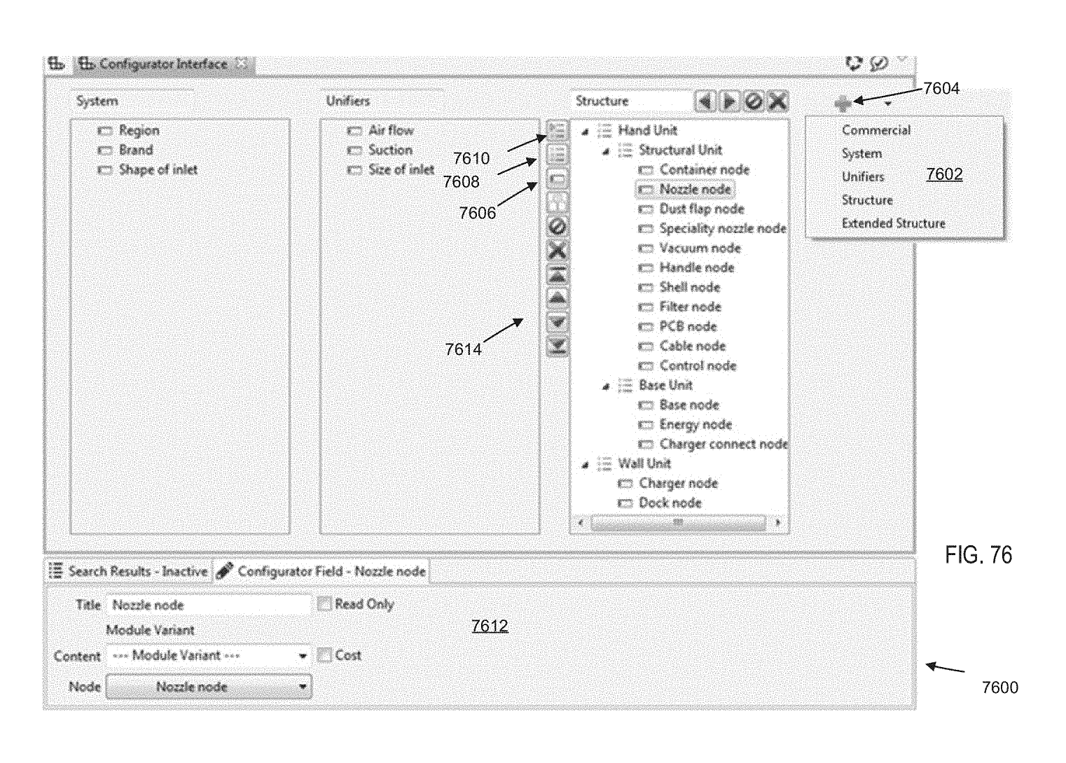

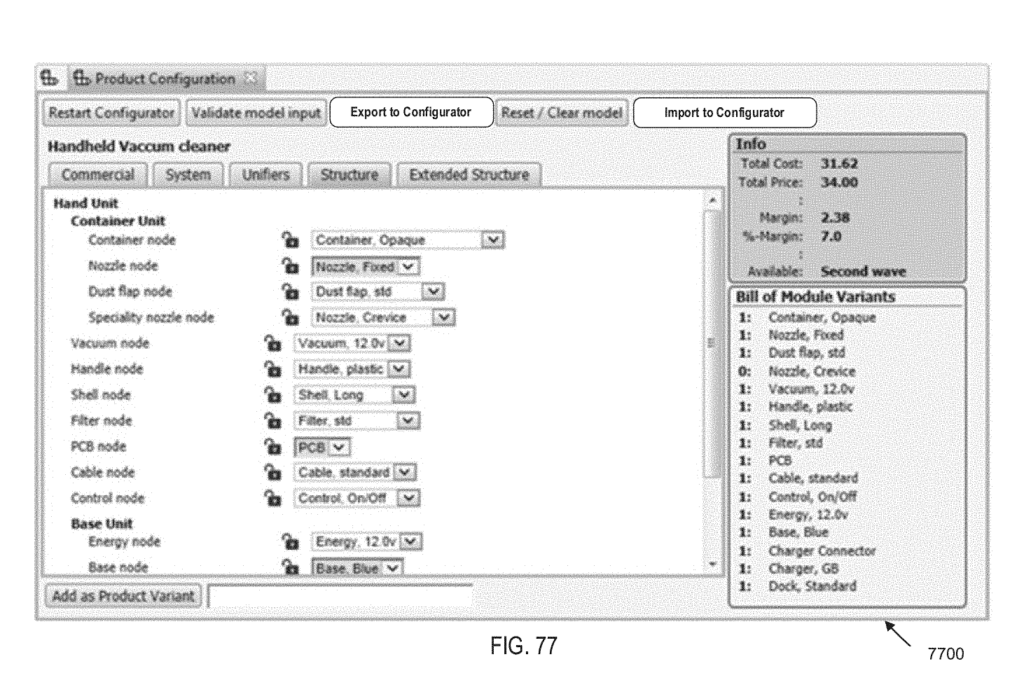

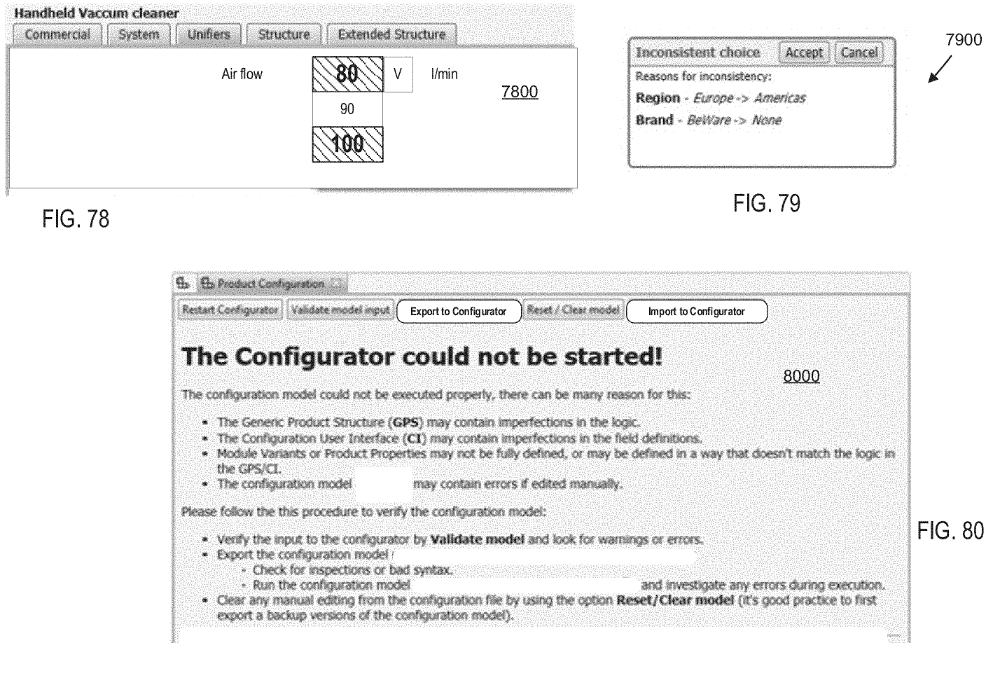

FIG. 4 illustrates an example computer operator graphical user interface 400 (GUI 400) provided by the PAS server 102 or client 104. The operator graphical user interface 400 is divided into three sections: a navigator area 402, tool area 404, and editor area 406.

FIG. 4 also shows a window title bar 408 that shows the name of the loaded module system and its version. If the module system is read-only this is also shown here (e.g., if the user does not have privileges to save). A menu bar 410 and a tool bar 412 is also shown, which can provide example access to general functions and menus. The availability of these bars may be dependent on the role and authorization of the user operating the GUI 400.

The navigator area 402 can list tools organized into groups. There may be two groupings of tools according to process or items they operate on. The process group tab 414 and the items group tab 416 can expand or collapse when selected to show the associated tools. The tools can launch in the tool area 404 when selected. There is also a task navigator that is expandable and collapsible by the tasks tab 418, which can show tasks that are either assigned to or originated by the logged in user.

A first tab in the tool area 404 may show the module system browser at start. Once a module system is open it may show the navigator area 402. Tools can be opened in new separate tabs as they are selected from one of many example navigators, such as the navigator in the navigator area 402. Tools are activated by selecting a corresponding tab. The tool area can include a tool context menu. Such a menu can provide actions related to the locations of tools on the GUI 400, like settings of the layout and sorting, etc. The actions vary depending on the active tool.

In some other example embodiments, tools are opened in separate browser frames or browser windows, such as instead of separate tabs.

The editor area 406 provides detailed information of a selected item (i.e., an object). The available information varies depending on the object that is selected. The editors provided by the editor area 406 can include an item editor, a relation editor, and search results. A part of the editor area 406 can include icons that apply to selected objects, such as icons that can set color and other formatting of the objects.

An information bar 420 can be located at the bottom of the window, such as shown. The left side shows information displayed when the GUI 400 represents login mode. The middle of the information bar 420 shows concurrent users, and to the right of the bar, shown is a status of the active tool.

The login mode is indicated at the left side of the information bar 420, and the login mode can be dependent on user type and role. The information bar 420 can also show that the user is logged into the PAS server 102 by icon 422. The information bar 420 also indicates whether the GUI 400 is in edit mode by icon 424. In such a mode, the user may have permission to save changes. The information bar 420 can also indicate the GUI 400 is in a read-only mode (such as by an icon not depicted in FIG. 4). The information bar 420 can also indicate the GUI 400 is in a mode where a new version may have not been saved and/or changes have not been saved.

In examples of the PAS, a revision is write protected. Also, in versions of the PAS, the GUI 400 can be in a locked mode when the module system is checked out by a user. Also, as shown, the active company can be indicated in the information bar 420.

The information bar 420 can also include a user icon 426 that shows if there are concurrent users. The first number indicates users that have one or more tools open in common with the active session, and having multiple tools open can cause potential conflicts. The number in parenthesis indicates users that do not share any open tools or have read-only access. By the operator selecting the user icon, a popup window with more details can be shown. From this window, it is possible to see who the other users are. The popup widow can also show detailed information about what tools they have open. Also, an email can be initiated from the popup window to users identified in the popup window.

The information bar 420 also shows the status level of an active tool, and its item sets are indicated at the right side in the information bar. The colors of status level icons 428, 430, and 432 indicate status levels. Example, status levels are relative to changes made to product modules through the GUI 400, they can include a confirmed status, a proposal status, or a draft or new status. The status level icon can reside next to a respective label of the module.

Status is applied in a hierarchy: tools followed by item sets followed by items. In some exemplary embodiments, status levels can be independent of each other. In some other embodiments, status levels can have dependencies on each other, such as according to the hierarchy in which that status levels belong.

A separate GUI can be provided to open a module system, expand a company definition, and select the name of the module system, and open different versions of the module system. In such a GUI, information next to a module system can show an indicator of the latest version, and who saved it last and when. If a specific version is requested, it can be opened by expanding the module system and selecting the desired version. Each version can be labeled with who saved it last.

In an exemplary embodiment of the PAS, whenever an object (such as a Company, module system or module system version) is selected in GUI 400 or a separate GUI, its description can show in a description area such as the information bar 420. Also, in an exemplary embodiment of the PAS, in order to open a second module system, when a first module system is already opened, the first module system must be closed.

Through the menu bar 410, many different types of graphical menus of the PAS can be activated. The icon labeled “PAS” in the menu bar can provide an icon for exiting a client application of the PAS. When selecting to exit the client application, the GUI 400 can also provide a save dialogue to facilitate saving of unsaved data. The icon labeled “module system” in the menu bar can provide an icon to close a module system, and if data has been changed selecting such an icon can initiate a reminder to save data. Such a reminder can be provided by a popup window.

The icon labeled “module system” in the menu bar 410 can also provide a menu with an icon to save changed data in the module system. Selection of such an icon can save changed data back to the server 102 in the same version of the module system that was opened. Another user can work with the same module system simultaneously and change and save the same information. Only the data that has been changed can be stored and the last information saved can be the information stored on the server. After the information is stored, any new information added to the module system since it was opened or last saved can be extracted to refresh the active session. A consequence of this is that the module system might look different from when it was saved because of a second user saving data between the opening and save of the first user.

The icon labeled “module system” in the menu bar 410 can also provide a menu with an icon to refresh a loaded module system (which includes retrieval of the latest data of the loaded module system). Changes made at the server can be merged into the current session. This is useful when several users work concurrently and they want to share their work with each other. Another scenario can be to use this function as a precaution to avoid overwriting data that someone else might have been working on, then a refresh may be made prior to a save. The operation of the GUI 400 or the client running the GUI can find data that has been stored on the server after that the module system was opened or saved. This data is then brought into the session so it is updated to the server.

The icon labeled “module system” in the menu bar 410 can also provide a menu with an icon to create a new version of a module system. Selection of such an icon can bring up a version description field so the reason for the new version can be documented. When confirming the new version by selecting an approval indicator, the module system can be saved as it is in the user's client to a new version. Such an action can also trigger recording of the latest version in the revision.

At the creation of the module system, a name and description can be required in examples, and it is also possible to enter a description for the version of the module system. It is possible to change this data at a later time as well.

The icon labeled “module system” in the menu bar 410 can also provide a menu with an icon to remove a module system from the client and/or the server. In a separate GUI, by selecting the module system, the complete module system can be deleted with its versions and revisions. By selecting a specific version or revision of the module system that particular version or revision can be deleted.

The icon labeled “module system” in the menu bar 410 can also provide a menu with an icon to show module system properties. Selecting such an icon can provide a sub-menu or a separate GUI. Such a sub-menu or separate GUI can provide different tabs. A first tab can provide name and description of the module system, which can be modified. If the module system is locked (checked out by some user) it can be unlocked by a user with correct authorization from this menu. An unlock button can be used (depending on role and authorization) to unlock the module system to enable edits and saving. A module system is only locked when it is checked out by another user. A second tab can provide global parameters, such as default maximum grade score that can be set in such a tab. Naming conventions for module variants may also be altered in such a tab.

Codes for key item sets can also be set in a tab of the GUI for the module system properties. With respect to code format, some key items set have a code attribute. The number of displayed index numbers can be set and is valid for codes. An item set code can have a unique prefix that can be set. This prefix can be manually changed for individual items. A module variant code for such key item sets can be a combination of the module code and a module variant index, and different variables can be separated with a separator.

Also, headings (e.g., item set names) shown in the tools can be modified at the GUI. The history of a module system can also be followed in the GUI through the tab labeled “module system” of the menu bar 410. The full description can be viewed or edited by selecting a version number in a table, through the tab labeled “module system”.

The tools menu 412 can include shortcuts to functions provided through the menu bar 410. Also, the tools menu 412 can include an icon to recover deleted items. Through selection of the recovery icon 434, the GUI 400 or a separate GUI can show a list of items that have been deleted. Revival of items can also occur and can include recovery of relations that were deleted because of the item deletion. In an exemplary embodiment, when saving or closing a module system, the revival list can be cleared.

Also, the tools menu 412 can include an icon to search items, such as the search icon 436. Selecting such an icon can activate a search tool for the PAS. Such a search tool can include a choice of whether to locate warnings or to do a text search. In case of a text search, a search query can be entered, and the data set to be searched can also be selected. Also, scope of a search can be defined. For example, the scope can relate to a complete module system or just the active tool displayed in the GUI 400. In an exemplary embodiment, the search request and/or result can be provided by the editor area 406 (see FIG. 5 which is a zoomed-in illustration of search results 500 that can appear in the editor area). In some examples, a user can choose whether to view a result in a table listing or a tree view by clicking on the control icon in the upper right of the search results area. A matching name can be highlighted such as by a certain color. A containing object is showed black. A related object (higher in hierarchy) is colored in grey. A user can then select an item to access further information on the item. In an exemplary embodiment, if a scope was set to an active tool, PAS may highlight the object in the active tool, automatically. If scope was set to a complete module system, PAS may ask what tool to open the selected object in. Preselected objects, such as preselected tools, may be indicated.

The search tool for PAS may also include a sort items GUI 600, which is illustrated in FIG. 6. An advance sort items GUI 700 of PAS is illustrated in FIG. 7. The sort items GUI 600 is a symbolic view of the active tool. By selecting on a field, the GUI can sort the tool in ascending order, as indicated in the field. Selecting the field a second time can sort items in a descending order. Metadata of items can be used to sort as well. In an exemplary embodiment, the sort items GUI 600 can be left open and can adapt to the active PAS tool displayed in the GUI 400. With the advance sort items GUI 700, advance sort is available for tools with the symbolic scoring. The advance sort items GUI 700 can sort one or multiple item sets according to a clustering order. The clustering input can be modified by several parameters. A diagonalizer associated with and displayed in the advance sort items GUI 700 can sort the cluster based on their center of mass. This can generate a diagonal through a matrix. The clarity of the diagonal depends greatly on the data. The clustering for each item set can be analyzed separately.

The menu bar 410 and/or a tool bar 412 can include a text zoom function. There are a set of predefined zoom levels that can be selected. This can in fact change the font size in the tool area. This is useful to improve clarity when on a low or high resolution screen, such as one provided by a projector. The menu bar 410 and/or a tool bar 412 can also include change username or password functionality. The bars can also include an auto save feature. There can be a save reminder that suggests to save in order to prevent loss of data in the event of a failure. The reminder can show the time since the last save operation was done. Also, the GUI 400 can provide for enabling and disabling of the reminder and setting a time period for the reminder.

The menu bar 410 and/or a tool bar 412 can also include a function or a separate GUI for adding users and groups to an item or module. A user can belong to the active company at the time of creation (for instance, see the information bar 420 for active company). Entering of user information can be provided by the function or separate GUI. Users can be inactivated (Toggle on/off) if they are no longer active in the project. Individual users can also be emailed from such a feature or GUI. The username can be generated by combining first name and surname, but it can be changed. A username must be unique in some examples. In an exemplary embodiment, PAS can flag if there is a duplicate username. The email address can be used when sending email to the user, either from another PAS user or for administrative notifications.

There are several different user types that give different privileges; the system can include at least three categories of user types: administration, manager, and user. See table below.

| type | Administrative | module system | Role |
|---|---|---|---|
| ADMIN | Add/Delete users. | None. | none |
| MANAGER | Add/Delete users. | Add/Delete | manager |
| | | module systems. | |
| USER | None. | Access by | team member |
| | | Authorization. | |

Within a module system, the authorization of the users is controlled by a role, this can be managed for users and module systems in an authorizations tab of the user administration dialog. The user type can limit the role a user can have, even if the user has been authorized a superior role in a project the user can only act according to what is authorized by the user type in some embodiments.

Below is a table having an example of different roles and their authorizations:

| Role | Action | status |
|---|---|---|
| manager | Make revision, set authorization | set status levels |
| team member | Edit, Save, Save version | set status to: new, |
| | | draft or proposal |
| reference | Read-only, reports | None |
| — | No access | — |

The menu bar 410 and/or a tool bar 412 can also include a tool to create and change the properties of the company. For example, an information tab can show company name and description, and allows changes. A module system tab can list the module systems associated with the company. And, users tab can list users and their roles associated with the company and module systems within the company.

The menu bar 410 and/or a tool bar 412 can also include a tool to create revisions of module systems. To create a revision of a module system, an icon can be selected from one of the bars of GUI 400. This can provide a revision description dialogue to document the reasons for a revision. When confirming the action, the module system can be saved as it is in the user's client to a new revision. For instance, a revision can have version number X.0. In an exemplary embodiment, to save data storage, when a revision is created previous versions are purged. Although, in such an embodiment, previous revisions can be kept. A revision can also be write protected. In some embodiment, to store new changes a saved version can be required to make an unprotected copy.

The menu bar 410 and/or a tool bar 412 can also include a tool to create reports. A report setup tool can provide configuration of the format and content of reports. For instance, PDF based reports, including a module report, a product module interface report, a shared interface report and a module system report can be configured by such a tool. The report setup can be defined per module system and/or by company. The tool can include a base format define by a report template form. See FIG. 8, for example, which illustrates an example report template form 800. As shown in FIG. 8, a logotype can be added to brand the reports to the company. The size of the printed logo is controlled by the height; aspect ratio is fixed, so the width may update accordingly. The styles used can be altered in the styles section by modifying size, style and font. The content of the header and footer can be defined by selecting several predefined attributes for different locations. A page layout part controls page size, which pages to have logotype, and whether to mirror the layout or not.

In the content selection of the GUI, there is a custom field that allows for a more detailed content, and to combine regular text with predefined elements. The content can be controlled by different tabs. The available sections are displayed in the tree browser, as shown in FIG. 9. The checked sections are to be included in the report. Each section can be expanded to either display subsection, if available, or to include page break. Sections can be reorganized by first selecting it and then using the action arrows to the left. Subsections can only be repositioned within its section in some embodiments. Page breaks cannot be reorganized, in some embodiments.

FIG. 10 illustrates an example graphical navigator GUI 1000 that can be rendered via the GUI 400. The GUI 1000 can be used to document relations between items. In an exemplary embodiment, the GUI 1000 can have one or two sets of items. An item set is a set of items that share the same base definition and serve the same function. Items and items sets are shared between tools. This means that attributes that are changed for an item in one tool may be updated in other tools as well. Sorting orders of items are therefore the same across the tools.

There is no mandatory order of how tools can be used. Tools can be opened and worked with in any order. However, certain tools provide an output to the next downstream tool, e.g., automatic weights and ranks, and these outputs can be set manually to continue or break daisy chaining or waterfalling.

The data of an item can be accessed in a tool, and details regarding the tool or associated items can be accessed in the editors. The same applies to relations. The content of the editor can be dependent of the item type.

Once a module system is opened, the first tab in the tool area 404 may show the graphical navigator GUI 1000. This can show tools (e.g., the square and triangular bricks 1002 and 1004), how the tools are related to each other and what items sets (e.g., the narrower rectangular bricks 1006 and 1008) are related to the tools. The bricks can include visual indicators related to the status of the tool or item set. For example, the color of the bricks can correspond to the status of the tool or item set. Also, a brick can be selected to show a comment regarding the tool, such as a tool tip with the full name and status. A brick can also be selected to open the tool in the GUI 400 or the item set editor in the editor area 406.

A tool dropdown menu 1010 can be displayed in the tool area 404. It includes functions related to the active tool, and the functions can be dependent on the tools. The functions may include a sort items function 1012, or a settings function 1014. Also, some tools may have additional functions such as an import manager 1016. Selecting the settings function can cause the display of the tool settings GUI 1100. As shown in the tool setting GUI 1100 in FIG. 11, a tool can have its own settings for size (e.g., number of characters), item header orientation (e.g., horizontal and vertical), the column width, the score column width, and number format. These setting can be stored with the tool at a server or a client device. An auto format can also be used with the GUI 1100 to adjust the prefix and decimals to best fit the column width available.

The tool area 404 and other areas of the GUI 400 can include action buttons as shown in FIG. 12. Items can be added using add item button 1210, deleted using the delete item button 1208, and reordered by using Action buttons 1202 and 1204 in the tools. Each of buttons 1202 move and group selected items to a far end in one of four directions (up, down, left, and right). Each of buttons 1204 moves selected items one step in four directions (up, down, left, and right). Items can also be deactivated, by toggling the state using button 1206. This can exclude the item from any calculation as if the item was deleted. An item can also be duplicated by the duplicate items button 1212. New items may be added below or after any select item, if nothing is select they can be added first. If several items are selected when adding an item, the same number of items can be added or removed.

In the GUI 400, items can be reorganized by drag and drop as well. Select one or more items, then click and hold on one of the items. Then drag the mouse, the mouse pointer can change to indicate drag and drop mode, point on the new destination and release the button. If the selected items were in front of (e.g., to the left or above) the items they were dropped on, the items can be placed after (e.g., to the right or below). And, vice versa, if the selected objects were located after the items they were dropped on. If items were located on both sides of the items they were dropped on they can be place below in reversed order. For multilevel tools (e.g., MVS tool), sub-items can only be dropped within its items (e.g., a module variant cannot be moved to another module).

The tool area 404 and other areas of the GUI 400 can also include relation scores as shown in FIG. 13. The representation of scores in FIG. 13 are via graphical shapes, but these scores may also be represented by other types of graphics such as numerical scores. In some examples, item relations in the tools are either set by numbers, a graded score (e.g., default is 1-5 where higher is better), or by score symbols. FIG. 13 illustrates icon 1302 that represents a strong relationship between items. Icon 1304 represents a medium relationship between items. Icon 1306 represents a weak relationship between items. Icon 1308 represents that more work is needed to determine a strength of a relationship between items. Icon 1310 represents a negative relationship between items. Icon 1312 represents that a statement can be retrieved regarding the relationship between two items. Icon 1314 represents that an uncertain relationship between two items may exist.

The tool area 404 and other areas of the GUI 400 can include expand and collapse functionality as illustrated by FIG. 14. For multilevel tools, it is possible to expand or collapse items at once. Use the button just above the items. The function can toggle after each use. The default of a list of items is to be expanded in some examples of the GUI 400. To collapse from the beginning of a session, a certain interaction may be made with the GUI 400, such as a button for an item is selected twice.

The tool area 404 and other areas of the GUI 400 can include extended text boxes as shown in FIG. 15. Some description fields can provide an extend text field to help edit longer texts. In some embodiments, a certain interaction (such as a double click) in the description field can cause the field to be provided as a popup window. In such as example, another interaction can cause the popup window to close such as clicking outside the field or by a keyboard entry like Ctrl+Enter.

In some tools presented by the GUI 400, cells can be invalid to be used depending on data in other tools, such as shown in FIG. 16. Such cells can be identified by a certain indication, such as a grey frame. These cells can still accept inputs; in such a case the frame can provide a second indication, such as turn red, to alarm a user of a possible error. In addition, a third indication, such as a green corner, can be provided to indicate that there is a warning explaining why the cell includes a warning. Upon selection of the third indication, a popup message may occur to explain the warning as shown in FIG. 16.

### General Tools

As shown in FIG. 17, an item set editor GUI 1700 can be included with the GUI 400 or as a separate GUI. In examples, the item set editor 1700 can either be opened manually from an item view in the GUI 400 or by selecting an item set in the graphical navigator GUI 1000 (such as one of the sets represented by bricks 1006 and 1008). Also, it can be provided by selecting the editor from a search result including a selectable corresponding icon. Different possible attributes of an item set are shown in FIG. 17. The occurrence of an attribute depends on what is applicable for the chosen item set. Attributes such as name, description, status, responsible, data quality (DQ) task, change request (CR) task are shown for item sets, in most embodiments. Items are sorted by selecting a column header, and every selection can change sort order from ascending to descending, and vice versa. Sorting functionality can be indicated with an arrow next to the column title. The sort order in the item set editor can be reset by selecting a function, such as the function button labeled “Sort as in tool”, depicted in FIG. 17. In exemplary embodiments, sorting of items do not affect the sort order shown in the tools. The sorting can be reset by selecting a corresponding button in the GUI. Some specific items set can be sorted manually using the action buttons, and these are not part of most embodiments. Items, from the GUI 1700, can be added, duplicated, deleted, etc., and this can unset the sorting but preserve the current order in the item set editor.

As shown in FIG. 18, a focus GUI 1800 can be included with the GUI 400 or as a separate GUI. The focus GUI 1800 can be provided by first selecting an icon selectable to activate of the focus GUI (e.g., icon 1801 as illustrated in FIG. 4). The focus GUI 1800 can provide a view of a selection from a tool to compare items or do some analysis. The Focus GUI 1800 provides a view of a tool but only with selected items. For example, one or more items can be selected. Multiple items can only be selected from the same item set. Items from the other item set(s) in the tool can be included in the focus tool as well. Relations can be selected too. Items connected to these relations can be part of a selection. To render the focus GUI 1800, once items are selected, launch of the focus GUI can occur from a corresponding selectable icon, such as icon 1801 illustrated in FIG. 4).

In some examples, sort buttons are inactive when there is only a partial item set showed. In applicable sub-tools to the focus GUI 1800, there is a function to hide items that do not have a relation. This functionality can be activated by selecting a corresponding icon such as icon 1802. This makes a comparison of items much easier since an operator only sees the items related to the original selection. FIG. 19 shows this enhancement to the focus GUI 1800. The aforesaid functionality can be deactivated by selecting an icon that corresponds to expanding the view (such as icon 1804) to show items in an item set.

As shown in FIG. 20, the GUI 400 can render an interface node diagram GUI 2000, such that the interface node diagram GUI can be part of the GUI 400 or be a separate GUI. Node diagrams are good to display and analyze dependences between items. Items are showed as shapes and relations are drawn as lines connecting the shapes. Groups of items can be shown as colored areas outlining the item shapes. A diagram tool of the GUI 2000 includes two areas, interactive diagram 2002, located to the right, and a settings area 2004, located to the left. Selecting the sash bar 2006 can hide the setting area 2004 in the example shown in FIG. 20. In the interactive diagram 2002, the shapes can be moved using various gestures, such as techniques including click and drag. These interactions can be done by using a mouse or via a touch screen. In some examples, a single click on a shape can lock the position of the shape, if the shape is moved it can stay where it is placed. A single click again can unlock it. Also, in such examples, a double click on a group (a shaded area) can collapse it. The shape can have an indicator to show that it is collapsed, such as the shape can be black to show it is collapsed.

In FIG. 20, a first group 2001 includes fourteen items (such as items 2001a and 2001b), and the second group 2003 includes two items 2003a and 2003b). Within the first group 2001 there are two sub-groups 2005 and 2007, one having three items and the other having four items. A user can select (such as double click) a black shape to expand a group (not shown). As shown, corners of the interactive diagram 2002 have selectable icons for interacting with the shapes. Icon 2008 fits the content of the diagram to the boundaries of the window or the display being operated by the user, depending on the implementation. Icon 2010 updates the diagram content, with respect to the most updated data on the server. Icon 2012 locks the position of the shapes in the diagram 2002, and icon 2014 unlocks the shapes. Icon 2016 activates a snapshot of the diagram 2002, which can be available on a clipboard or saved to the server or client.

As depicted in FIG. 20, the settings area 2004 includes multiple sections that can control the item types and the layout of the diagram 2002. These sections can include whether to show grouping in the diagram (e.g., see checkbox 2018), show grouped items as one or individual shapes, color of the shapes, show an illustration in the shape, what to include in the label, and filter to include/exclude items based on some attribute, such as size of the shape.

Also, as shown, the settings area 2004 shows the sections can also include a choice from three layouts of the diagram. Each of the three layouts shown have specific algorithms to organize the item shapes and can be selected in the settings area 2004. The first shown layout (the regular node diagram layout) is shown in the diagram 2002 and by the graphic 2020. The regular node diagram layout organizes the shapes in a fashion that shapes can repel each other and relations can pull shapes together. For example, the first shown layout may include a layout derived from a force-directed graph drawing algorithm. A result can be a diagram separating items or cluster of items with no or weak relations. The second shown layout (the circular layout) is shown by the graphic 2022. The circular layout organizes that shapes by placing one set of item shapes on a circle and relations are drawn inside the circle. This can indicate items to be grouped together. The third shown layout (the hierarchical node diagram layout) is shown by the graphic 2024. This third layout can be the first shown layout upon opening the interface node diagram GUI 2000. The third layout includes a hierarchical tree structure, which allows it to show two structures at the same time. There may also be other filters to define what may be included in the diagram or not.

The interface node diagram GUI 2000 can be launch from a tool from a selectable icon for activating the GUI 2000. For example, within the generic product structure (GPS) tool, the icon for activating the GUI 2000 can be selected (such as by checking one of the boxes in GPS GUI 7000 shown in FIG. 70).

As shown in FIG. 20, the diagram 2002 shows relationships between end nodes shown in the GPS tool and interfaces shown in the interface matrix (IM) tool. The nodes are displayed as round shapes (such as items 2001a and 2001b). Interfaces are shown as arrows connecting the nodes, which can also be displayed as diamond shapes where the interface includes a condition. Product module sets are shown as colored areas or groups (such as groups 2001, 2003, 2005, and 2007).

As shown in FIG. 20, the settings area 2004 includes many parameters to set that relate to the formatting and content of the diagram 2002. The checkbox 2018 relates to whether to include product module sets in the diagram 2002. The color by parameter selection area 2026 relates to coloring the node shapes according to the color of the module, its status, its strategy or as a measure of how many module variants exist for the module. The check box “show illustration” 2028 allows for illustrating the product module with the shape or not. Label the shape parameter selection area 2030 allows labeling of the shape with code or name of the node, module code or name, and characteristics of the node. The node size slider 2032 allows for changing the size of the selected shape. The interface size slider 2034 allows for changing the size of the selected interface.

In FIG. 20, interface settings are shown to the right of the node settings. Checkbox 2036 provides for selecting whether to show interface requirements separately. The interface color by area 2038 allows for selecting to color the interface shapes according to their priority or the interface type. The “show illustration” checkbox 2040 allows for selecting to show respective illustrations of an interface. The interface label area 2042 allows for selecting to label the interface shape with interface code, name (may only be applicable when separate interfaces are displayed, in some embodiments), and interface type. The filter button 2044 activates a separate window or section for filtering the depicted interfaces by interface type.

Individual interface relations can be toggled on and off by the interface toggle button 2046. This is intended, for example, for products that use one product module in several nodes. In some embodiments, when the function is active interface relations can be toggled on/off by double clicking in the diagram. Inactive relations are drawn with dashed lines in FIG. 20.

FIG. 21 illustrates example nodes of an example product properties diagram GUI 2100, which is similar to the interface node diagram GUI 2000. However, the diagram GUI 2110 shows how product properties relate to each other and the nodes via the product modules. Such a GUI can also be launched from the GPS tool. The diagram section of the GUI 2100 shows relations between end nodes provided by the generic product structure (GPS) tool and product properties (PP) tool defined in module variant specification (MVS), system property matrix (SPM), and commercial offerings (COM) tools. In FIG. 21 the nodes are displayed as round shapes as well. Product properties can be shown as diamonds (not depicted). Unifying product properties are shown as squares (depicted), including the commercial and system properties. The relationships between the items are shown as lines. Product module sets are shown as colored areas and groups.

Unifying product properties can be different in scope. For instance, some unifying product properties can be globally controlling of all instances of a property. Also, some unifying product properties can be locally controlling. For example, such properties can be locally controlling within the branch of a nodal system in which they are assigned (such that they are controlling of all instances of corresponding properties within a branch of a node structure).

The node settings are similar in FIG. 21. However, FIG. 21 also depicts product property settings for the diagram in the GUI 2100. The product property settings include a checkbox labeled “only connected” 2102, which allows for selecting to only show product properties that are connected. These settings also include a color by selection area 2104 that allows selection of coloring the product property shapes according to the product property, its status, its scope, its classification or the number of goal values. They also include a label by selection area 2106 that allows selection of labeling the shape with product property name, code, unit, scope or classification. They also include a filter button 2108 to filter which product property classes to include via a separate window or section having various filters. The property size slider 2111 allows for changing the size of the selected shape. The layout settings are similar accept for the circular layout selection graphic 2112. The circular layout selection graphic 2112 organizes the shapes by placing one set of item shapes on a circle and relations are drawn inside the circle. This can indicate items to be grouped together. In the case of the layout related to graphic 2112, the items are reorganized by product properties. Also, referring to FIG. 21 and back to FIG. 20, circular layout graphics 2114 and 2022 can be for selecting organizing items in the diagram by nodes.

Also, a filter can be set for the strength of the product property to module relation, this can hide any relation that is weaker than a certain threshold selected. The selection of the filter can occur via the relation settings area 2016. The area 2016 also provides an option 2017 to show (or not) relations between product properties that can appear from commercial or system properties.

### Market Input Tools of the PAS

FIGS. 22-33 illustrate example market input tools of the PAS. The GUI 400 can render each tool within the tool area 404 or within a different window or section. The market input tools include a segment ranking (SR) tool, a customer value ranking (CVR) tool, a pairwise (PR) tool, a quality function deployment (QFD) tool, a property benchmark (PB) tool, a development portfolio evaluation (DPE) tool, a property analysis (PA) tool, commercial offerings (COM) tool, and a commercial launch planner (CLP) tool.

FIG. 22 illustrates an example GUI for the SR tool, the SR GUI 2200. The SR tool calculates the individual ranking of a segments of a market based on market strategy. The SR tool uses relations between brands and segments in values (e.g., values 2202 and 2204). The values can be market shares, units sold, turnover or any other value that can measure or quantify the relation between segments and brands. The brands can also be weighed against each other. The weight of a brand (e.g., weight 2206) can reflect importance, future change, or strategy with respect to the brand. The column sum 2208 of the weight can be provided as guidance. The row sum 2210 for each brand can also be provided as guidance. The column product sum for each segment (e.g., sums 2212 and 2214) can be an auto weight of the segments and can be used by the CVR tool.

FIG. 23 illustrates an example GUI for the CVR tool, the CVR GUI 2300. The CVR tool calculates a ranking of customer values (such as customer values 2302 and 2304) based on individual segment rankings and segment importance. The CVR tool combines rankings of customer values for different customer segments. The influence of each segment can be controlled by a weight. The weigh (e.g., such as a weight derived from a corresponding column product sum from the SR tool) can be the outputted from the SR tool or entered manually. FIG. 23 shows the weights (e.g., weights 2212 and 2214) from the SR GUI 2200 in FIG. 22. The segment ranking can either be done directly by entering numbers (e.g., the higher number the more important it is) or by pairwise analysis outputted from the PR tool. Values can be sequential or on a graded scale.

A pairwise analysis can be launched by selecting pairwise comparison button in the editor area 406 of the GUI 400 when the CVR tool is activated in the tool area 404 (not shown). If a pairwise analysis is created the user can choose whether to use a result from the pairwise or use the manual input. The order winner (such as the highest ranked customer values within a segment) can by adjusted by setting the order winner threshold. The CVR GUI includes a slider 2306 for adjusting the order winner threshold. The order winner threshold is the percentage of the highest ranks that may qualify as an order winner.

If the segments are very far from each other in their values regarding buying decisions the rankings can be normalized. A normalizing algorithm can generate a normalized customer value (e.g., a customer value connected to a buying decision) to have a midgrade score. Other customer value rankings (such as rankings 2308 and 2310) can be recalculated keeping their internal order redistributed within a magnitude. This is to prevent a lower ranked buyer to have too much influence. In exemplary embodiments, an individual customer value can be selected for normalization.

A result from the CVR tool can include a graded ranking of the customer values that can be used by the QFD tool. The number of ordered winners for each customer can also be calculated and can be inputted to the PA tool.

FIG. 24 illustrates an example GUI for the PR tool, the PR GUI 2400. The PR tool can generate provide a ranking of customer values for a specific segment. The PR tool sets a relation between two customer values, such as which customer value has priority over the other. This can be done by pointing the arrow (such as arrows 2402 and 2404) to the superior customer value in each cell. As shown in FIG. 24, the PR tool can repeat the comparison between two customer values for each customer value pair. The PW tool can be a sub-tool to the CVR tool and can be opened in a new window, and multiple PW tools can be opened at the same time. For example, the PW GUIs can be placed in different tabs of a window such as a window of the GUI 400. The PW tool can output a rank for the customer values, such as ranks 2406 and 2408. The rank can be derived from the sum of the number of superior relations from each customer value. As shown, rank 2406 (which is the rank of the customer value labeled “high readiness”) has the highest rank of ten out of ten values because when compared to the nine other customer values it is determined to be most valuable. Rank 2408 (which is the rank of the customer value labeled “easy to stow”) has the lowest rank of the ten values because when compared to the nine other customer values it is determined to be least valuable.

FIG. 25 illustrates an example GUI for the QFD tool, the QFD GUI 2500. The QFD tool can generate and provide a relationship between a customer value and product properties.

If the auto box 2502 is checked in the QFD GUI 2500, the ranking of customer values is transferred from the CVR tool, otherwise a manual ranking is used. The trend column 2504 indicates whether some customer values can be expected to have a significantly increased importance in the future. The magnitude of the relation between a product property and a customer value is set by using score symbols (such as score symbols 2506 and 2508). As shown, the score symbols in the QFD GUI 2500 are a variety of the icons 1302-1306.

Product properties (such a product properties 2510 and 2512) are defined by goal values. The definitions of the product properties can be generated in an item editor (such as the item set editor GUI 1700) that is shown when a product property is selected. As shown, the product property 2510 is selected, which is labeled “PP10-Shape of inlet”. The editor can then define the unit of the product property and set the classification. Such definitions can also be done from the PA tool. Also, the editor can define the type of the goal values, which can be in a range, a list, discrete, and a Boolean. Goal value can be added, removed, and changed using one of the action buttons 2514.

Each goal value can have a launch wave, when it is expected to be launched on the market, and a comment. Launch waves can be edited in the items set editor GUI 1700, the MVP tool, or the CLP tool. Also, as shown, the lists of customer values and product properties have their own respective action buttons for changing the lists.

Results from the QFD tool can include a weight of each product property (such as weights 2516 and 2518), a product sum of the customer value weight and a product property relation score (such as sums 2520 and 2522). Also, a positive trend outputted from the QFD tool can be used by the PA tool and concept evaluation matrix (CEM) tool within the design property matrix (DPM) tool.

FIG. 26 illustrates an example GUI for the PB tool, the PB GUI 2600. The PB tool can be used to understand which product properties may be developed due to competitor performance. A competitor (such as competitor 2602) can be selected as a reference. Using the reference, the PB GUI 2600 can recommend product properties that are in scope with a project, and gaps in the scope generated by gap calculations can be made against the reference competitor. Several internal products can be used to understand differences. Also, an operator can set graded scores (such as within a default scale of graded scores 1-5 where higher score is better), e.g., graded scores 2604 and 2606, for a competitor and product property pair. With respect to the reference competitor, a gap to market average value (e.g., value 2608), a gap to market leader value (e.g., value 2610), and a market position value can be determined (e.g., value 2612). These values represent where there is a competitive gap. The competitive gap value (e.g., value 2614) can be set manually or automatically for each product property using the score symbols, according to the gap to market average, gap to market leader, and market position values. The competitive gap value can be used by the PA tool.

FIG. 27 illustrates an example GUI for the DPE tool, the DPE GUI 2700. The DPE tool can be used to understand ongoing development projects and how they impact the product properties. Ongoing development projects (such as project 2702) are listed and the magnitude of the impact can be set for each product property using the score symbols. The planned improvement score (such as score 2704) is calculated automatically, where scores one and two are considered low, scores between three and eight are medium, and nine and above are considered strong scores. A result from the DPE tool can include a planned improvement.

FIG. 28 illustrates an example GUI for the PA tool, the PA GUI 2800. The PA tool can be used to consider information captured and compiled in PAS for a market input process. The information can be summarized for analysis in the PA GUI 2800. Primary features of a module system can be analyzed and adjusted from the PA GUI 2800, including general importance of the module system, general order winner of the module system, and segment spread of the module system. Thresholds that affect the resolution can be varied individually by interacting with the PA GUI 2800, such as by using sliders 2802, 2804, and 2806. Varying the threshold effects may be considered when making a conclusion through the application of a classification to each of the product properties (such as classification 2808).

The three sliders 2802, 2804, and 2806 can set the threshold values for the critical features of the module system. Each threshold value can affect a resolution through a programmed algorithm. In examples, colored values can be provided on each of the sliders and they can provide the recommended range that the algorithms are designed to operate within, values outside these ranges can be used to improve clarity.

In the PA GUI 2800, the first slider 2802 effects the general importance threshold. It controls which product properties may be considered being of general importance based on their weight. The threshold is a percentage of the maximum score.

The second slider 2804 effects the general order winner threshold. It defines whether an order winner for a customer value may be general across market segments or specific to selected market segments. The product properties relation that connects a customer value with an order winners is either reported in the “order winner, general” or “Order winner, specific” row. The threshold defines the number of order winners required to be considered general by a percentage of the number of segments.

The third slider 2806 effects the variance spread threshold. It controls the magnitude of the variance provided by a product property. The threshold sets the relative spread value of the variance.

The PA GUI tool can calculate scores for general improvement and variance specific improvement based on an algorithm. A result can be an indication or recommendation for a manual or automatic decision for the property classification. Property classifications (such as classification 2808) can include: extension (E), which is a combination of D and V; development (D) in which general importance is high; variance (V) is variance specific improvement is superior; base (B) which is both indicators are low; and option (O) cannot be considered at the phase of the module system presented to the client of PAS by the server.

A result from the PA tool can include a classification of the product properties of the module system based on the market input.

FIG. 29 illustrates an example GUI for the COM tool, the COM GUI 2900. The COM tool can be used to define a set of commercial properties and assign pricing to the commercial properties. A search can be initiated from the COM GUI 2900 for properties to define a set of commercial properties and assign pricing. FIG. 30 illustrates an example properties editor GUI 3000 of the COM tool. The checkbox next to the commercial button on the GUI 3000 sets the scope of the product property to commercial property. Commercial properties are listed in the left column. This can enable the button which can launch the commercial property editor.

The goal values of commercial properties (such a commercial property 2902) can be assigned with a set price or a calculated price parameter (CPP). A set price is a value that can be included as it is and added to the total price. A CCP can be used for more advanced price items that use some sort of formula to calculate the price. The formula for how to use the CPP value can be described in the text area just above it. An interaction (such as a double click) with the cell and a text editor appears (such as text editor 3100).

The formula to calculate a price based on CPP can be programed in PAS or a configurator system that hosts PAS.

Selecting a commercial button in a product property editor (such as the item set editor GUI 1700) can open a commercial property editor (such as commercial property editor GUI 3200) to show the commercial property isolated with its goal values and related product properties. The commercial properties can have relations to other product properties as well, specifying goal values of these to match the goal values of commercial property. This works similarly for the system property matrix (SPM).

A result from the COM tool can include a set of the commercial properties that can specify a product and generate a price that is value based.

FIG. 33 illustrates an example GUI for the CLP tool, the CLP GUI 3300. The CLP tool can be used to define when in time to introduce the different goal values of product properties, including commercial properties. The check boxes in the CLP GUI 300 can be used to select which type of properties to display, such as whether to display commercial, product, system, or other types of properties. The properties (such as property 3302) can be expanded to display the goal values (such as goal value 3304). A user can assign a launch wave (such as launch wave 3306) to the goal value by double clicking in the corresponding cell, and a check mark indicates the assigned launch wave. Results of the CLP GUI 3300 can include planned introduction of the different goal values for the product properties.

### Engineering Input Tools of the PAS

FIGS. 34-45 illustrates example engineering input tools of the PAS. The GUI 400 can render each tool within the tool area 404 or within a different window or section. The engineering input tools include a design property matrix (DPM) tool, functional analysis (FA) tool, a concept evaluation matrix (CEM) tool, a system property matrix (SPM) tool, and a value analysis (VA) tool.

FIG. 34 illustrates an example GUI for the DPM tool, the DPM GUI 3400. The DPM tool can be used to connect technical solutions with product properties to understand the impact of the different technologies on the customer values. The property classification (such as classification 3402) of the product properties can be communicated from the PA tool to be shown as reference information. If scope (such as scope 3404) has been assigned to a product property it can also show as reference information. The weights (such as weight 3406) for the product properties may be a result from the QFD tool. There is an option to use manually entered weights by deselecting the auto box. Otherwise, the DPM GUI 3400 can populate the weights for the product properties automatically. The strength of a relation between a technical solution and a product properties can be set automatically or manually and as shown can be represented by a score symbol (such as score symbol 3408). Two different scores are shown calculated in the matrix of the DPM GUI 3400. A complexity value (such as value 3410), which can be the product of relations for a function (such as function 3412). A high complexity value, such as one that exceeds a predetermined threshold, indicates that the function may be divided in two or more functions to reduce its complexity. The second score shown as calculated via the matrix of the DPM GUI 3400 is an importance score (such as score 3414). The importance score can be the product sum of the connection and the weight of the corresponding product properties per function. Each row in the matrix of the DPM GUI 3400 can represent a function, and each of the functions can have one or more technical solutions (such as solution 3416).

An editor (which can be displayed in the editor area 406 if the GUI 400) can be used to document a function with an illustration and additional its basic information such as name, status, description, and who is responsible for the creation of the function in PAS (e.g., see the function editor GUI 3500 illustrated in FIG. 35). Shown are two buttons to open sub-tools. One of the sub-tools is a function analysis tool, where alternative technical solutions can be generated. The second shown tool is the concept evaluation tool, where alternative technical solutions can be evaluated. In an exemplary embodiment of the DPM GUI 3400, a technical solution can be an alternative solution that is selected. The first alternative solution created can be selected by default.

Results from the DPM tool can include relationships between technical solutions and product properties. The sum of scores for each product property can also be provided as a feedback. The importance score can be used in downstream tools and reports. The complexity score can be used to help understanding of the matrix within the DPM GUI 3400 and it gives feedback if some functions are to aggregated and split to another level of detail.

FIG. 36 illustrates an example GUI for the FA tool, the FA GUI 3600. The FA tool can be used to generate several alternative solutions and to specify which product properties influence a product function and its one or more solutions. This procedure can be referred to as “bottom-up” functional analysis. The FA GUI 3600 can launch from the function editor in the DPM tool using the functional analysis button. The FA GUI 3600 allows for reviewing the description and illustration of the function and make additions if required in the editor area such as editor area 406. If the function editor such as editor GUI 3500 is not visible, it can be selected from the tabs in the editor area or unselect by any other selection in an empty place somewhere in the tool area.

If no product properties have been assigned yet, assignment of properties can be initiated by interacting (such as by double clicking) in the corresponding cells.

The FA GUI 3600 is also shown to list and describe the existing solutions that are used to provide the function, using the text area labeled “Existing variance”. This field is a reference field.

Also, based on the known conditions an operator can start to collect ideas for how to deliver the function in other ways, and add such ideas in the field labeled “Alternative solutions” (which can be a list). Also, shown in FIG. 36, the operator can describe each of the alternative solutions in its description area in the editor.

Results from the bottom up FA tool can include a set of alternative solutions that can provide a function of the module system.

FIG. 37 illustrates an example GUI for the CEM tool, the CEM GUI 3700. The CEM tool can be used to compare and evaluate different alternative solutions that serve the same purpose and/or function and select one or more of them to be used as technical solutions. The CEM GUI 3700 can be launched from the concept evaluation button in the function editor 3500. If there are no alternative solutions, open the function analysis to generate some or create them directly in this tool. The CEM GUI 3700, as shown, includes a field to choose whether to make an absolute or relative evaluation by selecting a graded evaluation (e.g., an evaluation of one through five) or Pugh evaluation (e.g., +, =, −). In some example, the first alternative solution that is created is selected by default, but this can be changed manually.

In the CEM GUI 3700 there are three tabs showing customer values (which can be communicated from the CVR tool), product properties (which can be communicated from the QFD tool), and internal criteria (which can be entered directly via the CEM GUI). The customer values and product properties that have a connection to the technical solution can be preselected and can be manually adjusted, or they can be automatically entered. The weight of customer values can be the same as in the QFD tool. The product property weight can be recalculated from the product property weight in the QFD to a graded scale. The weight for the internal criteria can be set manually. Alternatively, the processes can be automated. The rising trends in the CEM GUI 3700 can also be imported from the QFD. The product property gets a rising trend if it is related to a customer value with rising trend. The trend of internal criteria can be set manually or automatically imported.

The CEM GUI 3700 is provided such that the customer value and the internal criteria tabs are used or the product property and the internal criteria tabs are used. The customer values and product properties can be overlapping in an analysis. In such cases one of the customer values and product properties tabs can be displayed exclusively.

The CEM GUI 3700 can provide market value that shows the product sum of the weight and the score for each alternative solution in the customer value tab and product property tab. It can also show internal cost that shows the product sum of the weight and the internal criteria found in the last tab. It can also show future proof that shows the product sum of items with rising trends.

In the CEM CUI 3700, the calculate only selected checkbox can be activated such that the GUI includes the selected criteria in results. Results can include an analysis and one or more alternative solutions to be included in a technical solution. This solution can be communicated to the DPM tool.

FIG. 38 illustrates an example GUI for the SPM tool, the SPM GUI 3800. The SPM tool can be used to connect system properties (such as a product property tagged as system property) with product properties. It can be used to define valid product property goal values for each system property goal value. The checkbox next to the system button in the product property editor of the SPM GUI 3800 may set the scope of the product property to system property. This can enable the button which can launch the system property editor. Product properties that are tagged as system properties can be listed in the left column.

System properties can have relations to other product properties. By interacting (such as double clicking) on a cell can connect them that creates a relation between them and is showed with a check mark.

The system property editor 3900 (such as launched from the editor of the product property) can be used to define the goal value relations for the system property and the product properties. Each goal value of the system property can use a specification of corresponding goal values of each related product property.

With interaction (such as a click) on a cell that connects a goal value of the system property and a product property, the relation editor is displayed and enables input and selections of a goal value. The tool also accepts multiple selections in columns, which means that several system property goal values can be defined at the same time. Ranges can be included. A system property cannot be of type range in most embodiments. If a product property has only one range, individual values in the range can be given to each system property goal value. If a product property has several ranges, the system property goal value can select the valid ranges.

In some embodiments, a specific goal value can control compatible goal values of controlled properties. When executed, such a control can operate in both directions, in the direction of the specific goal value to a compatible goal value or vice versa. Also, a system property can list a number of scenarios. Each scenario lists the goal values for each property that is compatible with the scenario.

The system property can be made a local system property by checking the option local in the product property editor 3900. Local system properties can be assigned to a product module set node in the generic product structure (GPS) tool to be included in the logic. The control scope of the local system property can be from the node where it is applied and downwards in the structure. The same local system property can be applied at several nodes and can be independent from each other.

In some embodiments, the logical structure and sub-structures of the logical structure can be stored as reusable units. The reusable units can be stored in memory and in code libraries of the PAS.

Another advanced feature of the SPM tool is the product property instantiation. The use case for instantiated properties is to control the layout of a product where the same product module is realized several times in the product structure. In the example illustrated in FIG. 40, interacting with the box next to the button instances can activate the function. The launching of the function of the product property instances editor is shown in FIG. 41. From the editor, a user can add or remove and manage the instances with the action buttons to the left. Also, the user can select an instance to rename it. The order of the instances may be kept in any other tool using the instances. Once a product property is instantiated there can be a new option available in the relation editor between the system property and the product property as shown by FIG. 42. Interacting with the option use property instances instead of main property can enable the instances in the system property editor, and this selection is shown in the SPM GUI 3800 as a matrix inside the cells as shown by FIG. 43.

To see and manage the actual content of the instances the system property editor can be opened. The main property is shown as reference but is not active for input, instead the instances of the property is active for inputs, as shown in FIG. 44. These property instances can later be used by the configurator system and the generic product structure to set the value of the main property for a module. The main property and the instances are sharing the same product property definition which is displayed in the product property editor. The SPM GUI 3800 can output a definition of system properties, and their relationships with product properties.

FIG. 45 illustrates an example GUI for the VA tool, the VA GUI 4500. The VA tool can be used to understand where development resources are best used. A relative cost index can be given for each technical solution. It can be in a currency (such as USD, EUR, etc.) or a relative number. The value/cost index is calculated based on normalized numbers. The new index shows where to get most customer value out from the least cost. Results from the value analysis can include the value/cost index which can be used as feedback when planning engineering activities.

### Modularity Enhancement Tools of the PAS

FIGS. 46-64 illustrate example modularity enhancement tools of the PAS. The GUI 400 can render each tool within the tool area 404 or within a different window or section. The modularity enhancement tools include a module indication matrix (MIM) tool, a module generator (MG) tool, a module driver matrix (MDM) tool, an interface matrix (IM) tool, and an interface variance editor (IVE) tool.

FIG. 46 illustrates an example GUI for the MIM tool, the MIM GUI 4600. The MIM tool can be used to assign the strategic module drivers to technical solutions. These can be used when creating the product modules. The magnitude of the relation between the module drivers and the technical solutions are set with score symbols. The sum for each module driver is shown; this is only for feedback and indicates what the overall business strategy can be. A result from the MIM tool can be the module driver profile for each technical solution.

FIG. 47 illustrates an example GUI for the MG tool, the MG GUI 4700. The MG tool can be used to define product modules using the relations from the design property matrix and module indication matrix. The first tab, statistical clustering, can be used to analyze the mathematical cluster. The second tab, module creator, can be used to create product modules. The data that is used for the clustering can be adjusted. The information is gathered from the DPM and MIM, these are the relations for technical solutions between product properties and module drivers.

Shown are three options when choosing which product properties to use: none, all, and interface driving properties. Interface driving properties are the ones that are classified as variance, development, option or system. Also, shown are three options when choosing which module drivers to use: none, all, and secondary. Secondary module drivers are the ones that do not involve improvement or variances.

Statistical Clustering can be done by using different metrics and methods. The default metric can include a Pearson distance and the method can be a centroid method. Other metrics available is squared Euclidean distance. Other methods can include a Ward method. Clustering can include entering several clusters fewer than the number of technical solutions. It can also include running the clustering algorithm by selecting the create clusters button. It can also include analyzing a result by view dendrogram, such as shown by FIG. 48. In FIG. 48, the graphs indicate that 19-22 clusters are good, and the distance between the clusters starts to be relative small.

A user can remedy the issue by entering a new number of clusters and then create clusters to update the clusters. Iterations can be used to understand the differences. Create product modules can remove any existing definitions of product modules. This can be beneficial before automatically generating product modules from the clusters. The usage of module creator can be used for evaluating the mathematical clusters. It can be used for changing module name and reordering the product modules and technical solutions if necessary for clarity.

Technical solutions can be moved between product modules by drag and drop. New product modules can be created. Also, it allows for deleting product modules. A product module can only be deleted when there is no technical solution assigned to them in some embodiments. Also, in some embodiments, if technical solutions are added after that the product module has been created they can be assigned to a default module. Result from the module generator can include product modules with an assigned technical solution.

FIG. 49 illustrates an example GUI for the MDM tool, the MDM GUI 4900. The MDM tool can be used to assign module drivers to each product module and select the strategy of the module. The module drivers are assigned to product modules. If technical solution has been assigned module drivers these relations can be captured to help populate the matrix. Strong and medium relations to a technical solution are indicated by an X in the MDM. These can be evaluated manually and set to the appropriate strength, or unset appropriately.

The indications can be reactivated by selecting the capture MIM relation button.

The product module can be expanded to better understand the reason why module drivers are indicated to a module. This can show the technical solutions of the product module and the assigned module drivers.

The module drivers can relate to one of the three strategies (also known as values disciplines): customer intimacy, operational excellence and product leadership. The strategy for each product module can be set either in the tool or in the module editor. To achieve consistent strategies within the product module some rearrangement of technical solutions may be used. Technical solutions can be move between product modules by drag and drop.

Three different values are calculated in the matrix. The column sum indicates the strategic profile of the module system. Complexity value is the product of the strongest connections to product properties. The connections are coming from the technical solutions and can be seen in the mDPM editor. High complexity value indicates that some technical solutions may be moved to a new or existing product module to reduce the complexity. Importance score, is the sum of the technical solutions DPM score, and which can be summed up for each module.

A code may be set in the module editor, which can be for easier tracking as names tend to update. The code can be shown as a prefix in the name. If the code is not unique it can be highlighted, such as in red, as a warning.

An illustration may be added in the module editor to improve clarity of the module.

A user can document the reason for every relation in the MDM (e.g., module to module driver score) using the shown memo field. A memo can be indicated with a red corner, and such a memo can be reported in the product module and interface reports.

A result from the module driver matrix can be a strategic profile with reasons what to consider and a strategy for each module.

FIG. 50 illustrates an example GUI for the IM tool, the IM GUI 5000. The IM tool can be used to define the interfaces between product modules. The interfaces can give an understanding of the assembly order and how to prioritize the development work. The tool is used to assign interfaces between product modules. There are two level of interfaces: product module interfaces (as represented by the cells in the IM) and shared interfaces (which can be assigned to one or more product module interfaces).

An interface is added by selecting the cell between two product modules. Then a GUI to enter the relation is provided. A user can enter the data about the interface in the relation editor 5100 illustrated in FIG. 51. A user can add a memo such as who is responsible. Code is generated automatically but can be modified. The code can be highlighted as a warning, such as in red, if not unique. A user can assign the importance by considering the hierarchical level, decoupling of product module sets, and separating of design tasks. A user can assign the risk by considering risk of changes in product modules and evaluate related module drivers. A user can double click on the picture area to add an illustration of the context of the interface. The picture can be uploaded or copied from the clipboard. The original file can be stored along with the image as well to support later refinement of the illustration.

A user can then select the interface requirements editor to create and document requirements on the interface, such the editor 5200 shown in FIG. 52. A user can add a requirement by clicking on icon 5302, which can add a row in the editor such that they can choose an interface type from the dropdown list 5300 shown in FIG. 53. A user can give the direction of the interface, select receiving product module or select bidirectional communication. A user can give a clear explanation of the requirement, provide a reference if there is an external document or standard, and select an existing shared interface.

In some embodiments, only shared interfaces of the same type as the requirement can be selected. An illustration of the product module interface may be added by selecting the illustration button. Interface types can be added both from the product module interface editor and the shared interface editor, by pressing the button named interface types. A user can add a new interface type with 5302; and give the name, abbreviation and description, a user can define if the interface type has an impact on design or assembly order. This is relevant for what is showed in the different views of the interface matrix.

The shared interfaces editor 5400 shown in FIG. 54 is launched by the pressing the button with the same name.

The interface matrix includes three views to display the interfaces, such as the complete view 5500 shown in FIG. 55 shows interface types and can use filters. This view is primarily used during creation of the interface. Design view 5600 shown in FIG. 56 can be used to display interface types influencing the design order, and reorder interface to form groups of product modules to be design together. This view can present interface types or codes. The assembly view 5700 shown in FIG. 57 shows display interface types influencing the assembly order, and a user can reorder product modules to find groups of product modules suitable for preassembly. This view can be present with interface types or codes.

The interface matrix can be presented in four different modes as shown in FIGS. 58-62. The interface type 5800 shown in FIG. 58 shows the abbreviation for interface types, if an interface type is repeated it may only be shown once in the matrix. Interface code 5900 shown in FIG. 59, shows the code of the product module interface and assigned shared interfaces, and interface code can be shown once in the matrix even if it is assigned several times. Overview 6000 shown in FIG. 60 shows an X if there is any kind of interface assigned. Importance/Risk 6100 shown in FIG. 61 shows a combination of importance and risk, used to prioritize the design work. A “?” indicates that a least one of the parameters is not set. The scores are shown in FIG. 62. Results from the interface matrix can be documented interfaces and the relations between product modules, the priority (e.g., importance and risk) for product module interfaces and groups of product modules based on assembly interaction and design criteria.

FIG. 63 illustrates an example GUI for the IVE tool, the IVE GUI 6300. An example purpose of the IVE 6300 is to manage variance within a product module interface. The tool documents what interfaces a module variant may utilize and which module variants that can be connected from the two product modules.

Individual interfaces requirements can be assigned either to module variants or the relation between module variants. If a relation is selected the interface requirement can be assigned to the connected module variants. Selection can be made using multi-selection as well. Relations that connect two module variants that have similar interface requirements assigned can show the interface code or type to indicate that these module variants can be connected.

When there is a specification in the interface variance editor this can be flagged in the IM tool 6400 by a small matrix background in the cell of the product module interface, as shown in FIG. 64. To delete the interface variance indication, specifications need to be cleared in some embodiments. This can be done by selecting relations using point and drag, and then in the editor uncheck interface requirements. This information can also be exported to the configurator model used in the CFG tool. The configuration file can be edited manually to define additional rules on how to allow module variant connections. A result from the interface variance editor can include documentation of which specific shared interface a module variant may utilize and what module variants are possible to connect between the two product modules.

### Product Configuration Tools of the PAS

FIGS. 65-82 illustrate example product configuration tools of the PAS. The GUI 400 can render each tool within the tool area 404 or within a different window or section. The product configuration tools include a module variant specification (MVS) tool, a module variant planner (MVP) tool, a generic product structure (GPS) tool, a configuration interface (CI) tool, a configurator (CFG) tool, and a configuration table (CT) tool.

FIG. 65 illustrates an example GUI for the MVS tool, the MVS GUI 6500. An example purpose of the MVS tool is to create module variants with specified goal values. The first rows report feedback for the product properties, such as units, scope, property classification and number of values (e.g., number of goal values/Range/Yes or No). The MVS tool can include a filter, as well as all properties can be displayed. Also, interface driving properties, such as all properties except base properties, can be displayed. Properties without a classification can be displayed as well.

In some embodiments, the unifier checkbox in the product property editor can set the configuration profile that the unified product property may meet the same goal value of items specified by it in a configuration. This may be considered if a product property is interface driving and has connections to more than one module. If a product property is selected by a system or commercial property and is not of type range it can automatically be set as a unifier.

By checking the fulfillment status option, such as in FIG. 65, the goal value fulfillment status for product modules variants, the assigned goal value and the product properties are shown with indication of status such as in different colors (e.g., red is not feasible, yellow is delayed, green is fulfilled).

The product modules can be expanded or collapsed to improve visibility. The product module rows show the highest score coming from the technical solutions, these product properties are assigned to the product module and are specified with a goal value.

The specification can either be made in the MVS or in the separate module variant editor 6600 shown in FIG. 66. This editor is launched by selecting the module variants button in the module editor.

By default, in some embodiments, each product module can have one module variant 6601. Additional module variants 6601 can be added (and deleted) using the action buttons such as on the left-hand side. Description and launch waves can also be entered in the table. By selecting a relation between a product property and a module variant, the input dialogue 6602 can appear, as shown in FIG. 67.

The launch wave of the selected goal values and the goal value of the module variant can be considered to enhance consistency. A warning can be issued if the launch wave of the module variant deviates from an assigned goal value. This warning can be shown on the module variant in the MVS tool as well.

A new module variant can be given a code automatically. This code is fixed to the module variant but can be manually changed in some embodiments. The index number can be changed, and the prefix and separator cannot be modified manually. The code format is defined in the module system properties in some embodiments as well.

Multi-selection (e.g., point and drag, Ctrl- or Shift-click) within a column (such as a product property column) can allow several module variants to be assigned at one time.

In some embodiments, a filter that can either show properties that are related to the product module or only show interface driving properties. This can be for all properties except for base properties in some embodiments. The interface driving properties filter can exclude properties that have a low relation to the product module (such as properties less than a medium (3) or strong (9) relation). Base properties can have one goal value and are auto assigned to module variants.

To change a product property definition (such as goal values), a user can select it in the tool and it can be displayed in the editor area. If a goal value is changed in the product property editor it can update in the module variant definition as well.

If a relation between product properties and a product module is missing it can be created through one of the technical solutions of the module. This can be done using the module DPM editor 6802 as shown in the DPM GUI 3400 in FIG. 68. It is launched by clicking the mDPM button in the module editor. Results from the module variant specification can be module variants with assigned goal values and launch waves.

FIG. 69 illustrates an example GUI for the MVP tool, the MVP GUI 6900. An example purpose of the module variant planner is to plan when to release the different module variants. This can be done with respect to three aspects: variants available to meet the launch wave of assigned goal values; variants available to meet the launch wave of planned product variants; and variants not available before they can be fulfilled. The tool lists the product module and module variants together with the launch waves. The assigned launch wave for each module variant is showed with icon 6902.

To change launch wave for a specific module variant a user can double click in a new cell. Launch waves that are constrained are highlighted such as with a grey frame as shown. A tool tip can explain the source of the constraint. If still assigned it can be indicated such as by turning red. This can allow a user to resolved the issue in another tool if possible. Launch waves can be added and deleted in the MVP tool. A launch wave that is used somewhere else (such as by a module variant or a goal value) cannot be deleted. The MVP tool can be useful to use before the MVS tool.

Result from the module variant planner can include a release plan for module variants. This can give a good understanding when a module variant may be designed and released.

FIG. 70 illustrates an example GUI for the GPS tool, the GPS GUI 7000. An example purpose of the GPS tool is to organize the product modules into a node structure that can build the product. This structure may include information about quantities of product modules for each node, such as being fixed, variable, or optional. Also, it can be noted where there are special conditions that need to be met by the module variants to populate the specific node.

As shown, the GPS tool can be divided in two sections, which are the node structure to the left and the node editor to the right. When using the GPS tool for the first time there can be a flat structure for the node structure. For example, a product module can be realized by one node. Also, if a product module is added later, such as by selecting the icon 7002, new nodes are generated so that product modules are realized.

Nodes can also be created manually using the action buttons. Two types of nodes can be created. End nodes are realized by product modules and depicted like icon 7004 in FIG. 70. Product module sets, or intermediate nodes, can include end nodes, such as shown by icon 7006. The insert product module set icon 7008 can create a product module set including selected nodes. A node can be duplicated, and duplicating a product module set can also duplicate the nodes in it. Node names may be unique within the same branch, after duplicating a node there can be a warning highlighting that the node needs to be renamed if it conflicts with naming of another node. Nodes can be reorganized by drag and drop or using the sort buttons. When deleting a product, module set, any nodes in it can be kept at the level of the deleted product module set.

The node structure can display additional information about the node. Node position is the hierarchal position number of the node. This number cannot be modified in some embodiments, and can be a result of the structure. Node code is the code of the node. As codes, they may be unique and can be modified in the node editor 7100 as shown in FIG. 71. A node module shows the product module that can realize the node.

The node structure can improve the generic product structure after analyzing how interfaces and product properties impact the generic product structure. Node diagrams that can be used through the GPS tool and can be selected by selecting one of the icons 7010 or 7012.

The node editor is where the content and additional conditions of the node can be defined. Selecting a node can show its information in the node editor. If the node is realized by a product module it can be showed in the editor area below the tool.

As shown in FIG. 71, each node can have a quantity of how many module variants that may be instantiated. This can be a constant, and can be set as a default value. A user can change the value to reflect the constant quantity. A variable can exist when the quantity depends on the configuration. This can activate the conditions GUI 7200 as shown in FIG. 72. The conditions specify what quantities are applicable and the circumstances. Optional quantity can be selected, when the presence of a product module is depending on the configuration. This can activate the conditions. This specifies when the product module may be included or not. If a node is realized by more than one module variant, it may instead be several nodes realizing the same module.

The conditions are defined by several cases. The cases are defined by product properties. A user can use the select criteria button to display the product properties GUI 7300, as shown FIG. 73, that are available from the product module realizing the node or nodes below in the structure.

In GUI 73, applicable product properties can be selected. For an optional quantity, there can be at least two cases: one for when the product module may be included and one for when it may not. In the condition shown, case 2 defines that Qty=Selected, when Color=Chrome. A checked box equals True, Yes or 1. This can translate into configuration rules that can result in the quantity of this node can only be one if Color=Chrome. More than one case can be to define situations when Qty=Selected (or any other value). The name of a case is only for understanding and does not need to be changed in some embodiments.

A configuration profile can generate unifying rules for product properties selected as criteria. These can apply on the selected node and downwards in the hierarchy. This can be done even though no cases are created or defined. This can be useful with product module sets to unify the goal values within a product module set.

An example benefit of the configuration profile is that it can provide quality assurances in development of a product. This can also be referred to as combinatory analysis. The configuration profile, once completed, can ensure that all items described for a product are known and can be used. Also, valid combinations of items expected can be set through the configuration profile. Also, an acceptable combination of items can be set through the configuration profile. Such functionality can sometimes capture items that are unforeseen.

Another example benefit of the configuration profile is that it can be readily shared with downstream systems. For example, the configuration profile can be shared as it is created or with complimented with additional rules or logic of another system or platform for product development, sales, and marketing.

With product module set nodes of the configuration profile it is possible to select local system properties as criteria as well. A local system property works as system properties but locally from the node and downwards. A local system property can be selected at several nodes and can then act independently of each other.

Select criteria in the conditions GUI 7200 can be used to display product properties that are available. A user can select the tab local system properties to list the local system properties in the local system properties GUI 7400. A user can select the ones to assign to the node. If local system properties are selected, they can be showed in a list in the node editor. By unselecting any node, clicking in the white area within the node structure, the node editor content can show the generic product information GUI 7500 of the GPS GUI 7000.

As shown, the generic product can be described by two illustrations. The generic product visualization, which is an illustration of the product. This can be a rendered picture, and an exploded view or a configuration view. The generic product diagram is a diagram explaining how the product is organized and uses the nodes, interfaces, a product module depictions to show relations.

Other conditions controlling the logic at product level can be managed by separate tools such as SPM, COM, and IM tools.

A result of the GPS can include a logical generic product structure, a node structure with realized product modules, and the logic to control the structure.

FIG. 76 illustrates an example GUI for the CI tool, the CI GUI 7600. An example purpose of the configuration interface is to define the inputs and feedbacks from a configurator system of the PAS or external to the PAS. The input and feedback parameters are defined as fields. These fields are organized in groups and tabs. A user can start with the CI tool by creating a new tab by selecting the icon 7604, and then give it a name. There can be several tabs, the tab active for input is white and includes the action buttons activated. A user can click in a tab to activate it.

Content can be created in a tab. Icon 7606 creates a field to show user input or feedback. Icon 7608 creates a field group to include fields and/or field groups. Icon 7610 can be used to combine a group to create a field group including the select items. When a field has been created, it may be defined in the editor 7612. A user can select whether to show a module variant or one of the product properties using the content dropdown menu. A user can define from which node to display the content for using the node selection menu, as well as unifying product properties, such as defining it as global (e.g., top level). For other product properties, a node that is realized by a product module defined by the product property can be selected. For the content module variant, the corresponding node can be selected. Invalid choices can be graphically indicated.

The nodes can be defined in the generic product structure. The generic product structure can be hierarchical so it may use several selections in a dropdown menu to reach the node. Options starting with [+], for example, can expand to the next level; whereas, options with [−] can back up in the structure. There can be a feedback message of the selection made. Not depicted, an indication such as the color red means that it is bad combination of content and node, or it can be that there is a duplicate of information; for instance, if a product property was selected for a node that has no relation to it.

Some items have related cost or price information. In such examples, the check box next to the content selection can be active. If checked, the field can show the price and/or cost information instead of the value. The field can be selected to be read-only by checking the box next to the title. This is useful when providing the value of a field as feedback from the configurator system. Content and node of a field can be defined in any order. The title can be generated from the name of the content but can be manually edited. Deleting the name can automatically generate a title from the content again.

To speed up the process for creating the fields there are some predefined “recipes” that can generate tabs populated with field of different types by selecting the icon 7604 and on options in the dropdown box 7602. “Commercial” creates a field for a commercial property followed by a field with the price of the selected goal value. “System” creates a field for a system property. “Unifiers” creates a field for a unifying property that is not a commercial or system property. “Structure” creates a field group for a product module set and a field for a product module node showing the selected module variant. “Extended Structure” creates a field group for a node, include both product module set and end node. This can include a field for a product module node showing the selected module variant, followed by a field showing the module variant cost, and followed by a field for a product property of the node that is not unifying.

As a complement to the reordering buttons 7614, fields and fields groups can be reorganized by drag and drop, both within a tab but also between tabs. Fields and field groups can be duplicated as well.

An example result from the CI too can be the user interface for the CFG tool, which can include user inputs and feedback organized in groups and tabs.

FIG. 77 illustrates an example GUI for the CFG tool, the CFG GUI 7700. An example purpose of the configurator tool is to execute the logic to verify the behavior of the module system and to create product variants to the configurator table (CT). The CFG tool can utilize another party's configurator system. Data from the upstream tools can generate a configuration model that is executed in the CFG tool, such as the GPS tool to the CI tool to the CFG tool.

The input fields, dropdown selections and numerical inputs, are accessed through one or more tabs in the shown embodiments. A result of the configuration can include a bill of module variants and related information. At the bottom, as shown it is possible to give a name to the configuration and store it to the configuration table by selecting add as product variant.

In the top area of the CFG GUI 7700 there are five control buttons as shown. “Restart Configurator” generates a new configuration model and launches it in the configurator system. It can be useful if data was modified or updated. “Validate model input” is series of checks that verifies the data quality feeding the configurator model. Issues are reported in the search editor. Issues are classified as: errors that the model cannot run, warnings that the model can run but probably not as intended, and informational in that there is unforeseen usage data format, but the configuration can probable run without issues.

The button labeled “Export to Configurator” can activate exporting a native configurator model in a format parable by the configurator system, and can launch the file if the configurator system is installed. The file can be modified and later imported back to the PAS.

“Reset/clear model” removes old configurator models and generates a completely new model based on data of the PAS. The button labeled “Import from Configurator” can activate importing a configurator model, in the configurator's format that has previously been created by the PAS. The imported file can have additional data and functions, such as configuration rules not available in the PAS.

Dropdown menu 7800 shown in FIG. 78 provide status of product properties. A warning popup GUI is provided to explain the incompatibility as shown in warning GUI 7900 in FIG. 79.

Input fields are shown in FIG. 78. A highlighted selection box means that the choice is a valid choice. A non-highlighted option in the list is what is currently selected. The triangular warning sign to the right indicates that options exist that are not possible to fulfill.

For numerical input fields the min or max limits can be shown in the tool tip. When a selection is made, the depicted pad lock is closed. The lock can toggle between open and closed when clicked. The unit of the product property is displayed to the right of the input field. Tool tips can appear when pointing at various items.

The configuration model can be modified using a separate configurator system and/or the CFG tool of the PAS. The model can be modified to support: additional applications that can be selected; configuration divided in steps, modify the content in the information area; add native rules not available in the PAS; define dynamic structures; and add mapping to CAD models.

A result from the CFG tool can include a valid product semantic and a set of product variants. Error! Reference source not found. can be provided if something goes wrong, as shown in FIG. 80 by the error messages GUI 8000. The configurator tool can be a web application running on a webserver of the PAS.

FIG. 81 illustrates an example GUI for the CT tool, the CT GUI 8100. An example purpose of the configuration table is to define an assortment of product variants, which and how many module variants that are used to build them. The launch wave when the product variant can be available according to the module variants. Product variant can be defined as an explicit product or as product families. Additionally, if a product variant is planned to a specific launch wave incompatible module variants can be indicated.

The product variants created in the product configurator system are displayed here. The product variants can be modified, to form product families for instance. Product families are created by providing a quantity number on the product module row, and then a “take rate” for a module variant. There can be a warning until the take rates sum up to 100%. New product variants can be created manually as well. Creating and/or modifying a product variant in the CT tool can have no support in another party's configurator system and the module system semantic.

The product variant editor 8200 as shown in FIG. 82 includes a “Required by” field, when the product is wanted on the market. Default information in the field is “When available”. It also includes an “Available by” field, according to the module variants. It also includes price (e.g., estimated sales price) input from the configurator system or manually edited. With the tool, annual price erosion reduces the price annually in the module system profitability tool. Cost (e.g., target cost) of the product based on total cost of module variants can also be included. Annual productivity reduces the cost annually in the module system profitability tool, simulating efficiency improvements in production, and can be included. Constrained cell can be used, which can trigger a warning, and the problem can be resolved in another tool. The price can either be set manually or generated when adding the configuration. A result from the CT tool can include a set of product variants connected to module variants (such as a bill of module variants) with an estimated sales price and target cost, including both price erosion and productivity efficiency.

### Profitability Tools of the PAS

FIGS. 83-87 illustrate example profitability tools of the PAS. The GUI 400 can render each tool within the tool area 404 or within a different window or section. The profitability tools include a sales planner (SP) tool, a part number count (PNC) tool, a module variant costing (MVC) tool, a module system costing (MSC) tool, and a module system profitability (MSP) tool.

FIG. 83 illustrates an example GUI for the SP tool, the SP GUI 8300. An example purpose of the sales planner tool is to forecast volumes of product variants and indirectly module variants on a yearly basis and in total. Product variants are reported from tools down the line of the PAS. As shown in the SP GUI 8300, production years is added in the left-hand column (such as a four-digit number). The product variants are available in the white cells. Grey cells indicate that at least one module variant is not available for this year. A user can enter an estimate of sold product variants for each year it is available. In the second column, the user can select which production years that may be included to calculate an average. In the third column, the user can select what may constitute as a base year. It can either be one of the production years or the average in some embodiments. The base year may be used in the downstream tools as annual volume reference. A result from the sales planner tool can include volumes of product variants per production year and overall totals.

FIG. 84 illustrates an example GUI for the PNC tool, the PNC GUI 8400. An example purpose of the part number count tool is to define the complexity cost of a product (e.g., indirect cost). Complexity cost is related to part numbers and volumes. Create product module complexity cost items (e.g., categories of parts) with an assigned cost. Part numbers can either be assigned to individual module variants (such as distributed over their volume) or be assigned to the product module (such as distributed over the module variants within the module). The complexity cost is calculated using the annual volume defined in sales planner tool. A result of the PNC can include a target part number count and calculated complexity cost for each module variant.

FIG. 85 illustrates an example GUI for the MVC tool, the MVC GUI 8500. An example purpose of the module variant costing tool can be to define the direct cost and/or the indirect cost for a module variant. A user can add module direct cost categories. Enter cost data for each category and module variant where applicable. The tool can calculate the total direct cost for each module variant. A total cost per module variant is calculated by adding the direct cost and complexity cost from the PNC. There are also corresponding annual costs calculated based on the annual volume. Results from the module variant costing tool can include direct cost and total cost for each module variant.

FIG. 86 illustrates an example GUI for the MSC tool, the MSC GUI 8600. An example purpose of the module system costing tool can be to define the total cost for a product variant. As shown, the tool can include four tabs. Total is a summary of the other tabs and shows total cost per product variant and annual cost. Complexity Count defines the complexity cost items for product variants. Final Assembly defines the direct cost per product variants. Other cost defines the other costs per product variants. A result from module system costing tool can include the total cost for product variants and annual costs.

FIG. 87 illustrates an example GUI for the MSP tool, the MSP GUI 8700. An example purpose of the module system profitability tool is to understand profitability of the modular product architecture, in total or per year or per product. The tool makes a summation of the cost and price corresponding to the sales planner. The total sum of the cost and price can be presented for each year and product. The corresponding profitability is reported as a percentage. The complexity cost coming from PNC tool can be included or not. The total profitability over products and years can be found at the lower right corner as shown in FIG. 87. Product variants and production years can be toggled on and off to see their impact on the total profitability. The impact of price, price erosion and production efficiency can be understood by changing these values for individual product variants. A result from module system profitability tool can include the total view of estimated cost/price and sales with resulting profitability.

### Supply Chain Tools of the PAS

FIGS. 88-91 illustrate example supply chain tools of the PAS. The GUI 400 can render tool within the tool area 404 or within a different window or section. The supply chain tools include a supply chain structure (SCS) tool and a volume planner (VP) tool.

FIG. 88 illustrates an example GUI for the SCS tool, the summary tab for the SCS GUI 8800. An example purpose of the supply chain structure tool is to evaluate the best supply chain strategy (such as make or buy, supplier profile, order points, assembly stage, etc.) by considering several factors influencing supply chain. The summary tab can show decisions made in the other tabs. This tab can also control which volume data to use. If there are no annual volumes for the module variants (sales planner and configuration table is not populated) the volumes can be forecasted. Volume forecasting can be made from a base volume, and for each product module a quantity and rake rate is given, which are multipliers. This can generate a forecasted volume estimating an annual volume per module. In the shown case, quantity is the average number of product modules per product, and take rate is the percent of products including the product module.

The evaluation can be done on a product module level or technical solution level. A user can double click in the first column at a product module shown, which can expand the technical solutions and place a checkmark to indicate. Quantity and take rate is used at technical solutions and can operate on the product module volume (either the annual volume or forecasted volume).

FIG. 89 illustrates an example GUI for the SCS tool, the make/buy tab for the SCS GUI 8900. The evaluations are separated in four topics: Make/Buy, recommends make (e.g., assembly) or sourcing on product module level; Global/local, recommends supplier profile; Stock/Order, recommends order point; and Pre/Final assembly, recommends assembly stage. These evaluations follow the same logic and are placed in separate tabs. For each module, estimate whether the volume distribution of the module variants is even or uneven. Supply chain driver can be added directly in the tool using the action buttons in the top. The order is given by their weight, and are listed in descending order. The total sum of the weight may be as close to zero as possible. There are two types of drivers, score and +/−. A “+” equal 9 (same as a strong score) and a “−” equals −9. The +/− is used for yes/no scenarios.

The score column can include the product sum for each supply chain driver score and its weight, per row. A result can be colored such as green or blue depending if the score is positive or negative to guide the decision of the strategy. The decision column can include dropdown menus with the different strategies. These can be colored if they correspond to a positive or negative score in some examples. A comment can be added to clarify the decision. This comment can be reported in a product module report.

The SC Driver editor 9000 as shown in FIG. 90 is opened by selecting the button with the same name. It is possible to assign a driver to more than one evaluation in this editor. If a driver is present in several evaluations, it can always show the same scoring wherever it is used. A supply chain driver that is present in more than one evaluations is indicated in the tool with a “*” under the driver as shown. The global supply driver is special because it is the decision from the global/local evaluation. It can be of type +/− and its name and weight can be modified as well as the assignment to evaluation. A result can of the tool can include a recommend supply chain structure or strategy for each module variant.

FIG. 91 illustrates an example GUI for the VP tool, the VP GUI 9100. An example purpose of the volume planner tool is to understand the volume distribution of module variants for production years. A trend can be set for a module variant and the forecast volumes to support negotiations with suppliers or when optimizing production setup. The volume data can be generated from the sales planner and configuration table tools. The volume mix first assigned in supply chain structure can be reevaluated based on the more accurate numbers. By analyzing the volume data for each module variant, it can be assigned a trend: rising, falling, stable, or fluctuating. The volume cannot be modified in this tool in some embodiments, but it can be analyzed. A result of the tool can include a volume trend for each module variant and a volume mix label.

### Status Tool of the PAS

FIGS. 92-93 illustrate an example status tool of the PAS. Status can be accessed in the editor for individual items. The status dialog is accessed from the tool menu in the upper right corner as shown in FIG. 92. The status dialog 9300 as shown in FIG. 93 can be used to set status for tools, item sets, or several items. Status is showed in the tree view.

A user can select the items to set or change status for and select the status level, confirm with apply. Status is applied in a hierarchy: tools followed by item sets followed by items. In some exemplary embodiments, status levels can be independent of each other. In some other embodiments, status levels can have dependencies on each other, such as according to the hierarchy in which that status levels belong.

STATUS LEVELS

| status | item | item set | tool |
|---|---|---|---|
| New | Initial status. | N/A. | N/A. |
| Draft | No limitation. | No limitation. | No limitation. |
| Proposal | item is Read- | item set is Read-only. | tool is Read-only. |
| | only. | All items are at least | All item sets are |
| | | at proposal. | at least at proposal. |
| Confirmed | Only manager | All items are | All item sets are |
| | can change | confirmed. | confirmed. |
| | status. | Only manager can | Only manager can |
| | | change status. | change status. |

### Tasks Tool of the PAS

FIGS. 94-97 illustrate an example tasks tool of the PAS. There are two types of tasks in some embodiments: data quality and change request tasks. Tasks can be applied on items, item sets, tools and sub-items, in any combination. The existence of a task is identified by an icon whenever it is applicable.

| E.g., Icon | Task type |
|---|---|
| Red flag | High priority, Data Quality task |
| Yellow flag | Medium priority, Data Quality task |
| Grey flag | Low priority, Data Quality task |
| Lightning bold | Change Request task |
| Green checkmark | Completed task, Data Quality or Change Request task |

Data Quality tasks relate to the quality of the information to improve the definition of the module system. For instance, this can be regarding the phrasing of an item name. Pointing out a missing description or question the scoring in a tool. These are typically created by a module system manager and assigned to a team member using the PAS.

Change request tasks are proposed changes to modify the module system in some way. For instance, this can be a request to add new goal values, add new module variants or change a technical solution of a function are typically created by someone reviewing the module system from marketing or technical perspective, a reviewer, and the task is assigned to a module system manager.

### Task State Schema

| | Originator | Assignee |
|---|---|---|
| | Creating tasks | Processing tasks |
| To Act On | Task is not fully defined. | Task is assigned and waiting |
| | -OR- | to be acted on. |
| | Assignee have added | -OR- |
| | conclusion and is finished. | New message or other change |
| | | by Originator. |
| In | Assignee has added messages | Assignee has added messages |
| Progress | but is not finished. | but is not finished. |
| Done | Task is assigned and waiting | Assignee have added |
| | to be acted on. | conclusion and is finished. |
| | -OR- | |
| | New message or other change | |
| | by Originator. | |
| Completed | Task is confirmed completed | Task is confirmed completed |
| | by the originator. | by the originator. |

Tasks are given a task ID, these identifiers can have the prefix CR or DQ and a number (e.g., DQ01 or CR01). The number of digits shown is controlled by the code setting number of index digits in module system properties. The task ID can show as CRXX until it is saved the first time and the task ID is generated.

The tasks tab GUI 9400 as shown in FIG. 94 in the navigator can show tasks when a user is an originator or assignee for the task. Tasks can be organized into four sections. This can look different depending of the role the user has for the specific task. If there is at least one task in the “to act on” section when a user opens a module system this tab can be shown by default.

The item set editor 9500 as shown in FIG. 95 can display tasks, independent of user role and a task state, by selecting “Tasks” from the dropdown menu.

There can be two different task editors, and the two editors manage the same information but have different layouts. The first task editor is shown in a vertical separate window in FIG. 95. This editor can be used when a task is selected in the tasks tab or from a task indication icon on an item. The second task editor is in the editor area with a horizontal layout and is used to display tasks when selected in the item set editor. Both editors can show the task that is selected.

The functions in the task editor can be dependent on the role of the user and the state of the task. In some embodiments, it is not possible to show two tasks at the same time since they can show in the same task editor window.

A task is created by first selecting what the task may apply to and then launch the task editor by clicking the task icon, which is in the top right corner (in either the tool window or editor as shown in FIG. 96).

A user can then describe the scope of the task, this can be shown as a title in the navigator GUI 9700. The user can select type of task, data quality or change request. Task type cannot be changed once the task is stored on the server in some embodiments. The “role” of the user specifies what type of tasks that can be created. The user also sets priority for data quality tasks, and can select a user to assign the task to.

The role of the users specifies what type of tasks that they can be assigned. A user can add a message describing what may be done. Messages from the originator are indicative thereof, such as with a color such as green. The “Applies to” area manages what PAS data the task is associated with.

To open the item, it can be done by double click on the row. Add new items by selecting it in the PAS and then click “+”. Remove items by selecting the row and click “−”.

The originator can confirm the task as completed by selecting checking confirm as completed and select submit. A completed task cannot be modified in exemplary embodiments. The originator can delete the task permanently by clicking delete task.

When the task is fully defined, and submitted, the user can close the editor window and register the task on the server by saving the module system, which can generate a task ID. Once the task is stored on the server the email button can generate an email to the assignee (e.g., receiver of the task).

In responding to a task, when opening a module system and there is a task waiting to be acted on the tasks tab can be shown. Alternatively, if the module system is already open a “Refresh” can bring any new tasks into the session. Click the task and it can open in the task editor window GUI 9800 as shown in FIG. 98. When analyzing the items in the “Applies to” section they can be opened by a double click. The assignee can give a message that the task is received and understood (or add follow up questions) in the “Enter text” area. A user can select “submit” to add the message to the log. This message can be colored blue and indented to highlight the conversation flow.

When the assignee considers the task to be completed it may be sent to the originator for confirmation, and this can be done by first checking “completed” and then selecting “submit”. A conclusion can be provided in the enter text area when submitting a completed task. Depending on how the originator agrees with the provided conclusion, the task can either be confirmed as completed or there can be a new message from the originator activating the task again.

The email button can generate an email to the originator once the task is stored on the server.

### Goal Value Fulfillment of the PAS

FIGS. 98-105 illustrate an example goal value fulfillment tool of the PAS. Goal value fulfillment can relate to securing the fulfillment of the requested module variants and performance levels expressed by the product properties. Both the technical aspect and the timing can be monitored. Timing is expressed in launch waves and is provided with a marketing and sales driven perspective. This is provided on individual goal values of the product properties, at specific module variants and may also be defined on product variants. Technical performance is expressed as goal values of product properties, these are defined by looking at what have been accomplished in the past and looking at competitors. The performance of the future product range may in most cases be outstanding compared to the current product range, but feasible within the time limits when it may be offered and at last, to a cost that make the products profitable.

Specifying a module variant 6601 can combine several goal values from different product properties, which individually may be feasible, but the combination of these may interfere in way that the module variant cannot be launched as requested or maybe difficult to design. This can be the scope of goal value fulfillment. This functionality can be split over several different areas and tools in PAS but can be initiated in the module variant editor 6600 as shown in FIG. 66.

A user can define a goal value fulfillment issue. There are two ways to open the goal value fulfillment editor 9800 as shown in FIG. 98, both ways can be accessed from the module variant editor 6600. A user can start with deciding what module variant to analyze. In some embodiments, a user can do one of the following: double click in the “!” column (shown just to the left of the matrix); or select one of the cells connecting to a product property to show the relation editor, and then click on goal value fulfillment button. This can also be accessed from the MVS tool. When the goal value fulfillment editor is launched, it relates to the module variant from where it was launched.

A user can define what triggers the goal value fulfillment issue, and what product property goal values in combination can make this module variant to require some special actions before it can be released. The user can click the select criteria button to launch the dialogue GUI for assignment of critical criteria 9900 as shown in FIG. 99. Check the product properties that are applicable. The user can then describe in words, in the reasons text field, why this module variant can require special actions when combining the product property goal values assigned.

A user can add the actions that are required to secure the fulfillment of module variant specification, and can use action buttons to add, delete or reorder actions. For each action, the user can define the method to categorize the action, describe the action under description, and who is responsible for the action under the responsible field. A user can also indicate at what state the action is in, and if there is a document that describes more details about the action. Both method and state options are predefined, and the options can be unique for each module system and can be edited from the item set editor. State and document can be revisited as actions proceed.

The last part of the goal value fulfillment is to estimate when the actions can be finished to release the module variant. This is done by selecting a launch wave from the “estimated launch wave when goal values can be fulfilled” dropdown. In some case the goal values are impossible to meet, in that case select “goal values not feasible”. If the estimated launch wave is later than the planned launch wave, the module variant can get a delayed status indicated such as by a yellow ball. If the estimated launch wave is the same or earlier than the planned launch wave, the status can be on time and indicated such as by a green ball. If the module variant is not feasible, the status can be “Not Feasible” and indicated such as with a red ball.

A use can also identify a goal value fulfillment issue. Once the goal value fulfillment issue is documented, the status of it can be shown next to the module variant in the module variant editor 6600. The product properties being the criteria can also get a goal value fulfillment status. This can be the most severe status if there are other module variants triggering this. By checking fulfillment status 6604 as shown in FIG. 100 the table can be colored according to the status. This can help analyze which module variants or goal values have issues to be changed. This function is also available in the MVS GUI 6500 by checking fulfillment status 6504 as shown in FIG. 101, where it can give a complete view of the fulfillment status of the module system. When selecting a product, property relating to a goal value fulfillment issue, the most severe status is shown in the editor by a status ball in the GV fulfillment button, as shown in FIG. 102. Select the GV fulfillment button to explore the status of goal values. Each module variant can include a goal value fulfillment issue that can be listed for each goal value, with its status and the actions defined to meet the specification. Selection of a module variant to open the goal value fulfillment editor 10300 as shown in FIGS. 103 and 104. The explorer can be viewed in a tree 10302 or table layout 10304, and a user can switch layout with the button in the top right corner 10306.

A user can also act on goal value fulfillment issues. For delayed module variants, the MVP GUI 6900 may be revisited. As shown in FIG. 105, a warning dialog 10502 is provided alerting the user that a selected launch wave is too early to fulfill goal values for module variant. A user can check if it is possible to reschedule without impacting other market requests. As shown, it might be possible to reschedule M05:00 to a later launch wave, since the currently select launch wave conflicts with the goal value fulfillment. In such an example, there can be no part available until the second wave. For module variants that are not feasible, something can be changed. Maybe another specification of the module variant, that is less extreme. Or maybe change the product property goal value itself to a more moderate level, which is easier to fulfill, especially if there are many module variants that are not feasible due to it. A formal change request task can be a good practice to document such proposals.

### Exemplary Reports Tool of the PAS

FIGS. 106-112 illustrate parts of an exemplary reports tool of the PAS. The information created in PAS can be reported in various formats, such as PDF and MICROSOFT OFFICE formats. A user can select report/item reports to launch the item reports dialogue 10600 as shown in FIG. 106. The reports can include the base information for an item. Each item set can be reported on a separate tab. Items can be reported on an items set basis.

A user can also select report/tool reports to launch the tools reports dialogue 10700 as shown in FIG. 107. Each tool can be created on a separate tab. Some tools have sub-tools, and if so the dialogue can be expanded to select individual sub-tools. For graph reports, the user can select report/graph reports to launch the graph reports dialogue 10800 as shown in FIG. 108. Each graph can be created on a separate tab. The graphs are generated by a macro from data tabs that are hidden. The graphs can be manipulated and customized once they are in the expected format, the source data be accessed by showing the hidden tabs.

For system reports, a user can select report/system report to open the module system report dialogue 10900 as shown in FIG. 109. There are three system reports that can be made from this tool. System status lists items sets and how their items are distributed over the different status levels and a combined completion metric. Full PMM which combines the SR, CVR, QFD, PB, DPE, PA, DPM, MIM, MG, and MDM tools. Basic PMM, is a shorter version of the full PMM, combining the QFD, DPM, MIM, and MDM tools. Configuration PAP combines the CT, MVC, MVP, and MSC tools together with a special top matrix which displays the goal values for a product variant.

For the module variant map a user can select report/module variant map to open the module variant map dialogue 11000 as shown in FIG. 110. The user can then select the product modules to map, the can list module variants within a product module and the product properties related to the module with specified goal values. A product module can be reported in a separate tab. For a module system report, the use can select report/module system report to generate the report. For a module report, the user can select report/module report to launch the module report dialogue 11100 as show in FIG. 111. For interface reports, the user can select report/interface report to launch the interface report dialogue 11200 as show in FIG. 112. A user can also select report/Filtered PMM to generate a filtered PPM report similar to the PMM and making use of data captured from SR, CVR, QFD, PB, DPE, PA, DPM, MIM, MG, and MDM tools. The differences are that this report filters the PMM based on a seed, anything relating to the seed (e.g., it can be one or several items/relations) are kept in the PMM. This report improves the understanding of relationships of items over these tools. To use this function something (such as a module, item, or items set) needs to be selected first in some embodiments.

### Exemplary Import Manager of the PAS

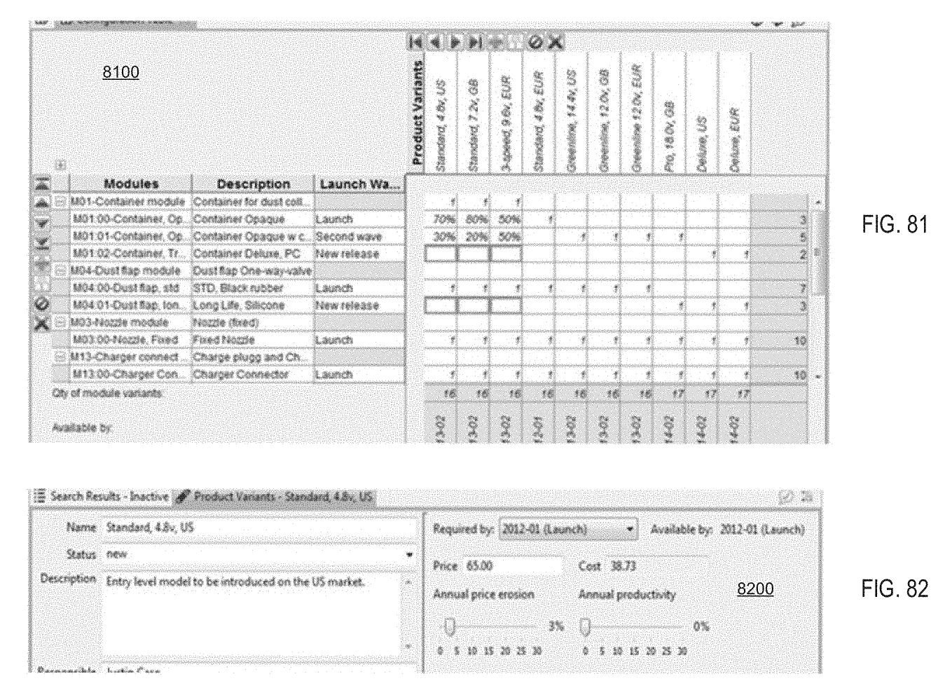

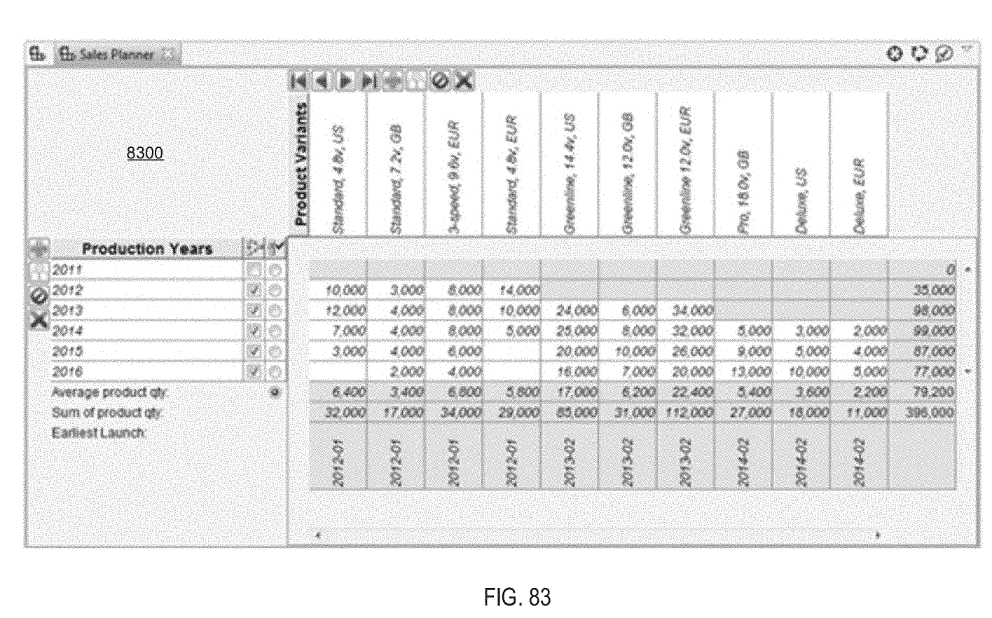

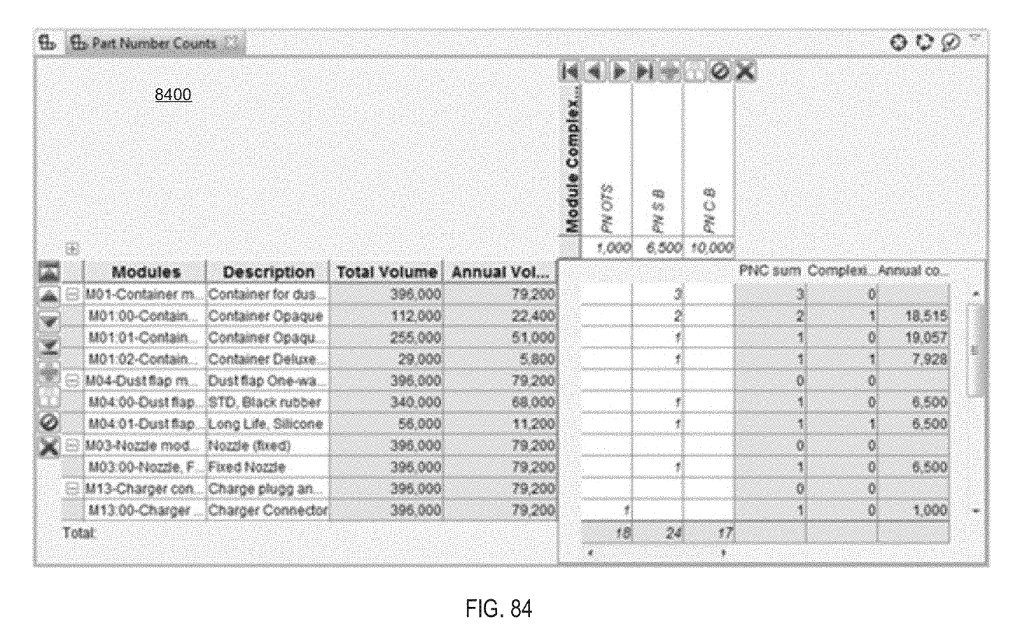

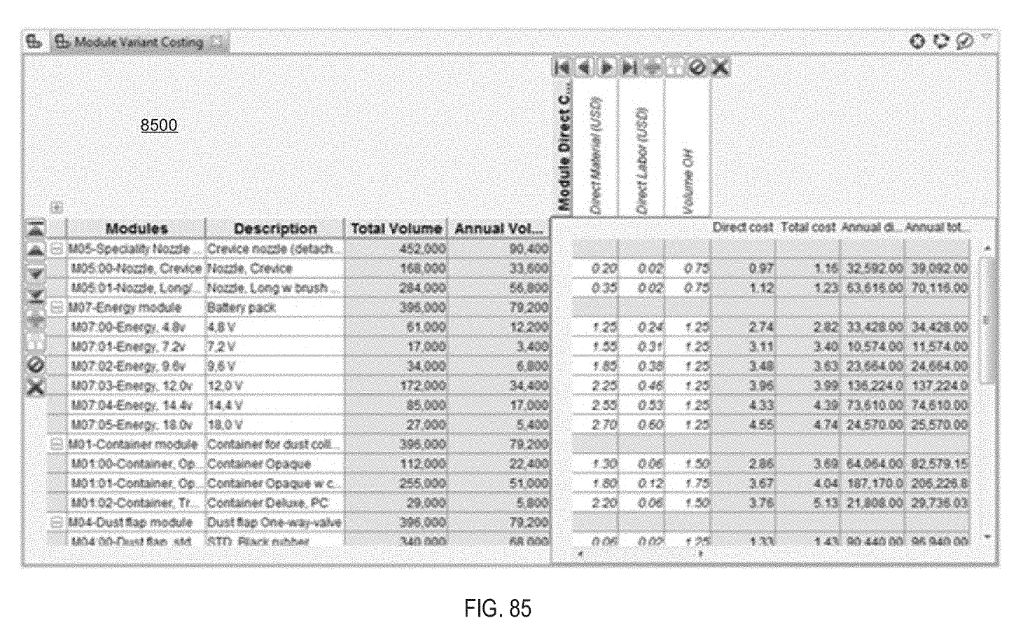

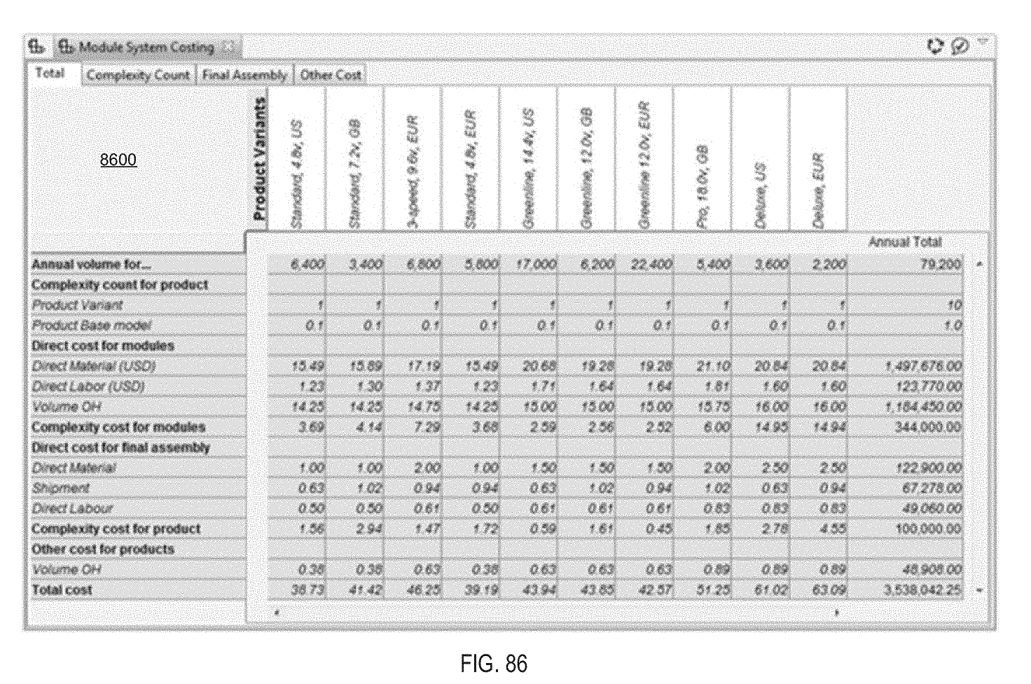

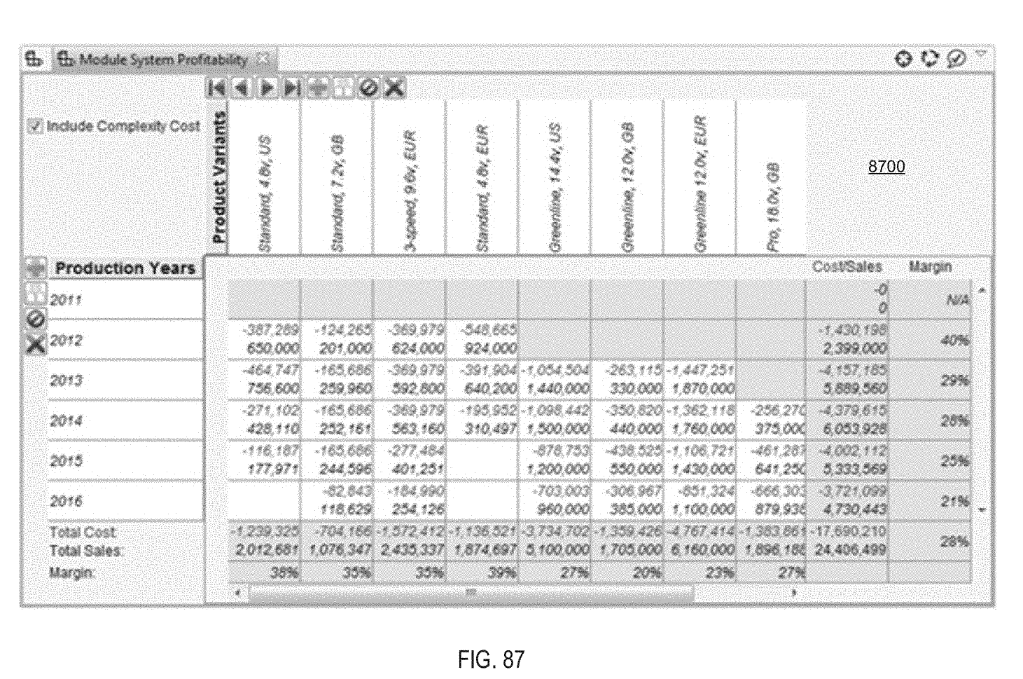

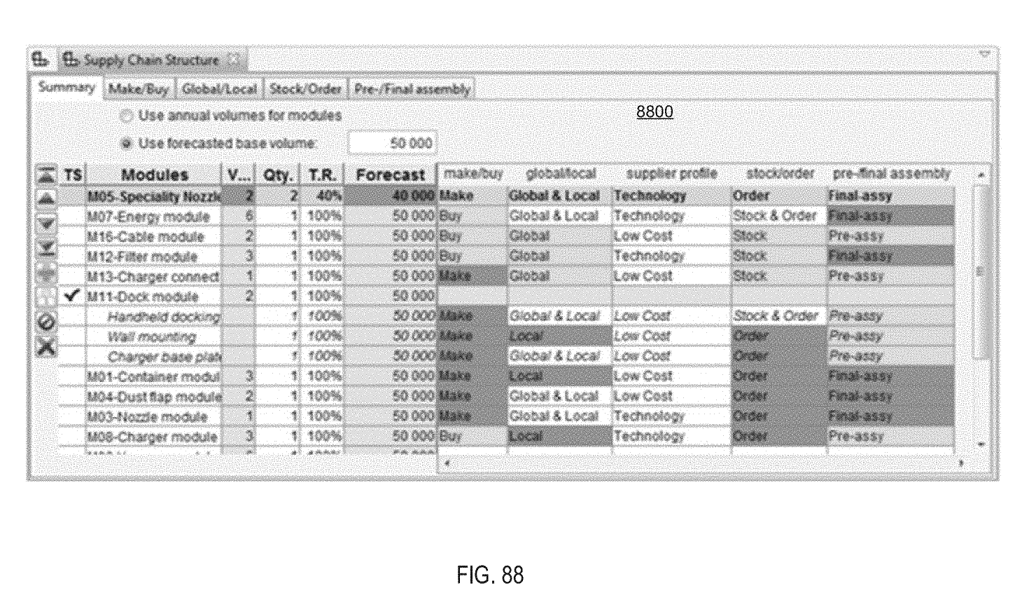

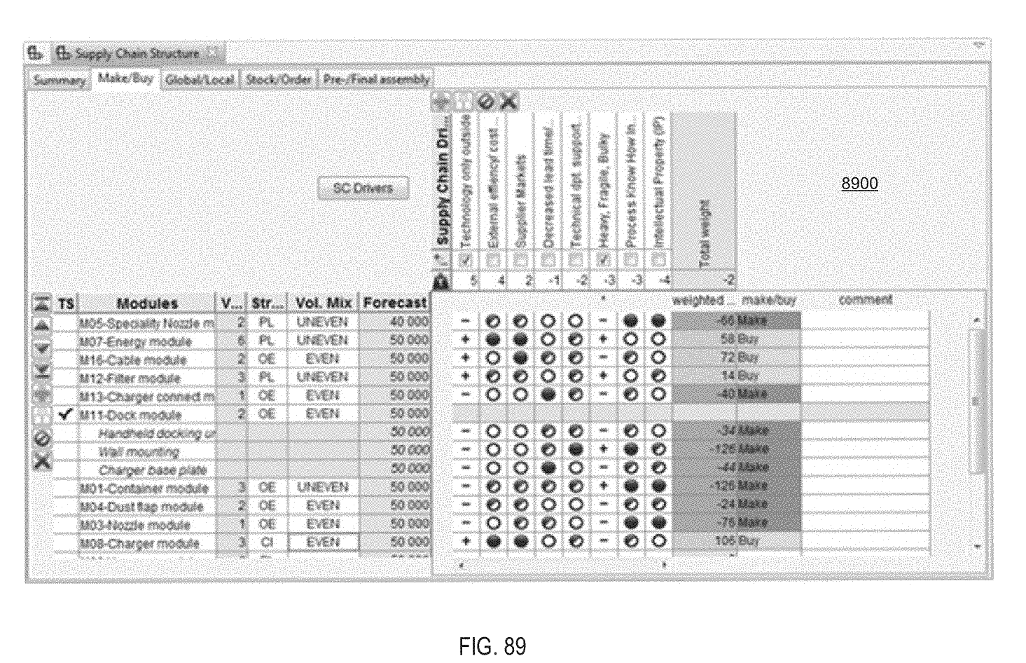

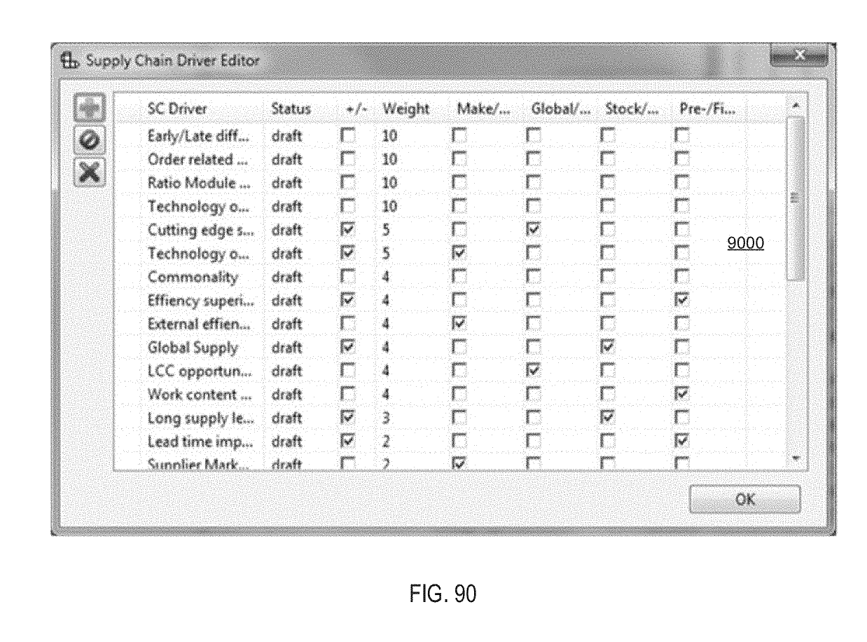

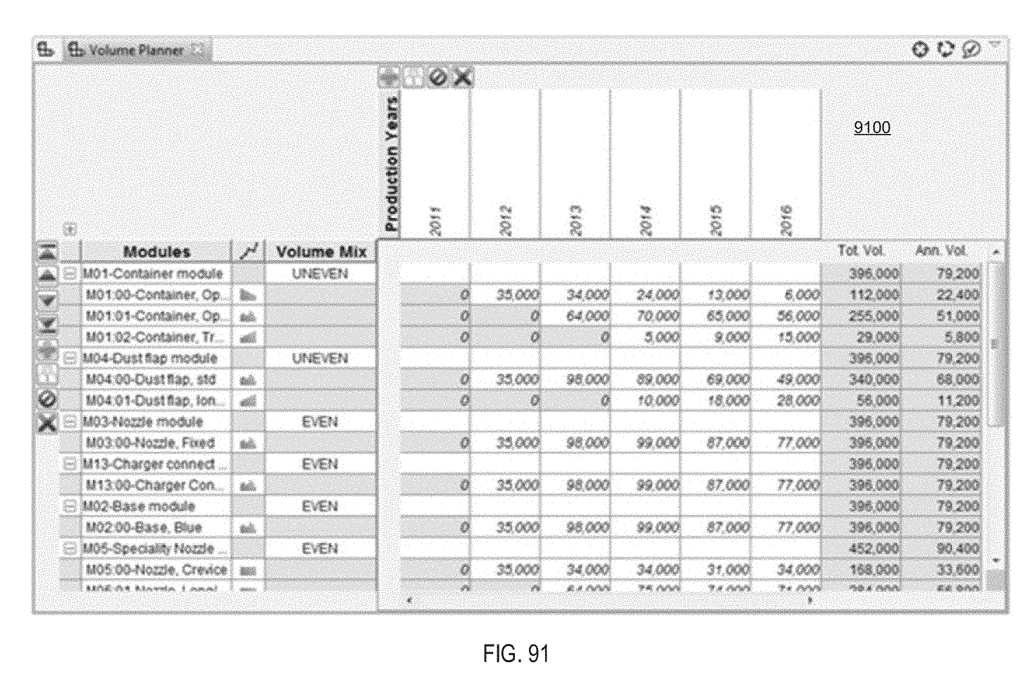

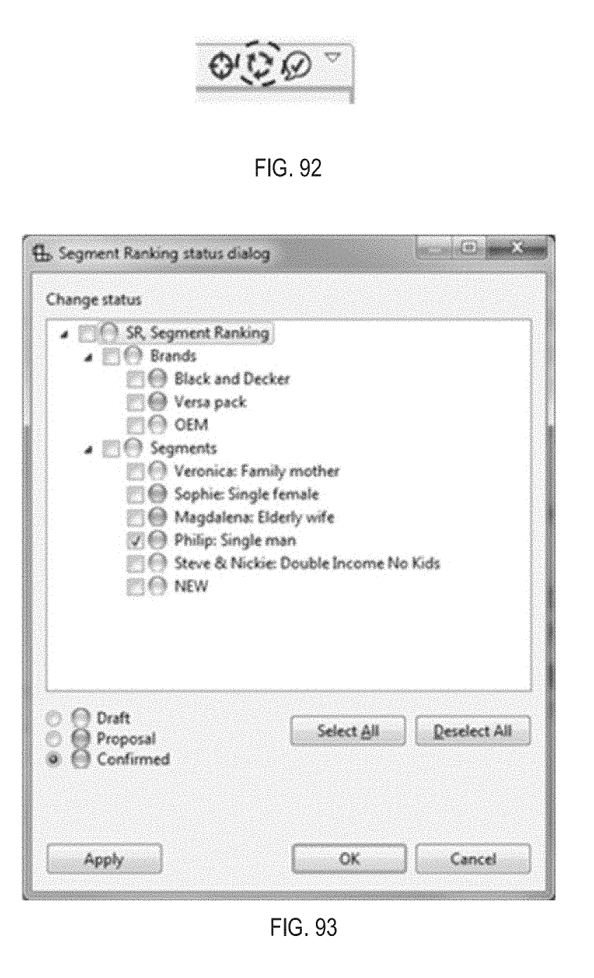

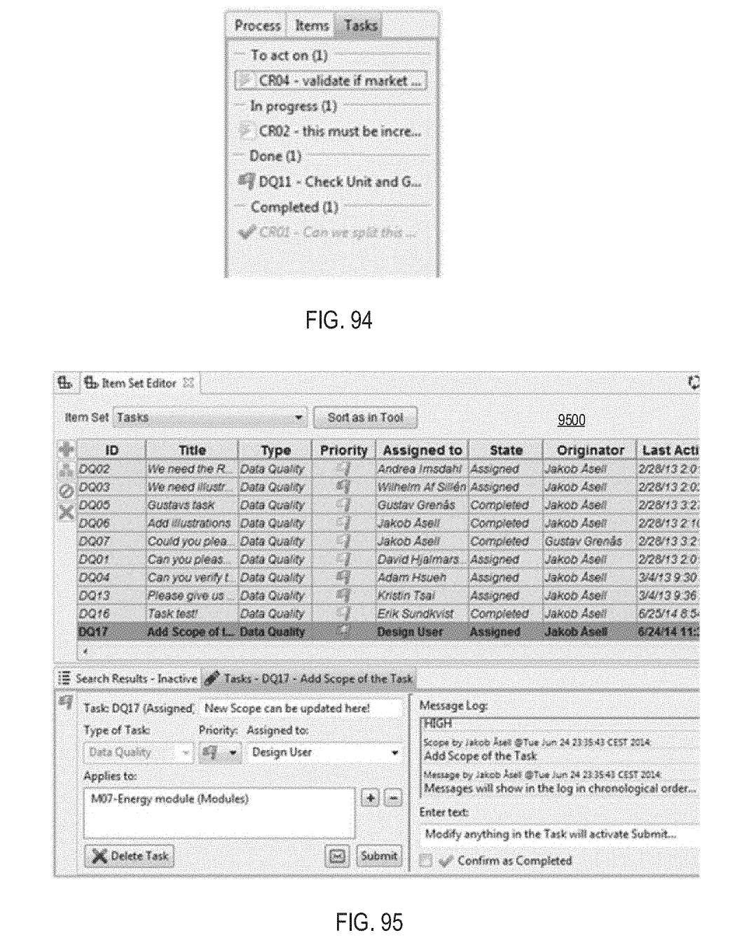

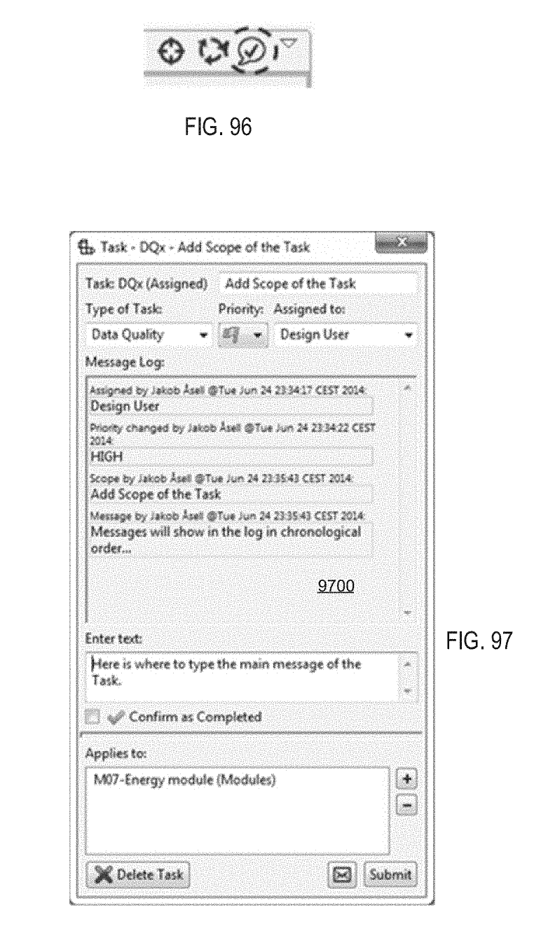

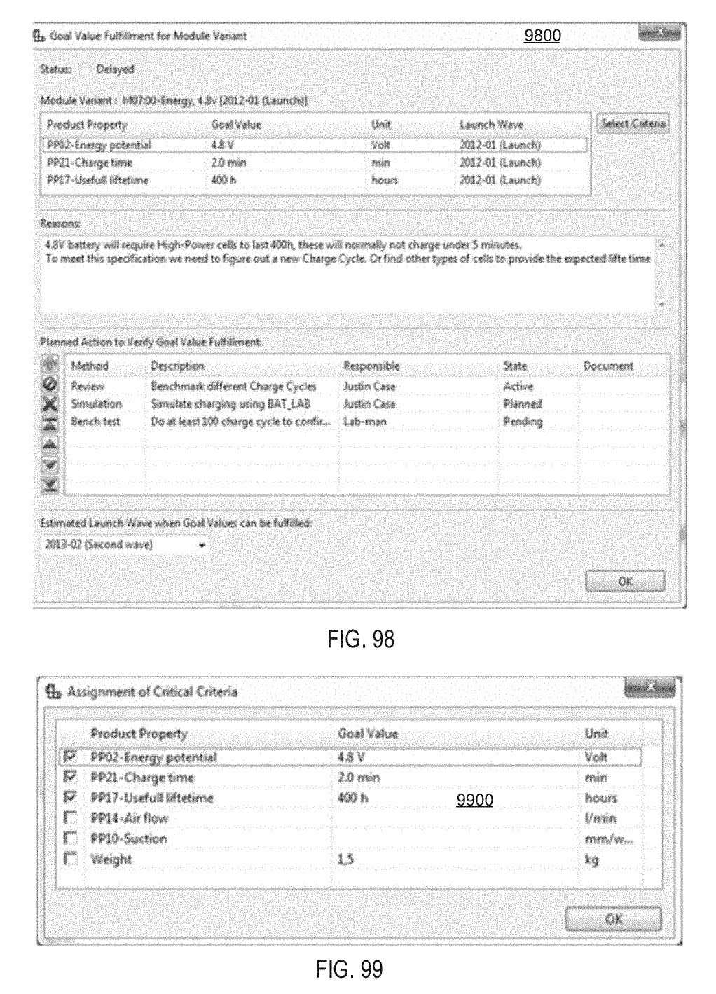

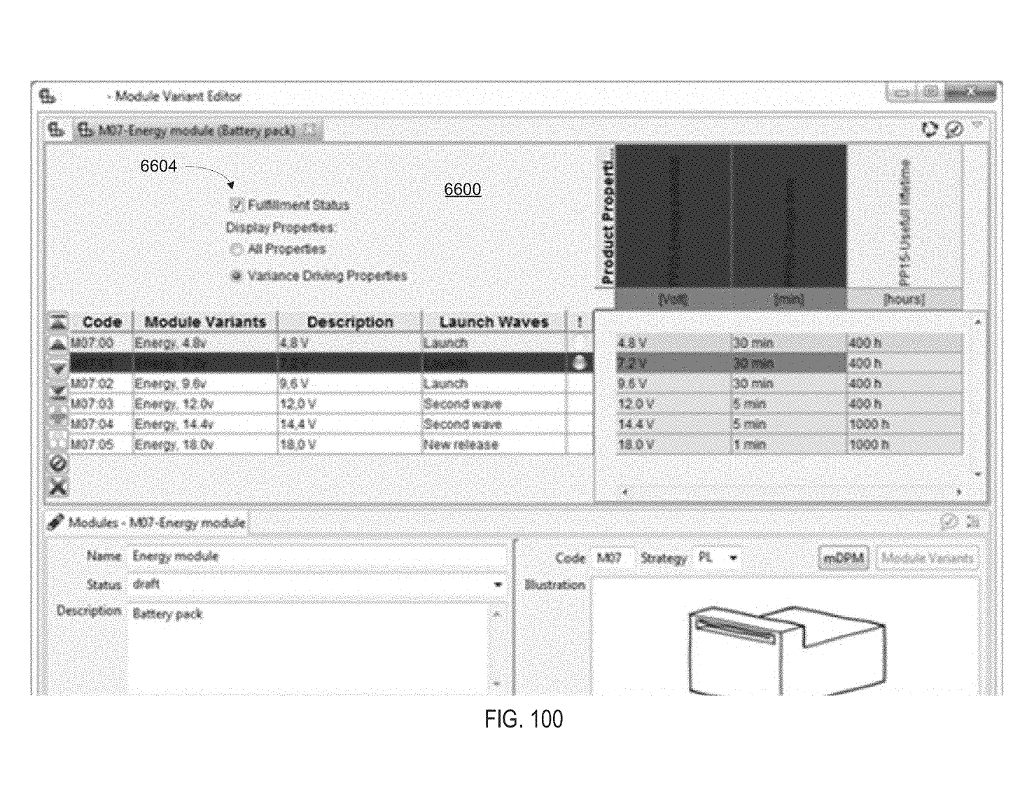

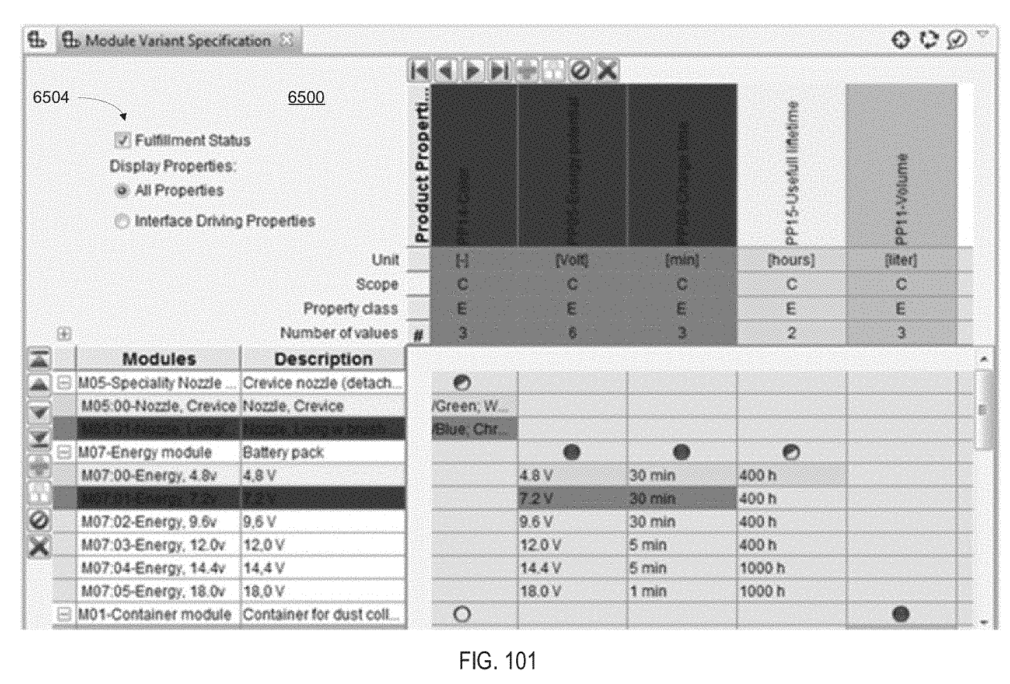

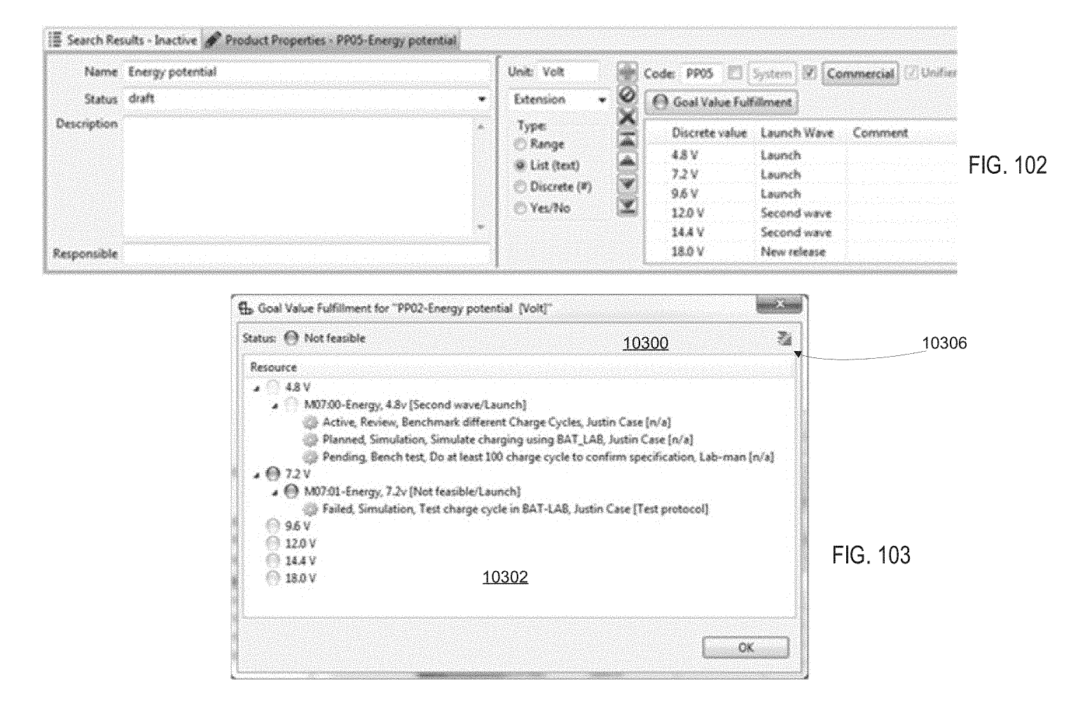

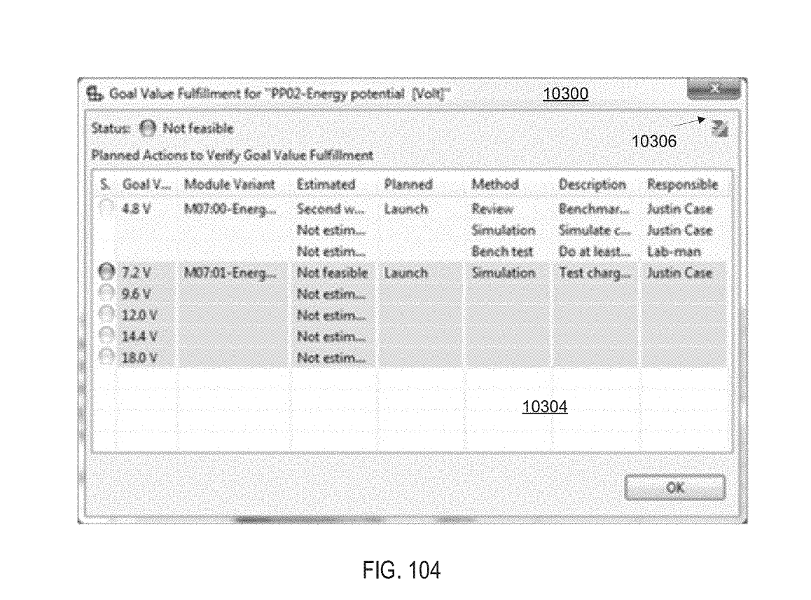

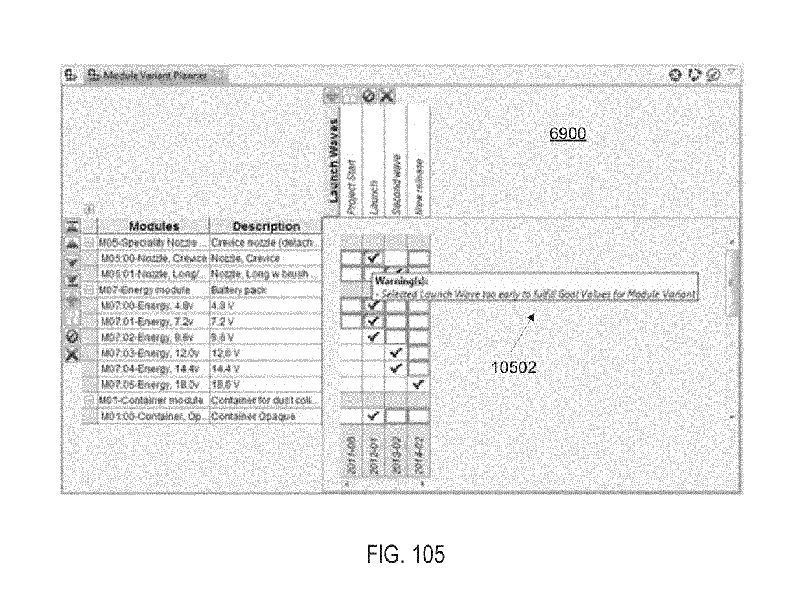

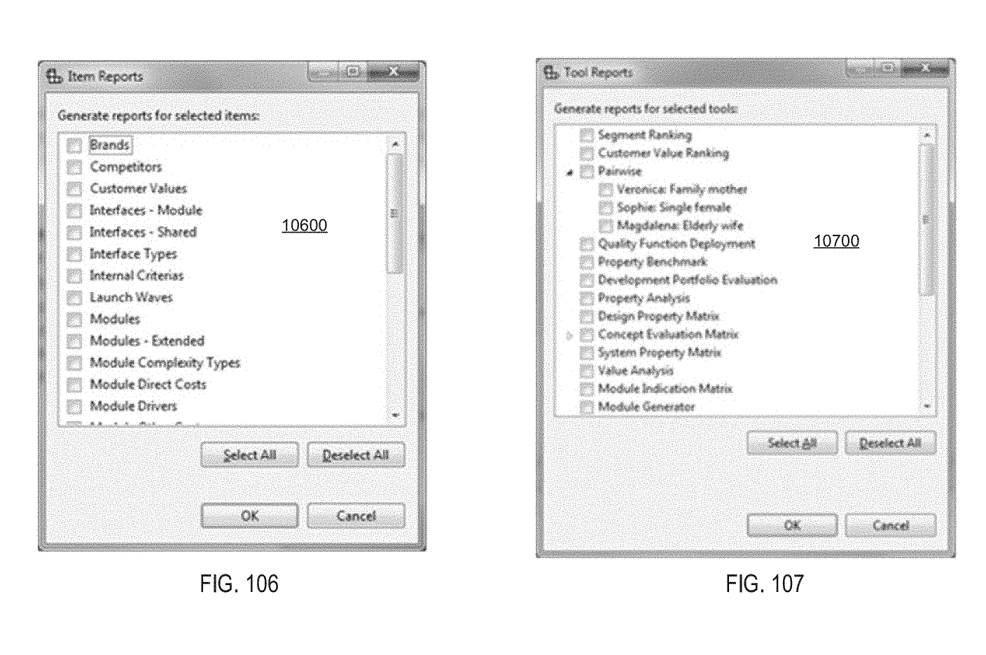

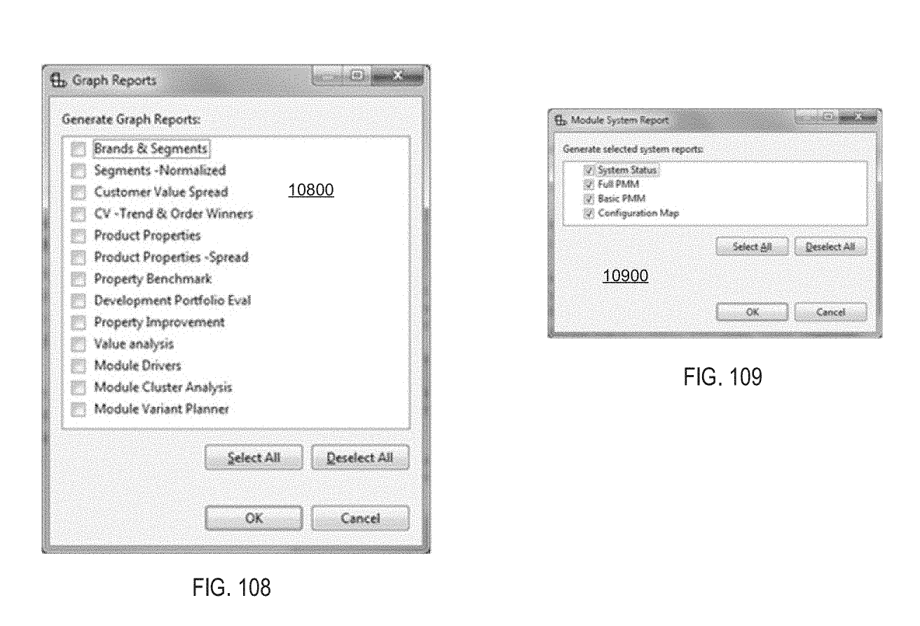

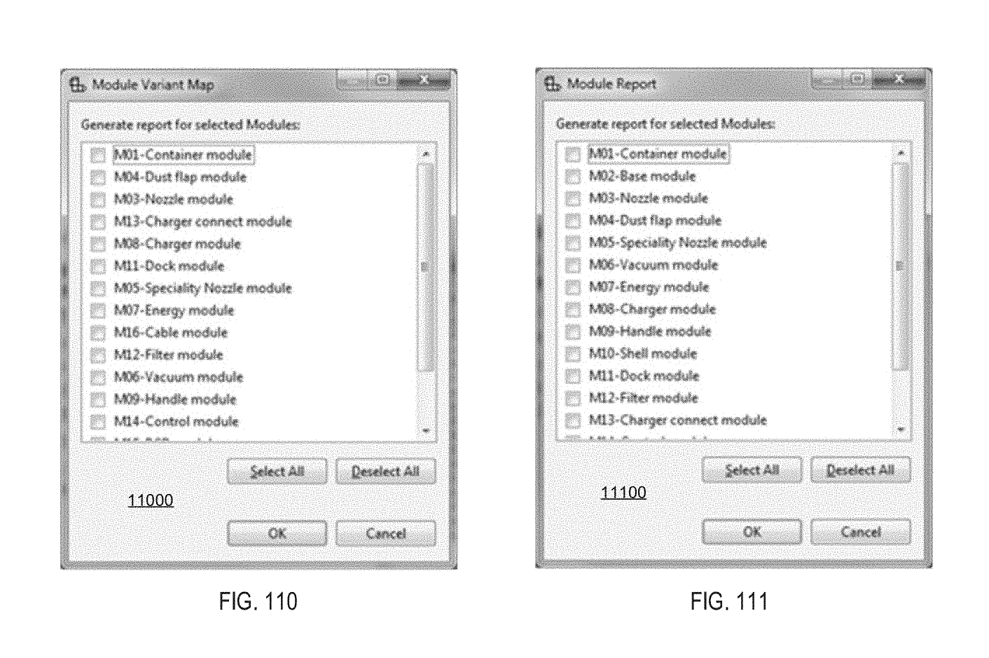

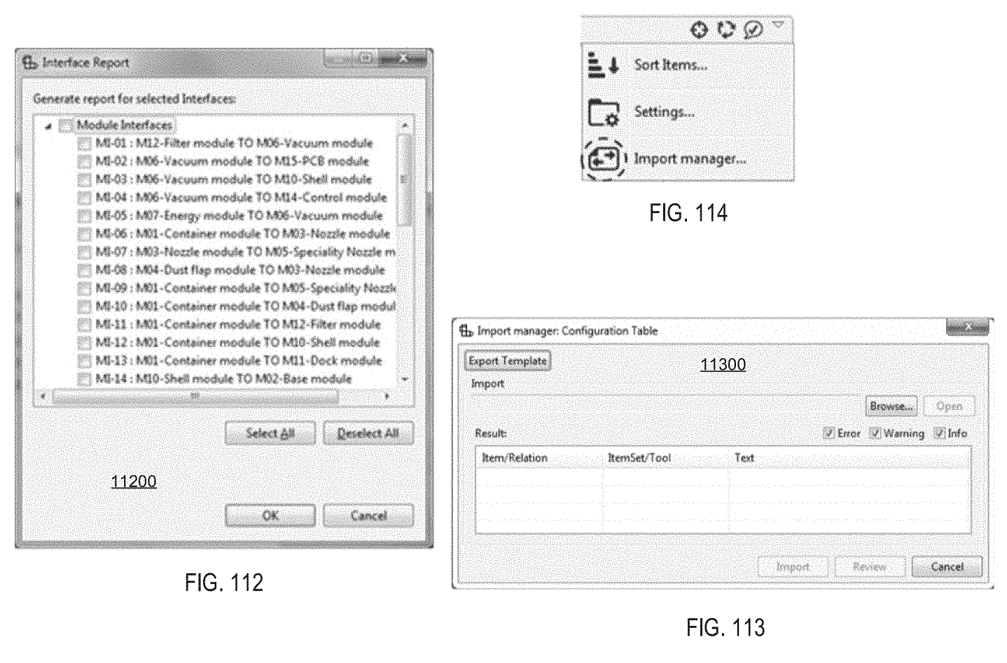

FIGS. 113-114 illustrate parts of an exemplary import manager tool of the PAS. The import manager 11300, as shown in FIG. 113, is found in the tool dropdown menu (located in the top right corner of the tool area), as show in FIG. 114. Certain tools can have this functionality, such as the module variant editor—MVE (as a sub-tool of MVS), the system property editor—SPE (as a sub-tool of SPM), the commercial property editor—CPE (as a sub-tool of COM), the configuration table—CT, module variant costing—MVC, and module system costing—MSC.

The import can be made using a compatible template from the PAS which is generated using the export template. The import file can be edited directly or by copy/paste information from other files of similar format. Once the import file is modified and saved it can be imported back to the PAS. The file does not need to be closed before the import, just saved in the PAS.

The user can select the file to import, by default the exported file is automatically selected as the import file. Select open to read the file into the PAS. Once the file has been opened the button can change name to refresh (such as if a new file is selected it can go back to open).

The PAS can analyze and verify the content of the file and inform the user if the content is consistent with the database, and include any kind of warnings or included errors.

A user or the PAS can analyze a result from the import file. The result is listed in the import manager. It can be filtered to show any combinations of errors, warnings or information. In some embodiments, if changes are made to the file because of the above analysis it can be refreshed. This can require a new file import in some embodiments.

A user can select review to copy results to the search results editor and hide the import manager. The standard search result functionality can apply here. The user can examine errors and warnings. Resolve unintended issues by modifications in the PAS or in the file.

A user can also reopen the import manager and select refresh to reanalyze the import file. When the imported information is free from errors the import button can be activated. If a result is analyzed and intended, the modifications can be brought into the database by selecting import. Selecting “cancel” in the import manager can reset the inputs and close it.

### Capturing the Configuration Profile

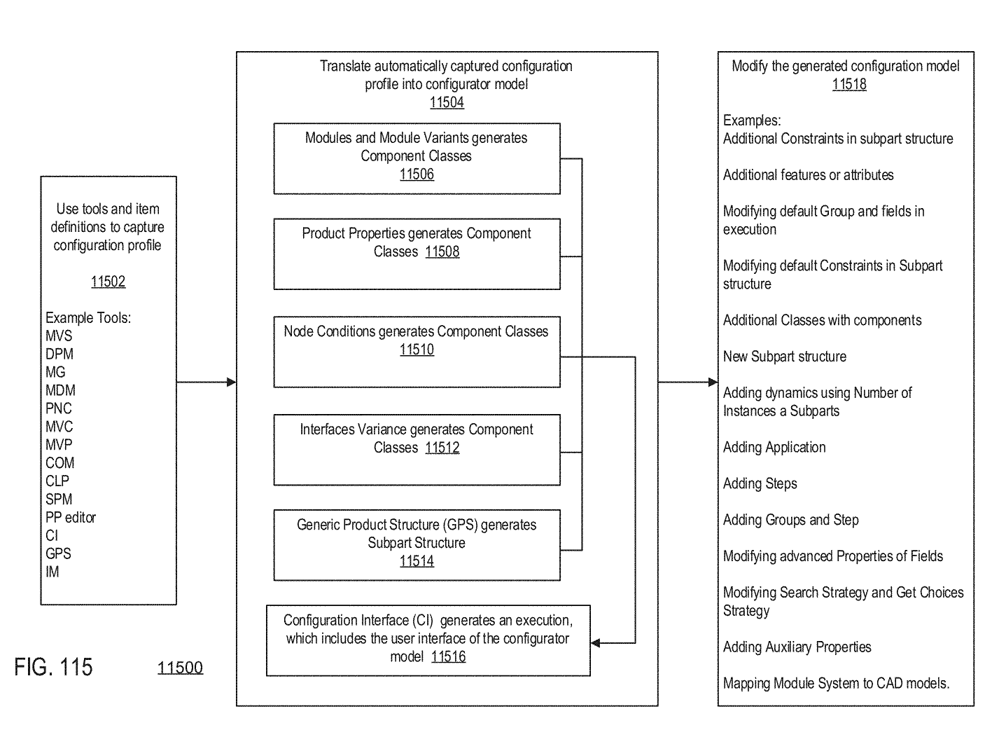

FIG. 115 illustrates example operations 11500 for capturing the configuration profile using tools of the PAS.

PAS can capture the configuration profile of the module system through several tools and item definitions and translate that automatically in to a configurator model. First, the tools described herein and associated items and items sets are used to capture configuration profile at 11502. Then, the configuration profile is translated automatically into a configurator model at 11504. Below is a table showing tools that generate the input for the configurator model.

TOOLS THAT GENERATE INPUT
FOR THE CONFIGURATOR MODEL

| tool | PAS Content |
|---|---|
| MVS | Module variants and specifications for related product properties |
| DPM | Connection between technical solutions and product properties |
| | defining them. |
| MG | Grouping of technical solutions into product modules. |
| MDM | Set module drivers characterizing the module |
| PNC | Define complexity costs (e.g., indirect costs), such as relating to |
| | part numbers and volumes. |
| MVC | Definitions of target cost for a module variant as a sum of |
| | complexity cost and the direct cost and/or the indirect cost for a |
| | module variant. |
| MVP | Assigned launch wave of module variants. |
| COM | Definition of commercial properties and pricing of these using a |
| | fixed option price and a calculated price formula. |
| CLP | Assigned launch wave of commercial properties. |
| SPM | Relations between product properties at system level |
| PP | Definition of PP type, goal values and unifying scope. |
| editor | |
| CI | Tabs, field groups and fields |
| GPS | Generic product structure with quantity definitions and node |
| | conditions. |
| IM | Interface variance between product modules (implicit interface |
| | variance at module variant level) |

The PAS can create tags where it is applicable to identify items that belong to the PAS, either as auxiliary properties or comments in the configurator system.

In the translation of the captured configuration profile into the configurator model, the product modules and module variants of the PAS generate component classes at 11506.

In the translation of the captured configuration profile into the configurator model, product properties generate component classes at 11508.

If module variants utilize several interfaces that needs to be support these are combined as one component or part.

In the translation of the captured configuration profile into the configurator model, generic product structure (GPS) generates subpart structure at 11514.

The subpart structure has a hierarchical structure of subparts, and for a subpart, a set of constraints and attributes to support these constraints.

The hierarchical structure of subparts includes a root part that is generated with the module system name. It also includes a first subpart that includes the named node structure, it can also include a tree with subparts for a node in the node structure. End nodes are realized by their module class. The tree includes additional subparts for node conditions realized by its condition class. Also, included is a second subpart that are for commercial constraints, it can include a flat list of subparts realizing commercial properties. Also, a third subpart for system constraints that can include a flat list of subparts of system properties.

The hierarchical structure can also include constraints controlling the subparts. Constraints can be generated at three levels: top level (a root level), for global rules; at a part representing a node with a condition; and at a subpart of the commercial constraints.

Each subpart can have a list of attributes. First any features of the class realizing the subpart can be include as attributes. Secondly, PAS can specifically create any attribute that is part of a constraint so that it can be selected at this level from the user interface.

With root constraints there can be three sections of rules of this level: PAS Default—constraints to calculate feedback; Global Unifiers—constraints for product properties with a scope unifier; and interface variance—constraints for a product module interface. The default constraint for a total price can make a sum of prices for subparts.

Conditional constraints are at nodes with conditions.

The price constraints at subparts of commercial constraints. There are two constraints, where of one is edited if a calculated price formula is used. Selecting the constraint calculated price can show the CPP usage text, defined in the commercial offering (COM) tool in PAS, in the comments area. This text needs to be translated into a constraint. Default CPP is multiplied with zero, and in practice CPP cannot be used until this formula is updated. The second constraint is to make a sum for the option price by adding a set price and a calculated price.

Finally, with respect to the translation of the captured configuration profile into the configurator model, configuration interface generates an execution (one or more executables such as one or more executable files), which includes the user interface of the configurator system at 11516.

The configuration interface tool can include a set of tabs with fields and field groups. These are placed in a single step application in the configurator system.

After the generation of the model, via the configurator system, a user can modify the generated configuration model at 11518. The configuration model can be modified for various reasons. Most common reason for doing this is to take advantage of some of the native configurator constraints not accessible from PAS. To Modify the model, it can be exported, secondly it can be opened in the configurator system. After modifications are made (which can be made automatically by the PAS), the configurator model can be imported back into PAS and saved with enhancements from the configurator system.

FIG. 115A also illustrates example operations 11500A for capturing a configuration profile using tools of PAS. The operations 11500A begin with defining product modules and module variants using the MVS tool, at 11502A. Also, product properties and goal values are defined using the MVS tool. At 11504A, the operations include specifying, with the MVS tool, product modules with product properties and product module variants with goal values. At 11506A, the operations include defining, with the GPS tool, a generic product structure including use of the product modules by the product. At 11508A, the operations include defining, with the GPS tool, conditions to select valid module variants. At 11510A, the operations include defining, with the SPM tool, system properties that control product properties of the product. At 11512A, the operations include defining, with the COM tool, commercial properties that can drive price of the product. In some examples, the outputted information of the MVS tool can be the input for the GPS tool, the output of the of the GPS tool can be the input for the SPM tool, and the output of the SPM tool can be the input for the COM tool.

The operations 11500A can continue with defining, with the CI tool, a user interface with parameters for feedback and interaction with the aforesaid information of operations 11500, at 11514A. At 11516A, a configuration profile is collected and generated using the CI tool (such as based on the information collected and derived at operation 11514A). The CI tool can also use the output of the MVS, GPS, SPM, and COM tools as input to generate the configuration profile. At 11518A, using the CI tool and/or a configurator system (such as a configurator internal or external to the PAS), the operations include generating a configuration model based on the configuration profile. At 11520A, a configurator system, such as the CFG tool or a configurator system external to the PAS, can execute the configuration model. Further, at 11522A, the configuration model can be interacted with via the CFG tool or an external configurator system. At 11524A, the CFG tool can also store the configuration model and/or profile in memory of the PAS.

### Adding Illustrations in the PAS

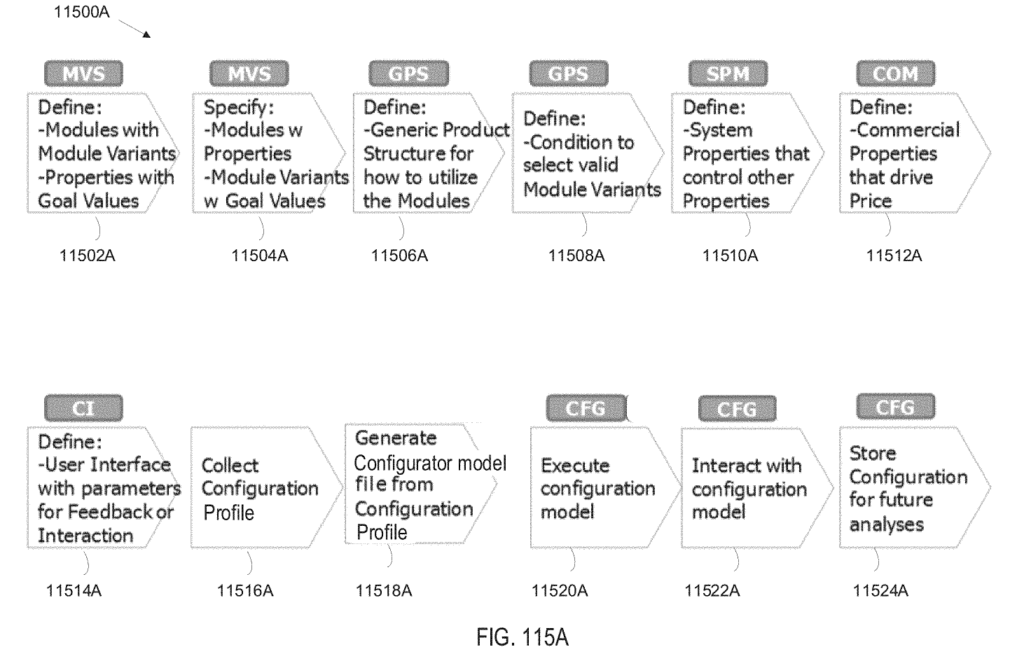

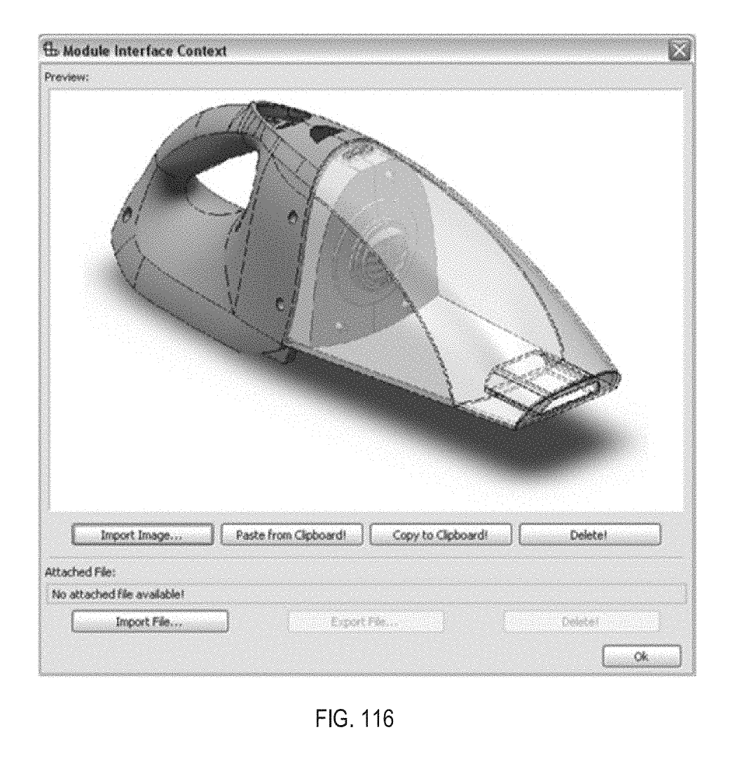

FIG. 116 illustrates an example GUI of the PAS for adding illustrations to the system. When adding a picture, it can be done using the clipboard or a file. Note that the quality of the clipboard image can vary depending on the source. In some embodiments, when a module system is opened, data is loaded except illustrations. When data is loaded, the module system is opened in PAS. Then, the PAS starts a background activity to load illustrations.

What is claimed is:

1. A system, comprising:
a processor; and
instructions stored in memory executable by the processor, the instructions including:
goal values, the goal values including a controlling goal value that controls at least one controlled goal value;
product properties,
each of the product properties including at least one of the goal values, and
the product properties including a unifying property that unifies at least one product property;
product modules, each of the product modules being associated with at least one of the product properties;
module variants, each of the module variants specified by at least one of the goal values;
a logical structure including the product modules and configured to instruct formation of a product based on the product properties, the logical structure including:
global logic that applies to the logical structure;
local logic that applies to certain parts of the logical structure;
conditions for selecting a module variant of a product module;
conditions for setting a quantity of a product module, the quantity including an amount of allowed instances of the product module; and
a translator, when executed by the processor, configured to translate the logical structure into a product configurator system model.

2. The system of claim 1, wherein the system includes a graphical user interface for configuring the product based on the product configurator system model.

3. The system of claim 1, wherein the logical structure further includes conditions that are reusable.

4. The system of claim 1, wherein the logical structure further includes conditions that are for single use.

5. The system of claim 1, wherein the logical structure further includes a control of product layout for the product, where the product is a recursive product.

6. A generic computer programming language for generating a configuration profile of a product in a product architecture system, comprising:
items;
item sets, an item set being a set of items that share a same base definition and serve a same function;
tools including functions, and the items and item sets are shared between tools such that attributes that are changed for an item in one tool are updated in other tools,
wherein the tools include a first tool and a second tool, and the first tool provides input for the second tool, and an output of the second tool depends on the input from the first tool, and
wherein data of an item is accessed via one of the tools; and
editors, configured to provide access to aspects of the tools, the items, the item sets, or relations thereof.

7. The programming language of claim 6, further comprising modules and product module sets.

8. The programming language of claim 6, further comprising statuses for the items, item sets, and tools.

9. The programming language of claim 6, further comprising actions for adding, duplicating, deleting, reordering, deactivating, and reactivating items.

10. The programming language of claim 6, further comprising relation scores representative of strength of relations between items and item sets.

11. The programming language of claim 6, wherein the tools include different user interfaces for inputting and outputting items, item sets, and relations thereof.

12. The programming language of claim 6, wherein the tools, editors, items, and item sets have respective error messaging and error handling.

13. The programming language of claim 6, including a graphical navigator configured to provide navigation through the tools, editors, items, item sets, and relations thereof.

14. The programming language of claim 13, wherein items, item sets, and tools are arrangeable within the graphical navigator.

15. The programming language of claim 6, including a node diagram configured to present items, item sets as nodes, and relations thereof as interfaces between the nodes (for example, the node diagram may include a layout derived from a force-directed graph drawing algorithm).

16. The programming language of claim 6, wherein the items and item sets include product configuration items that makeup a configuration profile for a product collectively.

17. The programming language of claim 6, wherein the items include goal values.

18. The programming language of claim 17, wherein the items include product properties, wherein each of the product properties including at least one of the goal values.

19. The programming language of claim 18, further comprising product modules, each of the product modules being associated with at least one of the product properties.

20. A system, comprising:
a generic computer programming language for generating a configuration profile of a product in a product architecture system, comprising:
a plurality of items, wherein each item of the plurality of items is associated with a unique identification code;
item sets, an item set being a set of items that share a same base definition and serve a same function;
tools including functions, and the items and item sets are shared between tools such that attributes that are changed for an item in one tool are updated in other tools,
wherein the tools include a first tool and a second tool, and the first tool provides input for the second tool, and an output of the second tool depends on the input from the first tool, and
wherein data of an item is accessed via one of the tools; and
editors, configured to provide access to aspects of the tools, the items, the item sets, or relations thereof; and
a specific translator for a specific configurator system, configured to translate instructions comprising the generic computer programming language to a configurator model executable by the specific configurator system.
